(19) United States
(12) Patent Application Publication
(10) Pub. No.: US 2026/0319220 A1
(43) Pub. Date: Oct. 15, 2026

(54) OPTICAL IMAGING LENS ASSEMBLY, IMAGE CAPTURING UNIT AND ELECTRONIC DEVICE

(71) Applicant: LARGAN PRECISION CO., LTD., Taichung City (TW)

(72) Inventors: Guan-Bo LIN, Taichung City (TW); Guan-Jr LIAO, Taichung City (TW)

(73) Assignee: LARGAN PRECISION CO., LTD., Taichung City (TW)

(21) Appl. No.: 19/248,917

(22) Filed: Jun. 25, 2025

(30) Foreign Application Priority Data
Apr. 9, 2025 (TW) 114113374

(51) Int. Cl. G02B 13/00; G02B 9/34

(52) U.S. Cl. CPC G02B 13/004; G02B 9/34

(57) ABSTRACT

An optical imaging lens assembly includes four lens elements which are, in order from an object side to an image side along an optical path: a first lens element, a second lens element, a third lens element and a fourth lens element. The first lens element has positive refractive power. The second lens element has an object-side surface being convex in a paraxial region thereof and an image-side surface being concave in a paraxial region thereof. The third lens element has positive refractive power. The fourth lens element with negative refractive power has an object-side surface being concave in a paraxial region thereof and an image-side surface being convex in a paraxial region thereof. At least one of the object-side surface and the image-side surface of at least one lens element of the optical imaging lens assembly has at least one inflection point.

### RELATED APPLICATIONS

This application claims priority to Taiwan Application 114113374, filed on Apr. 9, 2025, which is incorporated by reference herein in its entirety.

### BACKGROUND

### Technical Field

The present disclosure relates to an optical imaging lens assembly, an image capturing unit and an electronic device, more particularly to an optical imaging lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical imaging lens assembly includes four lens elements. The four lens elements are, in order from an object side to an image side along an optical path, a first lens element, a second lens element, a third lens element and a fourth lens element. Each of the four lens elements has an object-side surface facing toward the object side and an image-side surface facing toward the image side.

Preferably, the first lens element has positive refractive power. Preferably, the object-side surface of the second lens element is convex in a paraxial region thereof. Preferably, the image-side surface of the second lens element is concave in a paraxial region thereof. Preferably, the third lens element has positive refractive power. Preferably, the fourth lens element has negative refractive power. Preferably, the object-side surface of the fourth lens element is concave in a paraxial region thereof. Preferably, the image-side surface of the fourth lens element is convex in a paraxial region thereof. Preferably, at least one of the object-side surface and the image-side surface of at least one lens element of the optical imaging lens assembly has at least one inflection point.

When an axial distance between the object-side surface of the first lens element and the image-side surface of the fourth lens element is TD, an axial distance between the image-side surface of the fourth lens element and an image surface is BL, an absolute value of a focal length of the first lens element is |f1|, an absolute value of a focal length of the second lens element is |f2|, an absolute value of a focal length of the third lens element is |f3|, an absolute value of a focal length of the fourth lens element is |f4|, a maximum value of |f1|, |f2|, |f3| and |f4| is |fi|max, a central thickness of the third lens element is CT3, an axial distance between the third lens element and the fourth lens element is T34, the following conditions are preferably satisfied:

0.10<TD/BL<0.70;

0.20<|f2|/|fi|max≤1.00; and

0.10<CT3/T34<1.20.

According to another aspect of the present disclosure, an optical imaging lens assembly includes four lens elements. The four lens elements are, in order from an object side to an image side along an optical path, a first lens element, a second lens element, a third lens element and a fourth lens element. Each of the four lens elements has an object-side surface facing toward the object side and an image-side surface facing toward the image side. Preferably, the first lens element has positive refractive power. Preferably, the object-side surface of the second lens element is convex in a paraxial region thereof. Preferably, the image-side surface of the second lens element is concave in a paraxial region thereof. Preferably, the third lens element has positive refractive power. Preferably, the fourth lens element has negative refractive power. Preferably, the object-side surface of the fourth lens element is concave in a paraxial region thereof. Preferably, the image-side surface of the fourth lens element is convex in a paraxial region thereof.

When an axial distance between the object-side surface of the first lens element and the image-side surface of the fourth lens element is TD, an axial distance between the image-side surface of the fourth lens element and an image surface is BL, an Abbe number of the fourth lens element is V4, a central thickness of the first lens element is CT1, an axial distance between the second lens element and the third lens element is T23, a curvature radius of the object-side surface of the second lens element is R3, a curvature radius of the image-side surface of the third lens element is R6, the following conditions are preferably satisfied:

0.10<TD/BL<0.60;

5.0<V4<40.0;

1.00<CT1/T23<4.00; and

0.00<|R3/R6|<0.80.

According to another aspect of the present disclosure, an image capturing unit includes one of the aforementioned optical imaging lens assemblies and an image sensor, wherein the image sensor is disposed on the image surface of the optical imaging lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit corresponding to an infinite object distance and a finite object distance according to the 1st embodiment of the present disclosure;

FIG. 2 shows spherical aberration curves, astigmatic field curves and a distortion curve of the image capturing unit corresponding to the infinite object distance according to the 1st embodiment;

FIG. 3 shows spherical aberration curves, astigmatic field curves and a distortion curve of the image capturing unit corresponding to the finite object distance according to the 1 st embodiment;

FIG. 4 is a schematic view of an image capturing unit corresponding to an infinite object distance and a finite object distance according to the 2nd embodiment of the present disclosure;

FIG. 5 shows spherical aberration curves, astigmatic field curves and a distortion curve of the image capturing unit corresponding to the infinite object distance according to the 2nd embodiment;

FIG. 6 shows spherical aberration curves, astigmatic field curves and a distortion curve of the image capturing unit corresponding to the finite object distance according to the 2nd embodiment;

FIG. 7 is a schematic view of an image capturing unit corresponding to an infinite object distance and a finite object distance according to the 3rd embodiment of the present disclosure;

FIG. 8 shows spherical aberration curves, astigmatic field curves and a distortion curve of the image capturing unit corresponding to the infinite object distance according to the 3rd embodiment;

FIG. 9 shows spherical aberration curves, astigmatic field curves and a distortion curve of the image capturing unit corresponding to the finite object distance according to the 3rd embodiment;

FIG. 10 is a schematic view of an image capturing unit corresponding to an infinite object distance and a finite object distance according to the 4th embodiment of the present disclosure;

FIG. 11 shows spherical aberration curves, astigmatic field curves and a distortion curve of the image capturing unit corresponding to the infinite object distance according to the 4th embodiment;

FIG. 12 shows spherical aberration curves, astigmatic field curves and a distortion curve of the image capturing unit corresponding to the finite object distance according to the 4th embodiment;

FIG. 13 is a schematic view of an image capturing unit corresponding to an infinite object distance and a finite object distance according to the 5th embodiment of the present disclosure;

FIG. 14 shows spherical aberration curves, astigmatic field curves and a distortion curve of the image capturing unit corresponding to the infinite object distance according to the 5th embodiment;

FIG. 15 shows spherical aberration curves, astigmatic field curves and a distortion curve of the image capturing unit corresponding to the finite object distance according to the 5th embodiment;

FIG. 16 is a schematic view of an image capturing unit corresponding to an infinite object distance and a finite object distance according to the 6th embodiment of the present disclosure;

FIG. 17 shows spherical aberration curves, astigmatic field curves and a distortion curve of the image capturing unit corresponding to the infinite object distance according to the 6th embodiment;

FIG. 18 shows spherical aberration curves, astigmatic field curves and a distortion curve of the image capturing unit corresponding to the finite object distance according to the 6th embodiment;

FIG. 19 is a schematic view of an image capturing unit corresponding to an infinite object distance and a finite object distance according to the 7th embodiment of the present disclosure;

FIG. 20 shows spherical aberration curves, astigmatic field curves and a distortion curve of the image capturing unit corresponding to the infinite object distance according to the 7th embodiment;

FIG. 21 shows spherical aberration curves, astigmatic field curves and a distortion curve of the image capturing unit corresponding to the finite object distance according to the 7th embodiment;

FIG. 22 is a schematic view of an image capturing unit corresponding to an infinite object distance and a finite object distance according to the 8th embodiment of the present disclosure;

FIG. 23 shows spherical aberration curves, astigmatic field curves and a distortion curve of the image capturing unit corresponding to the infinite object distance according to the 8th embodiment;

FIG. 24 shows spherical aberration curves, astigmatic field curves and a distortion curve of the image capturing unit corresponding to the finite object distance according to the 8th embodiment;

FIG. 25 is a schematic view of an image capturing unit corresponding to an infinite object distance and a finite object distance according to the 9th embodiment of the present disclosure;

FIG. 26 shows spherical aberration curves, astigmatic field curves and a distortion curve of the image capturing unit corresponding to the infinite object distance according to the 9th embodiment;

FIG. 27 shows spherical aberration curves, astigmatic field curves and a distortion curve of the image capturing unit corresponding to the finite object distance according to the 9th embodiment;

FIG. 28 is a perspective view of an image capturing unit according to the 10th embodiment of the present disclosure;

FIG. 29 is one perspective view of an electronic device according to the 11th embodiment of the present disclosure;

FIG. 30 is another perspective view of the electronic device in FIG. 29;

FIG. 31 is one perspective view of an electronic device according to the 12th embodiment of the present disclosure;

FIG. 32 is another perspective view of the electronic device in FIG. 31;

FIG. 33 is a block diagram of the electronic device in FIG. 31;

FIG. 34 is one perspective view of an electronic device according to the 13th embodiment of the present disclosure;

FIG. 35 shows a schematic view of inflection points on lens surfaces and critical points on lens surfaces according to the 1st embodiment of the present disclosure;

FIG. 36 shows a schematic view of Y1R1 and Y4R2 according to the 1st embodiment of the present disclosure;

FIG. 37 shows a schematic view of a shape of an aperture stop according to one embodiment of the present disclosure;

FIG. 38 shows a schematic view of another shape of an aperture stop according to one embodiment of the present disclosure;

FIG. 39 shows a schematic view of a configuration of a reflective element in an optical imaging lens assembly according to one embodiment of the present disclosure;

FIG. 40 shows a schematic view of another configuration of a reflective element in an optical imaging lens assembly according to one embodiment of the present disclosure;

FIG. 41 shows a schematic view of still another configuration of a reflective element in an optical imaging lens assembly according to one embodiment of the present disclosure;

FIG. 42 shows a schematic view of a configuration of two reflective elements in an optical imaging lens assembly according to one embodiment of the present disclosure;

FIG. 43 shows a schematic view of another configuration of two reflective elements in an optical imaging lens assembly according to one embodiment of the present disclosure;

FIG. 44 shows a schematic view of a configuration of a double-reflective element in an optical imaging lens assembly according to one embodiment of the present disclosure;

FIG. 45 shows a schematic view of a configuration of a triple-reflective element in an optical imaging lens assembly according to one embodiment of the present disclosure;

FIG. 46 shows a schematic view of a configuration of a quadruple-reflective element in an optical imaging lens assembly according to one embodiment of the present disclosure;

FIG. 47 shows a schematic view of a configuration of a quintuple-reflective element in an optical imaging lens assembly according to one embodiment of the present disclosure;

FIG. 48 shows a schematic view of further another configuration of a reflective element in an optical imaging lens assembly according to one embodiment of the present disclosure;

FIG. 49 shows a schematic view of still another configuration of a reflective element in an optical imaging lens assembly according to one embodiment of the present disclosure;

FIG. 50 shows a schematic view of still further another configuration of a reflective element in the image capturing unit according to the 1st embodiment of the present disclosure;

FIG. 51 shows a perspective view of the reflective element in FIG. 50; and

FIG. 52 shows a perspective view of the reflective element in FIG. 51 with partial blocks being trimmed.

### DETAILED DESCRIPTION

An optical imaging lens assembly includes four lens elements. The four lens elements are, in order from an object side to an image side along an optical path, a first lens element, a second lens element, a third lens element and a fourth lens element. Each of the four lens elements has an object-side surface facing toward the object side and an image-side surface facing toward the image side.

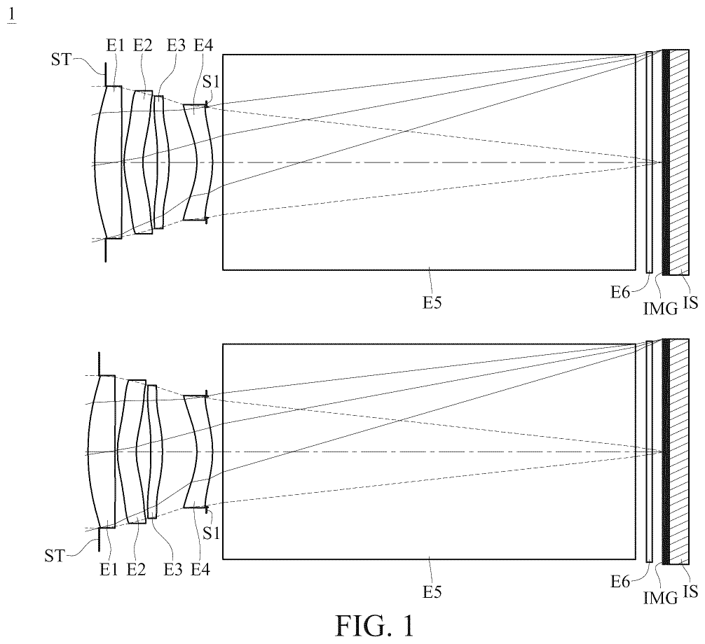

The optical imaging lens assembly has a first state corresponding to an infinite object distance and a second state corresponding to a finite object distance, wherein the first state refers to a state of the optical imaging lens assembly with an imaged object at infinity, and the second state refers to a state of the optical imaging lens assembly with an imaged object at a finite object distance. When an imaged object at infinity moves to be at the finite object distance, at least one lens element of the optical imaging lens assembly can move along an optical axis direction with respect to other lens elements of the optical imaging lens assembly to perform a movement focus process, so that the optical imaging lens assembly is changed from the first state to the second state. Please refer to FIG. 1, which is a schematic view of an optical imaging lens assembly of an image capturing unit at the first state (corresponding to the infinite object distance) and the second state (corresponding to the finite object distance) according to the 1st embodiment of the present disclosure. The upper part of FIG. 1 shows the optical imaging lens assembly at the first state, and the lower part of FIG. 1 shows the optical imaging lens assembly at the second state. Moreover, at least one lens element of the optical imaging lens assembly can move along an optical axis direction with respect to other lens elements of the optical imaging lens assembly during the movement focus process in which the first state is changed to the second state. Therefore, it is favorable for enabling the optical imaging lens assembly to achieve telephoto photography and macro photography so as to extend application range of the optical imaging lens assembly. Moreover, the infinite object distance refers to an axial distance between an imaged object and one lens element closest to the object side of the optical imaging lens assembly (e.g., the first lens element) which is equal to or greater than 10⁶ millimeters, and the finite object distance refers to an axial distance between an imaged object and one lens element closest to the object side of the optical imaging lens assembly (e.g., the first lens element) which is equal to or less than 1000 millimeters (mm). Further, the finite object distance refers to an axial distance between an imaged object and one lens element closest to the object side of the optical imaging lens assembly (e.g., the first lens element) which is equal to or less than 500 millimeters.

The first lens element can have positive refractive power. Therefore, it is favorable for reducing the size of the optical imaging lens assembly and controlling the viewing angle.

The object-side surface of the second lens element can be convex in a paraxial region thereof. Therefore, it is favorable for adjusting the refractive power of the second lens element, thereby correcting spherical aberration of the optical imaging lens assembly. The image-side surface of the second lens element can be concave in a paraxial region thereof. Therefore, it is favorable for correcting astigmatism of the optical imaging lens assembly so as to balance image quality at the image center and at the image periphery.

The third lens element can have positive refractive power. Therefore, it is favorable for enhancing convergence ability of the optical imaging lens assembly and reducing the size of the optical imaging lens assembly.

The fourth lens element can have negative refractive power. Therefore, it is favorable for correcting spherical aberration of the optical imaging lens assembly. The object-side surface of the fourth lens element can be concave in a paraxial region thereof. Therefore, it is favorable for ensuring that light can be received by the object-side surface of the fourth lens element in different states caused by the movement focus process. The image-side surface of the fourth lens element can be convex in a paraxial region thereof. Therefore, it is favorable for assisting in balancing the back focal length of the optical imaging lens assembly while correcting aberrations.

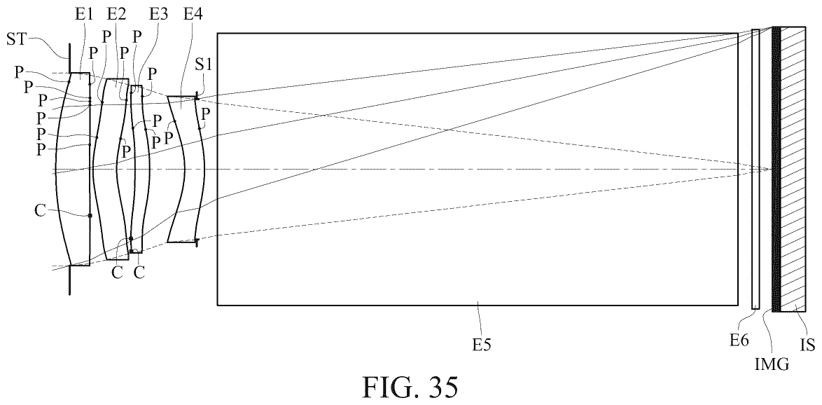

According to the present disclosure, at least one of the object-side surface and the image-side surface of at least one lens element of the optical imaging lens assembly can have at least one inflection point. Therefore, it is favorable for increasing shape variation of the lens surface, thereby compensating for off-axis aberrations. Moreover, the image-side surface of the third lens element can have at least one inflection point. Therefore, it is favorable for correcting aberrations at the image periphery while reducing the overall size. Please refer to FIG. 35, which shows a schematic view of inflection points P on the object-side surface of the first lens element E1, the image-side surface of the first lens element E1, the object-side surface of the second lens element E2, the image-side surface of the second lens element E2, the object-side surface of the third lens element E3, the image-side surface of the third lens element E3, the object-side surface of the fourth lens element E4 and the image-side surface of the fourth lens element E4 according to the 1st embodiment of the present disclosure. The abovementioned one or more inflection points P on any lens surface of the first through fourth lens elements in FIG. 35 are only exemplary. Each of lens surfaces in various embodiments of the present disclosure can also have one or more inflection points.

According to the present disclosure, at least one of the object-side surface and the image-side surface of at least one lens element of the optical imaging lens assembly can have at least one critical point in an off-axis region thereof. Please refer to FIG. 35, which shows a schematic view of critical points C on the image-side surface of the first lens element E1 and the object-side surface of the third lens element E3 according to the 1st embodiment of the present disclosure. The abovementioned one or more critical points C on the first lens element and the third lens element are only exemplary. Each of lens surfaces in various embodiments of the present disclosure can also have one or more critical points in an off-axis region thereof. In addition to visible light, light within the infrared band can also be applied to the optical imaging lens assembly according to the present disclosure, but the present disclosure is not limited thereto.

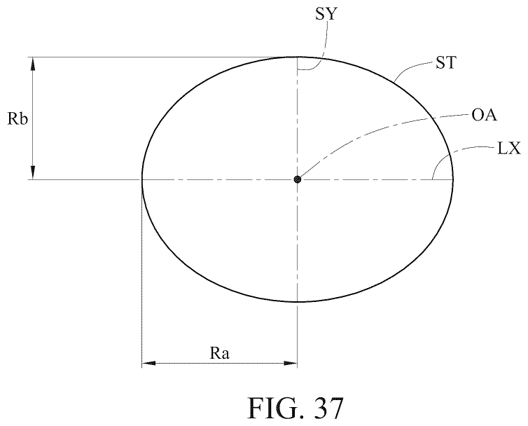

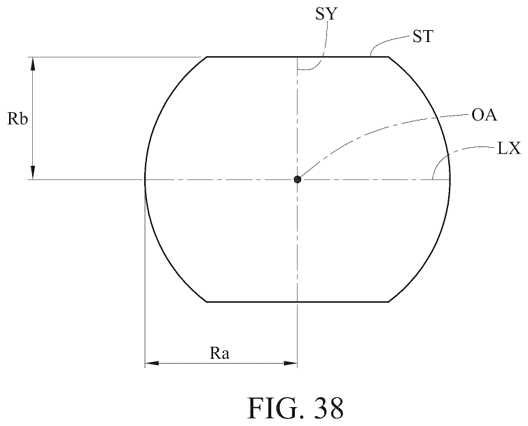

According to the present disclosure, the optical imaging lens assembly can further include an aperture stop. Moreover, the aperture stop can have a major axis direction and a minor axis direction which are perpendicular to the optical axis and are different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 37 and FIG. 38, which show schematic views of non-circular aperture stops according to the present disclosure, wherein FIG. 37 shows a schematic view of a shape of an aperture stop according to one embodiment of the present disclosure, and FIG. 38 shows a schematic view of another shape of an aperture stop according to one embodiment of the present disclosure. As shown in FIG. 37, in some configurations of the present disclosure, a shape of an aperture stop ST is elliptical, and the aperture stop ST has a major axis direction LX and a minor axis direction SY that are perpendicular to an optical axis OA. The major axis direction LX and the minor axis direction SY are two different directions, and an effective radius Ra of the aperture stop ST in the major axis direction LX is greater than an effective radius Rb of the aperture stop ST in the minor axis direction SY. As shown in FIG. 38, in some other configurations of the present disclosure, an aperture stop ST is shaped to have trimmed edges at an outer periphery thereof, and the aperture stop ST has a major axis direction LX and a minor axis direction SY that are perpendicular to an optical axis OA. The major axis direction LX and the minor axis direction SY are two different directions, and an effective radius Ra of the aperture stop ST in the major axis direction LX is greater than an effective radius Rb of the aperture stop ST in the minor axis direction SY.

According to the present disclosure, the optical imaging lens assembly can further include at least one reflective element with an optical path folding function. The optical path can be reflected at least once through the at least one reflective element, such that the optical imaging lens assembly can have a reflected optical path and can be more flexible in space arrangement, thereby miniaturizing the optical imaging lens assembly, reducing mechanical limitation, and thus achieving various specification requirements. Moreover, the optical path can be reflected at least twice through the at least one reflective element.

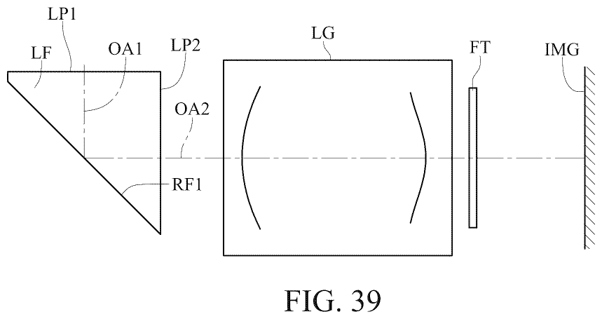

Moreover, the at least one reflective element can also be located between an imaged object and the image side surface. Moreover, the at least one reflective element can also be located between the fourth lens element and the image side surface. Moreover, the reflective element can be a prism or a mirror, but the present disclosure is not limited thereto. Please refer to FIG. 39, which shows a schematic view of a configuration of a reflective element in an optical imaging lens assembly according to one embodiment of the present disclosure. As shown in FIG. 39, in order from an imaged object (not shown in the figure) to an image surface IMG of the optical imaging lens assembly, an optical path can enter a reflective element LF along a first optical axis OA1 through a transmissive surface LP1, be reflected off a reflective surface RF1 of the reflective element LF, and then pass through a transmissive surface LP2, a lens group LG and a filter FT along a second optical axis OA2. The reflective element LF is a prism disposed between the imaged object and the lens group LG of the optical imaging lens assembly. However, the present disclosure is not limited thereto. In some other embodiments, the reflective element can also be disposed between the lens group and the image surface of the optical imaging lens assembly.

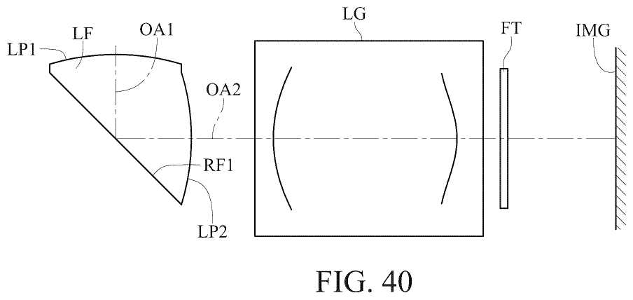

Moreover, in the aspect that the reflective element is a prism, the reflective element can have an object-side surface or an image-side surface being convex in a paraxial region thereof. Therefore, it is favorable for providing additional refractive power for the optical imaging lens assembly so as to reduce the size of the optical imaging lens assembly and improve image quality while making the overall appearance to have a three-dimensional visual effect. Please refer to FIG. 40, which shows a schematic view of another configuration of a reflective element in an optical imaging lens assembly according to one embodiment of the present disclosure. As shown in FIG. 40, in order from an imaged object (not shown in the figure) to an image surface IMG of the optical imaging lens assembly, an optical path can enter a reflective element LF along a first optical axis OA1 through a transmissive surface LP1, be reflected off a reflective surface RF1 of the reflective element LF, and then pass through a transmissive surface LP2, a lens group LG and a filter FT along a second optical axis OA2. The transmissive surface LP1 can be convex towards the imaged object in a paraxial region thereof, and the transmissive surface LP2 can be convex towards the lens group LG in a paraxial region thereof.

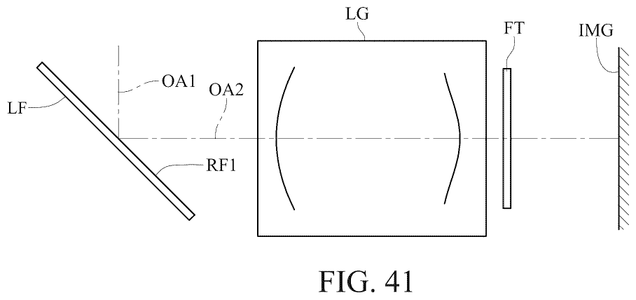

In addition, the abovementioned reflective element can also be replaced with a mirror. Please refer to FIG. 41, which shows a schematic view of still another configuration of a reflective element in an optical imaging lens assembly according to one embodiment of the present disclosure. As shown in FIG. 41, in order from an imaged object (not shown in the figure) to an image surface IMG of the optical imaging lens assembly, an optical path can enter a reflective element LF along a first optical axis OA1, be reflected off a reflective surface RF1 of the reflective element LF, and then pass through a lens group LG and a filter FT along a second optical axis OA2.

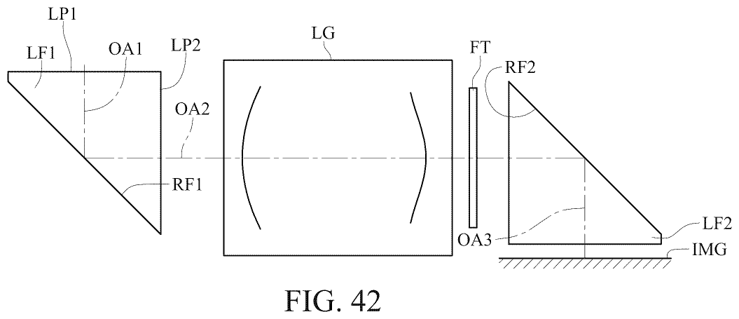

In addition, at least two reflective elements can also be optionally disposed between an imaged object and the image surface on the optical path of the optical imaging lens assembly. Please refer to FIG. 42, which shows a schematic view of a configuration of two reflective elements in an optical imaging lens assembly according to one embodiment of the present disclosure. As shown in FIG. 42, in order from an imaged object (not shown in the figures) to an image surface IMG of the optical imaging lens assembly, an optical path can enter a first reflective element LF1 along a first optical axis OA1, be reflected off a reflective surface RF1 of the first reflective element LF1, pass through a lens group LG and a filter FT along a second optical axis OA2, enter a second reflective element LF2 to be reflected off a reflective surface RF2 of the second reflective element LF2, and then extend onto the image surface IMG along a third optical axis OA3. The first reflective element LF1 is disposed between the imaged object and the lens group LG of the optical imaging lens assembly, the second reflective element LF2 is disposed between the lens group LG and the image surface IMG of the optical imaging lens assembly, and the travelling direction of light on the first optical axis OA1 can be the same direction as the travelling direction of light on the third optical axis OA3 as shown in FIG. 42.

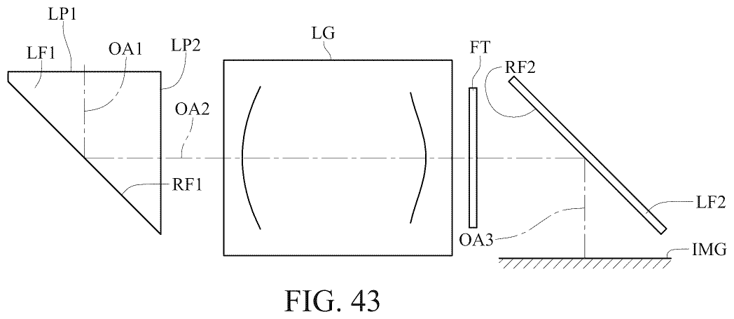

In addition, the at least two reflective elements optionally disposed between the imaged object and the image surface on the optical path of the optical imaging lens assembly can be different types. Please refer to FIG. 43, which shows a schematic view of another configuration of two reflective elements in an optical imaging lens assembly according to one embodiment of the present disclosure. As shown in FIG. 43, a second reflective element LF2 of the optical imaging lens assembly is a mirror, which is different from the second reflective element LF2 as being a prism in the arrangement of FIG. 42. The optical path along a second optical axis OA2 can also be reflected off a reflective surface RF2 of the second reflective element LF2 and then extend onto the image surface IMG along a third optical axis OA3. The arrangement of FIG. 43 is similar to that of FIG. 42, and the description is not repeated herein. The optical imaging lens assembly can be optionally provided with three or more reflective elements, and the present disclosure is not limited to the type, amount and position of the reflective elements of the embodiments disclosed in the aforementioned figures.

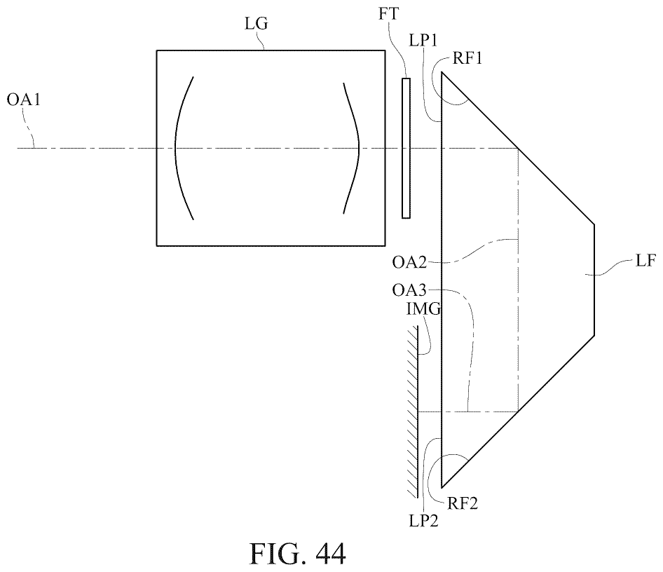

In addition, one reflective element can have at least two reflective surfaces, at least three reflective surfaces, at least four reflective surfaces, or at least five reflective surfaces. It can also be considered that the optical path can be reflected once, twice, three times, four times, five times or even more times in one reflective element. Please refer to FIG. 44, which shows a schematic view of a configuration of a double-reflective element in an optical imaging lens assembly according to one embodiment of the present disclosure. As shown in FIG. 44, in order from an imaged object (not shown in the figure) to an image surface IMG of the optical imaging lens assembly, an optical path can pass through a lens group LG, a filter FT and a transmissive surface LP1 along a first optical axis OA1, enter a double-reflective element LF to be reflected off a first reflective surface RF1 of the double-reflective element LF, extend along a second optical axis OA2 to be reflected again off a second reflective surface RF2 of the double-reflective element LF, and then extend onto the image surface IMG along a third optical axis OA3 through a transmissive surface LP2. The double-reflective element LF is disposed between the filter FT and the image surface IMG of the optical imaging lens assembly, and the travelling direction of light on the first optical axis OA1 can be an opposite direction from the travelling direction of light on the third optical axis OA3 as shown in FIG. 44.

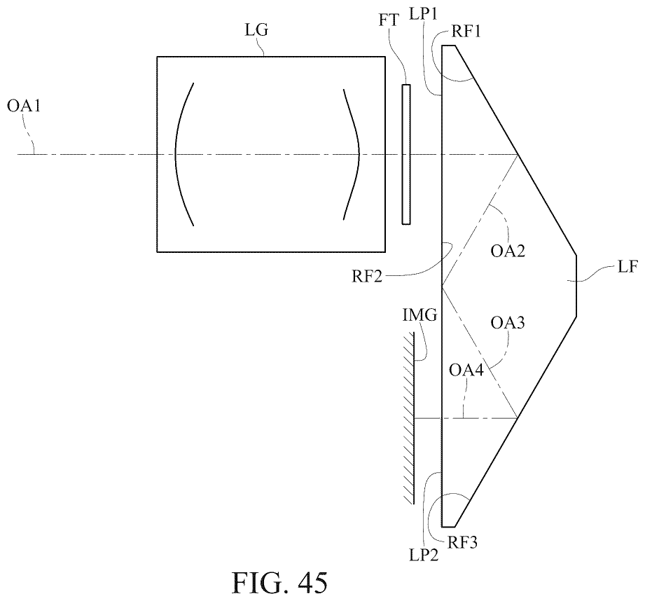

In addition, the angle between the normal direction of the reflective surface and the optical axis is not limited to 45 degrees. Other angles can be arranged according to actual requirements such as space arrangement. Please refer to FIG. 45, which shows a schematic view of a configuration of a triple-reflective element in an optical imaging lens assembly according to one embodiment of the present disclosure. As shown in FIG. 45, in order from an imaged object (not shown in the figure) to an image surface IMG of the optical imaging lens assembly, an optical path can pass through a lens group LG, a filter FT and a transmissive surface LP1 along a first optical axis OA1, enter a triple-reflective element LF to be reflected off a first reflective surface RF1 of the triple-reflective element LF, extend along a second optical axis OA2 to be reflected again off a second reflective surface RF2 of the triple-reflective element LF, extend along a third optical axis OA3 to be reflected further again off a third reflective surface RF3 of the triple-reflective element LF, and then extend onto the image surface IMG along a fourth optical axis OA4. The triple-reflective element LF is disposed between the filter FT and the image surface IMG of the optical imaging lens assembly, the travelling direction of light on the first optical axis OA1 can be an opposite direction from the travelling direction of light on the fourth optical axis OA4 as shown in FIG. 45, the angle between the second optical axis OA2 and the normal direction of the first reflective surface RF1 of the triple-reflective element LF is less than 45 degrees, and the angle between the third optical axis OA3 and the normal direction of the third reflective surface RF3 of the triple-reflective element LF is less than 45 degrees.

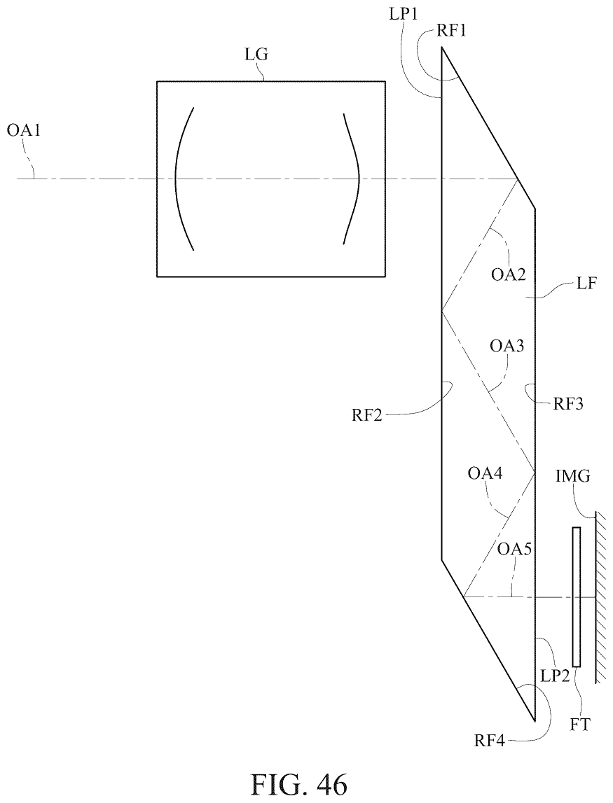

In addition, the reflective element can also be disposed between the lens group and the filter. Please refer to FIG. 46, which shows a schematic view of a configuration of a quadruple-reflective element in an optical imaging lens assembly according to one embodiment of the present disclosure. As shown in FIG. 46, in order from an imaged object (not shown in the figure) to an image surface IMG of the optical imaging lens assembly, an optical path can pass through a lens group LG and a transmissive surface LP1 along a first optical axis OA1, enter a quadruple-reflective element LF to be reflected off a first reflective surface RF1 of the quadruple-reflective element LF, extend along a second optical axis OA2 to be reflected again off a second reflective surface RF2 of the quadruple-reflective element LF, extend along a third optical axis OA3 to be reflected further again off a third reflective surface RF3 of the quadruple-reflective element LF, extend along a fourth optical axis OA4 to be reflected still further again off a fourth reflective surface RF4 of the quadruple-reflective element LF, and then extend onto the image surface IMG through a transmissive surface LP2 and a filter FT along a fifth optical axis OA5. The quadruple-reflective element LF is disposed between the lens group LG and the filter FT of the optical imaging lens assembly, and the travelling direction of light on the first optical axis OA1 can be a same direction from the travelling direction of light on the fifth optical axis OA5 as shown in FIG. 46.

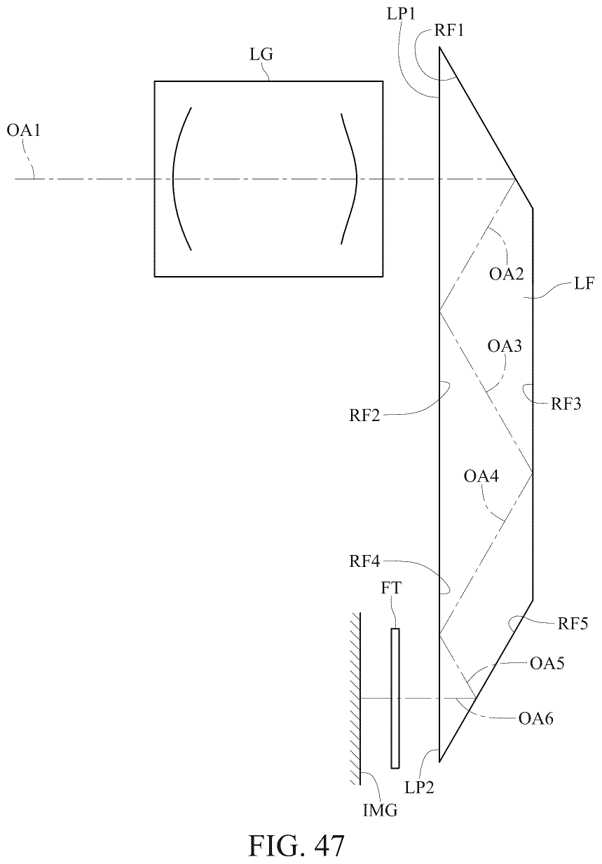

In addition, the reflective element can also be disposed between the lens group and the filter. Please refer to FIG. 47, which shows a schematic view of a configuration of a quintuple-reflective element in an optical imaging lens assembly according to one embodiment of the present disclosure. As shown in FIG. 47, in order from an imaged object (not shown in the figure) to an image surface IMG of the optical imaging lens assembly, an optical path can pass through a lens group LG and a transmissive surface LP1 along a first optical axis OA1, enter a quintuple-reflective element LF to be reflected off a first reflective surface RF1 of the quintuple-reflective element LF, extend along a second optical axis OA2 to be reflected again off a second reflective surface RF2 of the quintuple-reflective element LF, extend along a third optical axis OA3 to be reflected further again off a third reflective surface RF3 of the quintuple-reflective element LF, extend along a fourth optical axis OA4 to be reflected still further again off a fourth reflective surface RF4 of the quintuple-reflective element LF, extend along a fifth optical axis OA5 to be reflected still further again off a fifth reflective surface RF5 of the quintuple-reflective element LF, and then extend onto the image surface IMG through a transmissive surface LP2 and a filter FT along a sixth optical axis OA6. The quintuple-reflective element LF is disposed between the lens group LG and the filter FT of the optical imaging lens assembly, and the travelling direction of light on the first optical axis OA1 can be an opposite direction from the travelling direction of light on the sixth optical axis OA6 as shown in FIG. 47.

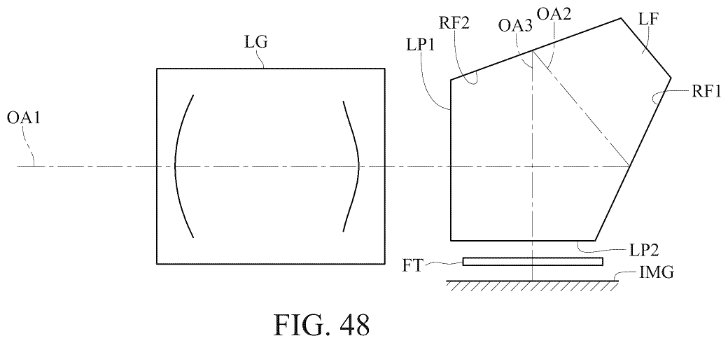

In addition, the optical path in the reflective element can have intersection. Please refer to FIG. 48, which shows a schematic view of further another configuration of a reflective element in an optical imaging lens assembly according to one embodiment of the present disclosure. As shown in FIG. 48, in order from an imaged object (not shown in the figure) to an image surface IMG of the optical imaging lens assembly, an optical path can pass through a lens group LG and a transmissive surface LP1 along a first optical axis OA1, enter a reflective element LF as being a pentaprism to be reflected off a first reflective surface RF1 of the reflective element LF, extend along a second optical axis OA2 to be reflected again off a second reflective surface RF2 of the reflective element LF, extend along a third optical axis OA3 to intersect the first optical axis OA1, and then extend onto the image surface IMG through a transmissive surface LP2 and a filter FT. The reflective element LF is disposed between the lens group LG and the image surface IMG of the optical imaging lens assembly, and the travelling direction of light on the first optical axis OA1 can be perpendicular to the travelling direction of light on the third optical axis OA3 as shown in FIG. 48.

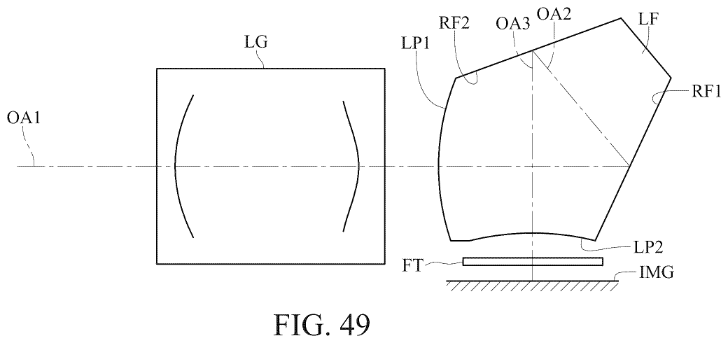

In addition, the surface of the reflective element can be planar surface, spherical surface, aspheric surface or freeform surface according to the optical design requirements, but the present disclosure is not limited thereto. Please refer to FIG. 49, which shows a schematic view of still further another configuration of a reflective element in an optical imaging lens assembly according to one embodiment of the present disclosure. As shown in FIG. 49, in order from an imaged object (not shown in the figure) to an image surface IMG of the optical imaging lens assembly, an optical path can pass through a lens group LG and a transmissive surface LP1 along a first optical axis OA1, enter a reflective element LF as being a pentaprism to be reflected off a first reflective surface RF1 of the reflective element LF, extend along a second optical axis OA2 to be reflected again off a second reflective surface RF2 of the reflective element LF, extend along a third optical axis OA3 to intersect the first optical axis OA1, and then extend onto the image surface IMG through a transmissive surface LP2 and a filter FT. The transmissive surface LP1 can be convex towards the lens group LG in a paraxial region thereof, and the transmissive surface LP2 can be concave away from the image surface IMG in a paraxial region thereof.

In addition, in order to reduce the size of the optical imaging lens assembly, the length and the width of the lens element may be different from each other, and the length, the width and the height of the prism may be different from one another, as shown as the double-reflective element LF, the triple-reflective element LF, the quadruple-reflective element LF, quintuple-reflective element LF and the reflective element LF in FIG. 44 to FIG. 49. Moreover, an angle between a vector of the optical axis at the object side and that at the image side can be any angle, not limited to 0 degree, 90 degrees or 180 degrees. Moreover, the reflective element can consist of more than one prism depending on the design requirements. Moreover, the prism can be made of glass material or plastic material depending on the design requirements.

When an axial distance between the object-side surface of the first lens element and the image-side surface of the fourth lens element is TD, and an axial distance between the image-side surface of the fourth lens element and an image surface is BL, the following condition can be satisfied: 0.10<TD/BL<0.90. Therefore, it is favorable for having a sufficient back focal length of the optical imaging lens assembly so as to facilitate the folding of the optical path. Moreover, the following condition can also be satisfied: 0.10<TD/BL<0.70. Moreover, the following condition can also be satisfied: 0.10<TD/BL<0.60. Moreover, the following condition can also be satisfied: 0.10<TD/BL<0.55. Moreover, the following condition can also be satisfied: 0.15<TD/BL<0.60. Moreover, the following condition can also be satisfied: 0.20<TD/BL<0.35. Moreover, the following condition can also be satisfied: 0.23≤TD/BL≤0.50.

When an absolute value of a focal length of the first lens element is |f1|, an absolute value of a focal length of the second lens element is |f2|, an absolute value of a focal length of the third lens element is |f3|, an absolute value of a focal length of the fourth lens element is |f4|, and a maximum value of |f1|, |f2|, |f3| and |f4| is |fi|max, the following condition can be satisfied: 0.20<|f2|/|fi|max≤1.00. Therefore, it is favorable for adjusting the refractive power configuration of the optical imaging lens assembly to improve image quality. Moreover, the following condition can also be satisfied: 0.25<|f2|/|fi|max≤1.00. Moreover, the following condition can also be satisfied: 0.26≤|f2|/|fi|max≤1.00. Moreover, the following condition can also be satisfied: 0.40<|f2|/|fi|max≤1.00.

When a central thickness of the third lens element is CT3, and an axial distance between the third lens element and the fourth lens element is T34, the following condition can be satisfied: 0.10<CT3/T34<1.20. Therefore, it is favorable for adjusting the ratio of the central thickness of the third lens element to the lens interval between the third lens element and the fourth lens element of the optical imaging lens assembly, thereby facilitating the space arrangement of the mechanism and other assemblies. Moreover, the following condition can also be satisfied: 0.20<CT3/T34<1.00. Moreover, the following condition can also be satisfied: 0.34≤CT3/T34≤0.88.

When an Abbe number of the fourth lens element is V4, the following condition can be satisfied: 5.0<V4<40.0. Therefore, it is favorable for adjusting the Abbe number of the fourth lens element, thereby correcting chromatic aberration of the optical imaging lens assembly. Moreover, the following condition can also be satisfied: 10.0<V4<35.0. Moreover, the following condition can also be satisfied: 10.0<V4<30.0. Moreover, the following condition can also be satisfied: 15.0<V4<25.0. Moreover, the following condition can also be satisfied: 16.3≤V4≤23.5.

When a central thickness of the first lens element is CT1, and an axial distance between the second lens element and the third lens element is T23, the following condition can be satisfied: 1.00<CT1/T23<4.00. Therefore, it is favorable for adjusting the ratio of the central thickness of the first lens element to the lens interval between the second lens element and the third lens element of the optical imaging lens assembly, thereby improving light convergence quality. Moreover, the following condition can also be satisfied: 1.00<CT1/T23<3.50. Moreover, the following condition can also be satisfied: 1.10<CT1/T23<3.00. Moreover, the following condition can also be satisfied: 1.23≤CT1/T23≤2.82.

When a curvature radius of the object-side surface of the second lens element is R3, and a curvature radius of the image-side surface of the third lens element is R6, the following condition can be satisfied: 0.00<|R3/R6|<0.80. Therefore, it is favorable for correcting coma and improving light convergence quality at the paraxial and off-axial regions. Moreover, the following condition can also be satisfied: 0.00<R3/R6|<0.70. Moreover, the following condition can also be satisfied: 0.00<R3/R6|<0.60. Moreover, the following condition can also be satisfied: 0.02≤|R3/R6|≤0.58.

When an axial distance between the object-side surface of the first lens element and the image surface is TL, and a maximum image height of the optical imaging lens assembly (which can be half of a diagonal length of an effective photosensitive area of an image sensor) is ImgH, the following condition can be satisfied: 3.00<TL/ImgH<6.00. Therefore, it is favorable for controlling the ratio of the total track length of the optical imaging lens assembly to the image height within a proper range, such that sufficient brightness of the image can be maintained while meeting the miniaturization requirement of the optical imaging lens assembly. Moreover, the following condition can also be satisfied: 3.30<TL/ImgH<5.60. Moreover, the following condition can also be satisfied: 3.50<TL/ImgH<5.20.

When the axial distance between the image-side surface of the fourth lens element and the image surface is BL, and a focal length of the optical imaging lens assembly is f, the following condition can be satisfied: 0.70<BL/f<1.30. Therefore, it is favorable for increasing the back focal length of the optical imaging lens assembly, thereby achieving telephoto photography effect. Moreover, the following condition can also be satisfied: 0.80<BL/f<1.20.

When the focal length of the optical imaging lens assembly is f, and the focal length of the second lens element is f2, the following condition can be satisfied: −3.00<f/f2<0.80. Therefore, it is favorable for effectively correcting the aberrations generated by the first lens element, thereby improving image quality. Moreover, the following condition can also be satisfied: −2.60<f/f2<0.70. Moreover, the following condition can also be satisfied: −2.20<f/f2<0.60.

When the focal length of the second lens element is f2, and the focal length of the fourth lens element is f4, the following condition can be satisfied: 0.00<|f4/f2|<5.00. Therefore, it is favorable for balancing light convergence capability and light divergence capability of the optical imaging lens assembly, thereby correcting aberrations. Moreover, the following condition can also be satisfied: 0.00<|f4/f2|<4.50. Moreover, the following condition can also be satisfied: 0.05<|f4/f2|<4.00. Moreover, the following condition can also be satisfied: 0.05<|f4/f2|<2.50.

When a curvature radius of the image-side surface of the first lens element is R2, and the curvature radius of the object-side surface of the second lens element is R3, the following condition can be satisfied: 0.00<R3/R2|<1.00. Therefore, it is favorable for controlling the deflection angle of light in the optical imaging lens assembly so as to reduce stray light. Moreover, the following condition can also be satisfied: 0.00<R3/R2|<0.85. Moreover, the following condition can also be satisfied: 0.00<R3/R2|<0.70.

When a curvature radius of the object-side surface of the first lens element is R1, and a curvature radius of the image-side surface of the fourth lens element is R8, the following condition can be satisfied: 0.00<R8/R1|<1.50. Therefore, it is favorable for controlling the travelling direction of light in the optical imaging lens assembly, thereby improving light convergence quality at the paraxial and off-axial regions. Moreover, the following condition can also be satisfied: 0.00<|R8/R1|<1.20. Moreover, the following condition can also be satisfied: 0.00<R8/R1|<1.00. Moreover, the following condition can also be satisfied: 0.00<|R8/R1|<0.85.

When the curvature radius of the image-side surface of the third lens element is R6, and the curvature radius of the image-side surface of the fourth lens element is R8, the following condition can be satisfied: 0.00<R8/R6|<1.20. Therefore, it is favorable for adjusting the lens shapes of the third lens element and the fourth lens element, thereby correcting off-axial field curvature. Moreover, the following condition can also be satisfied: 0.00<R8/R6|<1.00. Moreover, the following condition can also be satisfied: 0.00<R8/R6<0.80.

When the axial distance between the object-side surface of the first lens element and the image surface is TL, and a curvature radius of the object-side surface of the third lens element is R5, the following condition can be satisfied: −2.00<TL/R5<6.00. Therefore, it is favorable for adjusting the refractive power of the third lens element to improve light convergence quality. Moreover, the following condition can also be satisfied: −1.80<TL/R5<5.50.

When an Abbe number of the first lens element is V1, and a refractive index of the first lens element is N1, the following condition can be satisfied: 18.00<V1/N1<43.00. Therefore, a proper material section of the first lens element is favorable for improving image quality. Moreover, the following condition can also be satisfied: 20.00<V1/N1<40.00.

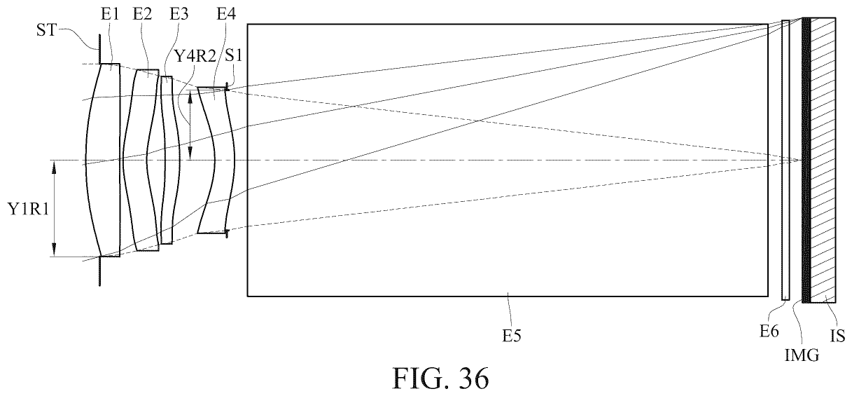

When a maximum effective radius of the object-side surface of the first lens element is Y1R1, and a maximum effective radius of the image-side surface of the fourth lens element is Y4R2, the following condition can be satisfied: 1.00<Y1R1/Y4R2<1.70. Therefore, it is favorable for adjusting the ratio of the effective radius of the object-side surface of the first lens element to the effective radius of the image-side surface of the fourth lens element, thereby increasing illuminance at the image periphery. Moreover, the following condition can also be satisfied: 1.20<Y1R1/Y4R2<1.60. Please refer to FIG. 36, which shows a schematic view of Y1R1 and Y4R2 according to the 1st embodiment of the present disclosure.

When the axial distance between the object-side surface of the first lens element and the image surface is TL, and the focal length of the optical imaging lens assembly is f, the following condition can be satisfied: 1.15<TL/f<1.55. Therefore, it is favorable for obtaining a proper balance between the total track length and the viewing angle of the optical imaging lens assembly. Moreover, the following condition can also be satisfied: 1.20<TL/f<1.50. Moreover, the following condition can also be satisfied: 1.30<TL/f<1.50.

When a maximum field of view of the optical imaging lens assembly is FOV, the following condition can be satisfied: 25 degrees<FOV<40 degrees. Therefore, it is favorable for having a proper imaging range of the optical imaging lens assembly so as to meet the viewing angle requirement of the application device.

When a sum of central thicknesses of all lens elements of the optical imaging lens assembly is ECT, and a sum of axial distances between each of all adjacent lens elements of the optical imaging lens assembly is ΣAT, the following condition can be satisfied: 0.90<ΣCT/ΣAT<2.00. Therefore, it is favorable for reducing the intervals between the lens elements of the optical imaging lens assembly, thereby reducing the overall size of the lens assembly. Moreover, the following condition can also be satisfied: 1.00<ΣCT/ΣAT<1.90.

When the focal length of the first lens element is f1, and the focal length of the third lens element is f3, the following condition can be satisfied: 0.30<|f1/f3|<3.00. Therefore, it is favorable for balancing light convergence capability of the optical imaging lens assembly to improve light convergence quality. Moreover, the following condition can also be satisfied: 0.40<|f1/f3|<2.80.

When the focal length of the second lens element is f2, and the focal length of the third lens element is f3, the following condition can be satisfied: 0.00<|f3/f2|<2.50. Therefore, it is favorable for adjusting the refractive powers of the second lens element and the third lens element, thereby reducing the overall size. Moreover, the following condition can also be satisfied: 0.05<|f3/f2|<2.00. Moreover, the following condition can also be satisfied: 0.05<|f3/f2|<1.50.

When the focal length of the optical imaging lens assembly is f, a curvature radius of the object-side surface of the fourth lens element is R7, and the curvature radius of the image-side surface of the fourth lens element is R8, the following condition can be satisfied: 4.00<|f/R7|+|f/R8|<14.00. Therefore, it is favorable for adjusting the lens shape and the refractive power of the fourth lens element, thereby correcting aberrations and adjusting the back focal length. Moreover, the following condition can also be satisfied: 5.00<|f/R7|+|f/R8|<13.00. Moreover, the following condition can also be satisfied: 8.00<|f/R7|+|f/R8|<13.00.

When a curvature radius of the image-side surface of the second lens element is R4, and the curvature radius of the object-side surface of the third lens element is R5, the following condition can be satisfied: 0.00<R4/R5|<1.00. Therefore, it is favorable for adjusting the surfaces in the curvature radius of the second lens element and the third lens element that are adjacent to each other, thereby improving image quality at the peripheral field of view. Moreover, the following condition can also be satisfied: 0.00<R4/R5|<0.80.

When the central thickness of the first lens element is CT1, and the central thickness of the third lens element is CT3, the following condition can be satisfied: 0.90<CT1/CT3<3.00. Therefore, it is favorable for balancing the ratio of the central thicknesses of the first lens element to the third lens element, thereby balancing lens configuration of the optical imaging lens assembly. Moreover, the following condition can also be satisfied: 1.00<CT1/CT3<2.50.

When an axial distance between the first lens element and the second lens element is T12, and the axial distance between the third lens element and the fourth lens element is T34, the following condition can be satisfied: 0.00<T12/T34<0.30. Therefore, it is favorable for reducing the size at the object end of the optical imaging lens assembly. Moreover, the following condition can also be satisfied: 0.00<T12/T34<0.20.

According to the present disclosure, the aforementioned features and conditions can be utilized in numerous combinations so as to achieve corresponding effects.

According to the present disclosure, the lens elements of the optical imaging lens assembly can be made of either glass or plastic material. When the lens elements are made of glass material, the refractive power distribution of the optical imaging lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical imaging lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the optical imaging lens assembly, based on the corresponding image sensor, can be flat or curved, especially a curved surface being concave facing towards the object side of the optical imaging lens assembly.

According to the present disclosure, an image correction unit, such as a field flattener, can be optionally disposed between the lens element closest to the image side of the optical imaging lens assembly along the optical path and the image surface for correction of aberrations such as field curvature. The optical characteristics of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the optical imaging lens assembly can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical imaging lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the optical imaging lens assembly and thereby provides a wider field of view for the same.

According to the present disclosure, the optical imaging lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical imaging lens assembly can include one or more optical elements for limiting the form of light passing through the optical imaging lens assembly. Each optical element can be, but not limited to, a filter, a polarizer, etc., and each optical element can be, but not limited to, a single-piece element, a composite component, a thin film, etc. The optical element can be located at the object side or the image side of the optical imaging lens assembly or between any two adjacent lens elements so as to allow light in a specific form to pass through, thereby meeting application requirements.

According to the present disclosure, the optical imaging lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the optical imaging lens assembly can further include a light-blocking element. The light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

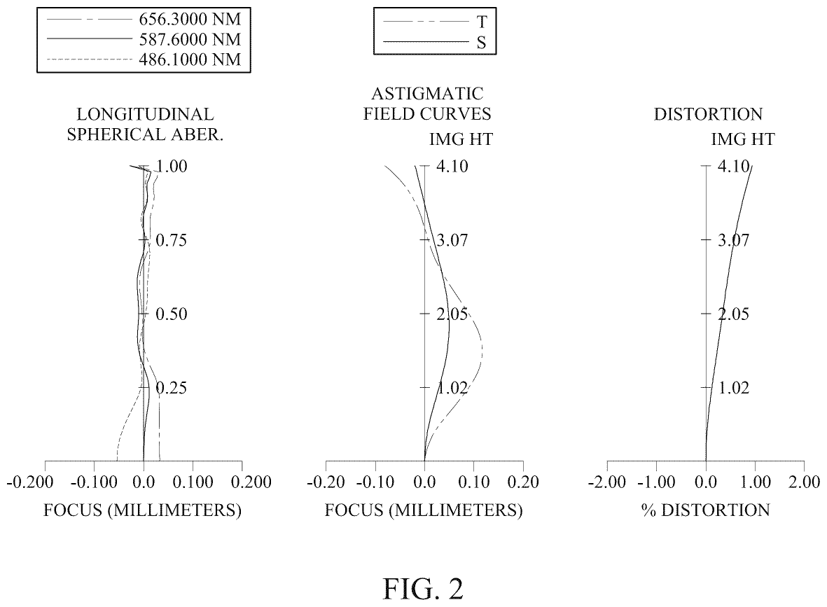

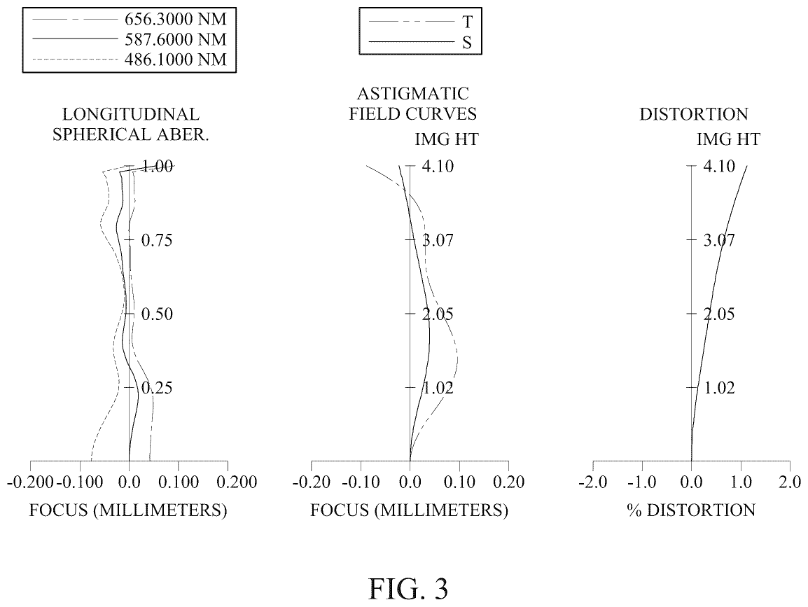

FIG. 1 is a schematic view of an image capturing unit at the first state (corresponding to an infinite object distance) and the second state (corresponding to a finite object distance) according to the 1st embodiment of the present disclosure. FIG. 2 shows, in order from left to right, spherical aberration curves, astigmatic field curves and a distortion curve of the image capturing unit at the first state according to the 1st embodiment. FIG. 3 shows, in order from left to right, spherical aberration curves, astigmatic field curves and a distortion curve of the image capturing unit at the second state according to the 1st embodiment. The upper part of FIG. 1 shows the optical imaging lens assembly at the first state, and the lower part of FIG. 1 shows the optical imaging lens assembly at the second state. In FIG. 1, the image capturing unit 1 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.602 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 1 and the second state as shown in the lower part of FIG. 1.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has five inflection points. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has two critical points in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

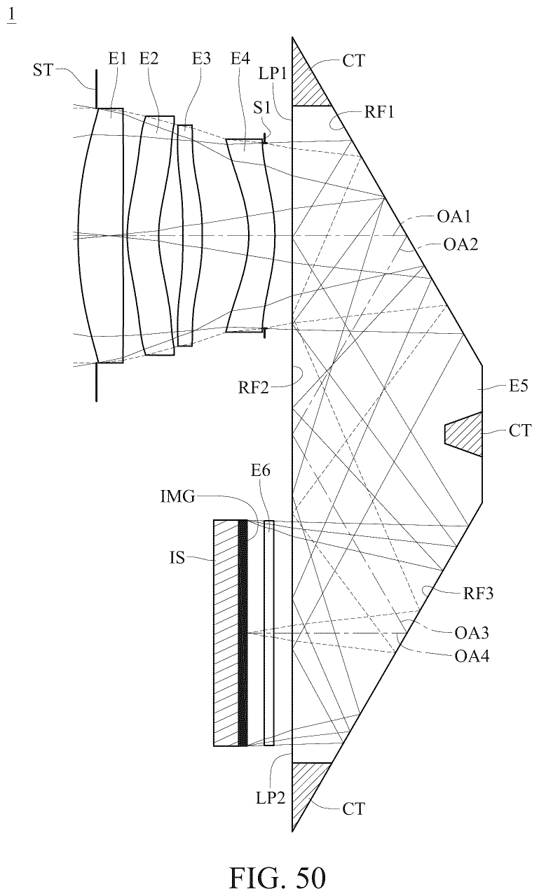

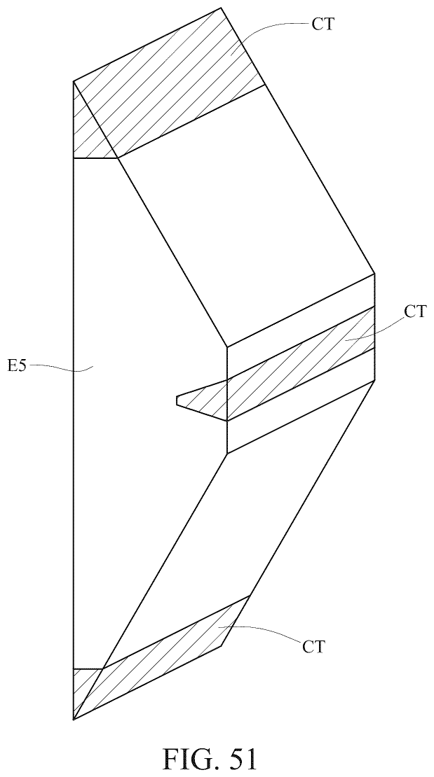

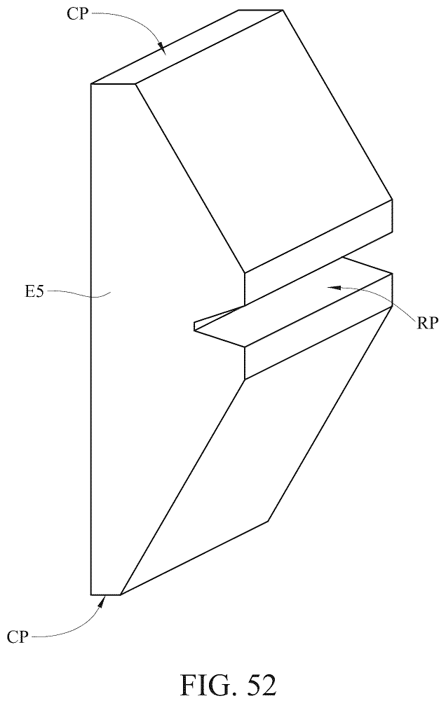

The reflective element E5 is made of glass material. The reflective element E5 is a prism which provides an optical path folding function. For simplicity, the light-folding effect generated by the reflective element E5 in FIG. 1 is omitted. The reflective element E5 can have various forms as shown in FIG. 39 to FIG. 49. The detail can be referred to the description related to FIG. 39 to FIG. 49, which will not be repeated again. Moreover, the reflective element E5 can be an element with trimmed edges CP and a recess RP as shown in FIG. 52, which is formed by removing non-optical effective blocks CT of an element with a trapezoidal section as shown in FIGS. 50 and 51. By doing so, it is favorable for reducing lens size and thus further achieving the miniaturization of the overall module. Please be noted that the reflective element E5 as shown in FIG. 52 can also be achieved by the combination of two or more prisms, and the present disclosure is not limited thereto.

The filter E6 is made of glass material and located between the reflective element E5 and the image surface IMG, and will not affect the focal length of the optical imaging lens assembly. The image sensor IS is disposed on or near the image surface IMG.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22 and 24.

In the optical imaging lens assembly of the image capturing unit 1 according to the 1 st embodiment, when the focal length of the optical imaging lens assembly is f, an f-number of the optical imaging lens assembly is Fno, and half of a maximum field of view of the optical imaging lens assembly is HFOV, the following conditions are satisfied at the first state: f=15.01 [mm]; Fno=2.70; and HFOV=15.1 [deg.], and the following conditions are satisfied at the second state: f=14.62 [mm]; Fno=2.79; and HFOV=14.7 [deg.].

An axial distance between an imaged object and the aperture stop ST is defined as DO. An axial distance between the image-side surface of the third lens element E3 and the object-side surface of the fourth lens element E4 is defined as D1. The optical imaging lens assembly is changeable between the first state and the second state through the movement focus process, and the values of DO and D1 vary accordingly. When the optical imaging lens assembly is at the first state, the aforementioned parameters have the following values: D0=∞ (infinity) and D1=1.010 mm. When the optical imaging lens assembly is at the second state, the aforementioned parameters have the following values: D0=300.000 mm and D1=1.251 mm.

When the maximum field of view of the optical imaging lens assembly is FOV, the following condition is satisfied at the first state: FOV=30.2 degrees (deg.), and the following condition is satisfied at the second state: FOV=29.4 deg.

When an axial distance between the object-side surface of the first lens element E1 and the image surface IMG is TL, and a maximum image height of the optical imaging lens assembly is ImgH, the following condition is satisfied at the first state: TL/ImgH=5.04, and the following condition is satisfied at the second state: TL/ImgH=5.10.

When the axial distance between the object-side surface of the first lens element E1 and the image surface IMG is TL, and the focal length of the optical imaging lens assembly is f, the following condition is satisfied at the first state: TL/f=1.38, and the following condition is satisfied at the second state: TL/f=1.43.

When an axial distance between the image-side surface of the fourth lens element E4 and the image surface IMG is BL, and the focal length of the optical imaging lens assembly is f, the following condition is satisfied at the first state: BL/f=1.09, and the following condition is satisfied at the second state: BL/f=1.12.

When an axial distance between the object-side surface of the first lens element E1 and the image-side surface of the fourth lens element E4 is TD, and the axial distance between the image-side surface of the fourth lens element E4 and an image surface IMG is BL, the following condition is satisfied at the first state: TD/BL=0.26, and the following condition is satisfied at the second state: TD/BL=0.28.

When a sum of central thicknesses of all lens elements of the optical imaging lens assembly is ECT, and a sum of axial distances between each of all adjacent lens elements of the optical imaging lens assembly is ΣAT, the following condition is satisfied at the first state: ΣΣCT/ΣAT=1.62, and the following condition is satisfied at the second state: ΣCT/ΣAT=1.41. In this embodiment, ECT is a sum of central thicknesses of the first lens element E1, the second lens element E2, the third lens element E3, and the fourth lens element E4. In this embodiment, ΣAT is a sum of axial distances between the first lens element E1 and the second lens element E2, the second lens element E2 and the third lens element E3, and the third lens element E3 and the fourth lens element E4. In this embodiment, an axial distance between two adjacent lens elements is a distance in a paraxial region between two adjacent lens surfaces of the two adjacent lens elements.

When the focal length of the optical imaging lens assembly is f, and a focal length of the second lens element E2 is f2, the following condition is satisfied at the first state: f/f2=−0.08, and the following condition is satisfied at the second state: f/f2=−0.08.

When the focal length of the optical imaging lens assembly is f, a curvature radius of the object-side surface of the fourth lens element E4 is R7, and a curvature radius of the image-side surface of the fourth lens element E4 is R8, the following condition is satisfied at the first state: |f/R7|+|f/R8|=9.66, and the following condition is satisfied at the second state: |f/R7|+|f/R8|=9.41.

When the axial distance between the object-side surface of the first lens element E1 and the image surface IMG is TL, and a curvature radius of the object-side surface of the third lens element E3 is R5, the following condition is satisfied at the first state: TL/R5=−1.12, and the following condition is satisfied at the second state: TL/R5=−1.14.

When a central thickness of the third lens element E3 is CT3, and an axial distance between the third lens element E3 and the fourth lens element E4 is T34, the following condition is satisfied at the first state: CT3/T34=0.42, and the following condition is satisfied at the second state: CT3/T34=0.34.

When an axial distance between the first lens element E1 and the second lens element E2 is T12, and the axial distance between the third lens element E3 and the fourth lens element E4 is T34, the following condition is satisfied at the first state: T12/T34=0.10, and the following condition is satisfied at the second state: T12/T34=0.08.

When a focal length of the first lens element E1 is f1, and a focal length of the third lens element E3 is f3, the following condition is satisfied: |f1/f3|=1.25.

When the focal length of the second lens element E2 is f2, and the focal length of the third lens element E3 is f3, the following condition is satisfied: |f3/f2|=0.07.

When the focal length of the second lens element E2 is f2, and a focal length of the fourth lens element E4 is f4, the following condition is satisfied: |f4/f2|=0.08.

When an absolute value of the focal length of the first lens element E1 is |f1|, an absolute value of the focal length of the second lens element E2 is |f2|, an absolute value of a focal length of the third lens element E3 is |f3|, an absolute value of the focal length of the fourth lens element E4 is |f4|, and a maximum value of |f1|, |f2|, |f3| and |f4| is |fi|max, the following condition is satisfied: |f2|/|fi|max=1.00.

When a curvature radius of the image-side surface of the first lens element E1 is R2, and a curvature radius of the object-side surface of the second lens element E2 is R3, the following condition is satisfied: |R3/R2|=0.11.

When the curvature radius of the object-side surface of the second lens element E2 is R3, and a curvature radius of the image-side surface of the third lens element E3 is R6, the following condition is satisfied: |R3/R6|=0.58.

When a curvature radius of the image-side surface of the second lens element E2 is R4, and the curvature radius of the object-side surface of the third lens element E3 is R5, the following condition is satisfied: |R4/R5|=0.15.

When a curvature radius of the object-side surface of the first lens element E1 is R1, and the curvature radius of the image-side surface of the fourth lens element E4 is R8, the following condition is satisfied: |R8/R1|=0.41.

When the curvature radius of the image-side surface of the third lens element E3 is R6, and the curvature radius of the image-side surface of the fourth lens element E4 is R8, the following condition is satisfied: |R8/R6|=0.71.

When a central thickness of the first lens element E1 is CT1, and the central thickness of the third lens element E3 is CT3, the following condition is satisfied: CT1/CT3=2.30.

When the central thickness of the first lens element E1 is CT1, and an axial distance between the second lens element E2 and the third lens element E3 is T23, the following condition is satisfied: CT1/T23=1.84.

When an Abbe number of the first lens element E1 is V1, and a refractive index of the first lens element E1 is N1, the following condition is satisfied: V1/N1=26.57.

When an Abbe number of the fourth lens element E4 is V4, the following condition is satisfied: V4=19.5.

When a maximum effective radius of the object-side surface of the first lens element E1 is Y1R1, and a maximum effective radius of the image-side surface of the fourth lens element E4 is Y4R2, the following condition is satisfied: Y1R1/Y4R2=1.37.

The detailed optical data of the 1st embodiment are shown in Table 1A and Table 1B, and the aspheric surface data are shown in Table 1C below.

TABLE 1A
1st Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.398 | | | | |
| 2 | Lens 1 | 9.3541 | (ASP) | 0.972 | Glass | 1.788 | 47.5 | 17.10 |
| 3 | | 29.1816 | (ASP) | 0.098 | | | | |
| 4 | Lens 2 | 3.1095 | (ASP) | 0.684 | Plastic | 1.587 | 28.3 | −190.27 |
| 5 | | 2.7791 | (ASP) | 0.528 | | | | |
| 6 | Lens 3 | −18.3928 | (ASP) | 0.423 | Plastic | 1.544 | 56.0 | 13.64 |
| 7 | | −5.3307 | (ASP) | D1 | | | | |
| 8 | Lens 4 | −2.6308 | (ASP) | 0.570 | Plastic | 1.669 | 19.5 | −15.89 |
| 9 | | −3.7997 | (ASP) | −0.224 | | | | |

| | | | | | | | |
|---|---|---|---|---|---|---|---|
| 10 | Stop | Plano | 0.600 | | | | |
| 11 | Reflective | Plano | 15.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 0.376 | | | | |
| 15 | Image | Plano | — | | | | |

Note:
Reference wavelength is 587.6 nm (d-line).
An effective radius of the stop S1 (Surface 10) is 2.020 mm.

In Table 1A, the curvature radius, the thickness and the focal length are shown in millimeters (mm). Surface numbers 0-15 represent the surfaces sequentially arranged from the object side to the image side along the optical axis.

TABLE 1B
Optical data for optical imaging lens assembly with
infinite object distance and finite object distance

| | Infinite | | Finite |
|---|---|---|---|
| | object distance | | object distance |
| | (First state) | | (Second state) |
| f [mm] | 15.01 | f [mm] | 14.62 |
| Fno | 2.70 | Fno | 2.79 |
| HFOV [deg.] | 15.1 | HFOV [deg.] | 14.7 |
| object distance | ∞ | object distance | 299.602 |
| [mm] | | [mm] | |
| D0 [mm] | ∞ | D0 [mm] | 300.000 |
| D1 [mm] | 1.010 | D1 [mm] | 1.251 |

Table 1B shows optical data of the first state and the second state of the optical imaging lens assembly in different focusing conditions. It should be understood that only two movement focus conditions (i.e., the first state and the second state) are disclosed in this embodiment, but the present disclosure is not limited thereto. The optical imaging lens assembly of this embodiment can further have other focal lengths corresponding to the intermediate range of the first state and the second state in other movement focus conditions 5 besides the first state and the second state for different object distances.

It can be known from Table 1B, when the object distance DO varies to 299.602 millimeters from infinity, the optical imaging lens assembly changes to the second state from the first state, the axial distance between the image-side surface of the third lens element E3 and the object-side surface of the fourth lens element E4 increases to 1.251 millimeters of the second state from 1.010 millimeters of the first state.

TABLE 1C
Aspheric Coefficients

| Surface # | 2 | 3 | 4 | 5 |
|---|---|---|---|---|
| k= | 0.00000E+00 | 0.00000E+00 | −7.12622E−01 | −6.94242E−01 |
| A4= | 7.18721341E−03 | −2.69882271E−03 | −3.70213389E−02 | −3.85697350E−02 |
| A6= | −3.46424828E−03 | −4.47495160E−03 | −7.62163512E−03 | −2.98703092E−02 |
| A8= | 9.69368594E−04 | 2.74678428E−03 | 1.09886084E−02 | 4.10807283E−02 |
| A10= | −1.61327721E−04 | −7.20760659E−04 | −5.06801618E−03 | −2.60537744E−02 |
| A12= | 1.47729890E−05 | 1.00038286E−04 | 1.43159741E−03 | 1.05226671E−02 |
| A14= | −6.51463112E−07 | −7.14519610E−06 | −2.69031780E−04 | −2.80599735E−03 |
| A16= | 8.71719860E−09 | 2.05805278E−07 | 3.17996057E−05 | 4.67698675E−04 |
| A18= | — | — | −1.70867643E−06 | −4.06471274E−05 |
| A20= | — | — | −7.27658050E−08 | 3.59432112E−07 |
| A22= | — | — | 1.53176798E−08 | 2.21673294E−07 |
| A24= | — | — | −6.15272342E−10 | −1.24701656E−08 |
| Surface # | 6 | 7 | 8 | 9 |
| k= | 3.45709E+01 | −2.39222E+00 | −5.26947E−01 | 3.13804E−01 |
| A4= | 1.90001360E−02 | 2.67259461E−02 | 3.50367419E−02 | 2.71405974E−02 |
| A6= | −9.41486770E−02 | −7.53050544E−02 | −3.00791393E−02 | −1.98277612E−02 |
| A8= | 1.14248842E−01 | 9.53333255E−02 | 4.62821142E−02 | 2.96720370E−02 |
| A10= | −7.70512268E−02 | −6.95607239E−02 | −4.58122363E−02 | −2.73654071E−02 |
| A12= | 3.46323829E−02 | 3.43626953E−02 | 3.03170207E−02 | 1.63507520E−02 |
| A14= | −1.07917037E−02 | −1.19138881E−02 | −1.38302056E−02 | −6.47641527E−03 |
| A16= | 2.30875789E−03 | 2.88093654E−03 | 4.36313818E−03 | 1.68736642E−03 |
| A18= | −3.27920705E−04 | −4.72918373E−04 | −9.33592930E−04 | −2.77470584E−04 |
| A20= | 2.91205613E−05 | 5.00304822E−05 | 1.29156513E−04 | 2.60642468E−05 |
| A22= | −1.43933560E−06 | −3.07033579E−06 | −1.04139685E−05 | −1.06467823E−06 |
| A24= | 2.95131622E−08 | 8.29989270E−08 | 3.71530139E−07 | — |

In Table 1C, k represents the conic coefficient of the equation of the aspheric surface profiles. A4-A24 represent the aspheric coefficients ranging from the 4th order to the 24th order. The tables presented below for each embodiment are the corresponding schematic parameter and aberration curves, and the definitions of the tables are the same as Table 1A to Table 1C of the 1st embodiment. Therefore, an explanation in this regard will not be provided again.

### 2nd Embodiment

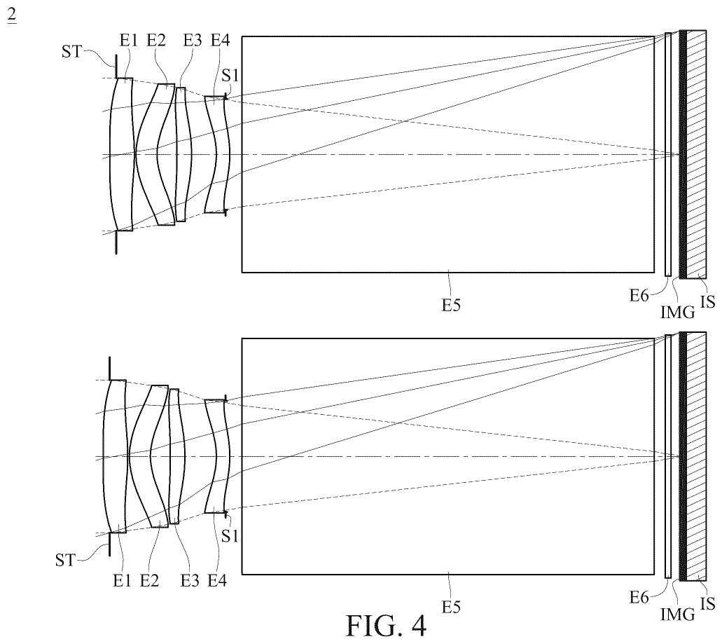

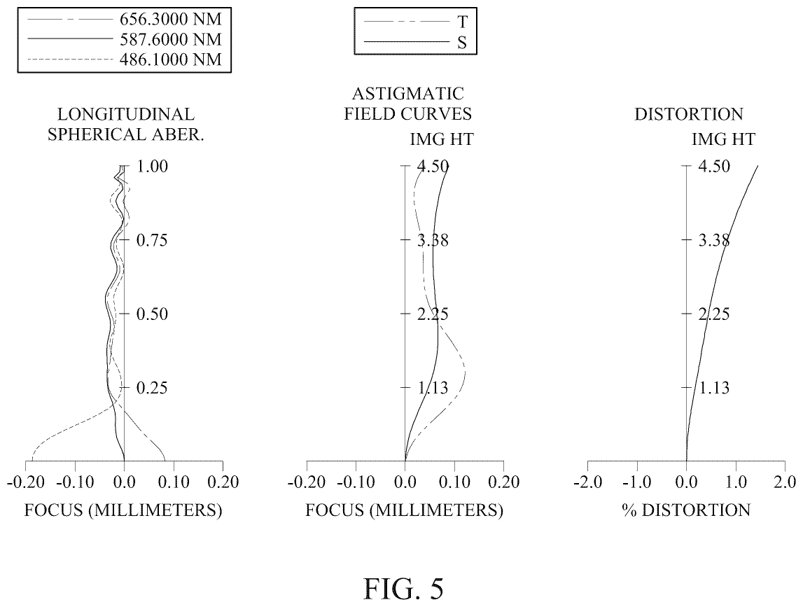

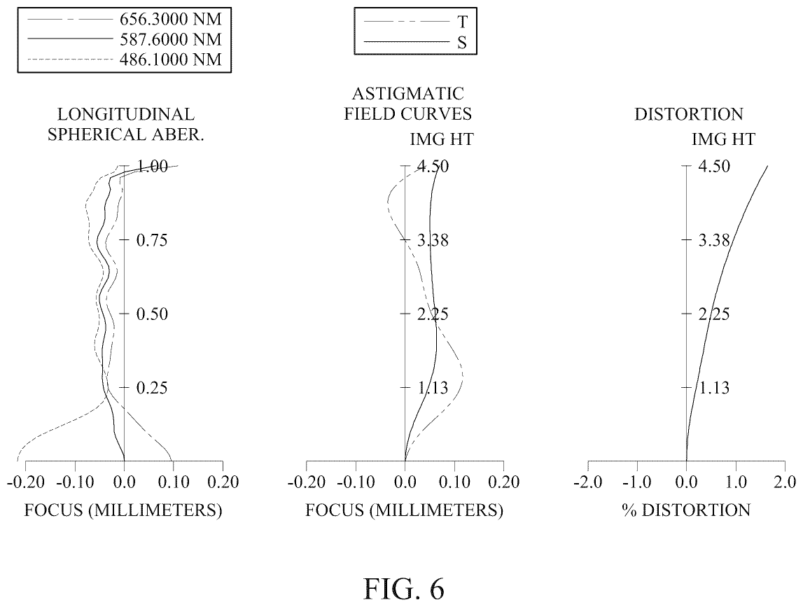

FIG. 4 is a schematic view of an image capturing unit at the first state (corresponding to an infinite object distance) and the second state (corresponding to a finite object distance) according to the 2nd embodiment of the present disclosure. FIG. 5 shows, in order from left to right, spherical aberration curves, astigmatic field curves and a distortion curve of the image capturing unit at the first state according to the 2nd embodiment. FIG. 6 shows, in order from left to right, spherical aberration curves, astigmatic field curves and a distortion curve of the image capturing unit at the second state according to the 2nd embodiment. The upper part of FIG. 4 shows the optical imaging lens assembly at the first state, and the lower part of FIG. 4 shows the optical imaging lens assembly at the second state. In FIG. 4, the image capturing unit 2 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.769 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 4 and the second state as shown in the lower part of FIG. 4.

The first lens element E1 with positive refractive power has an object-side surface being concave in a paraxial region thereof and an image-side surface being convex in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point. The object-side surface of the first lens element E1 has one critical point in an off-axis region thereof. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 4 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

The detailed optical data of the 2nd embodiment are shown in Table 2A and Table 2B, and the aspheric surface data are shown in Table 2C below.

TABLE 2A
2nd Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.231 | | | | |
| 2 | Lens 1 | −76.9231 | (ASP) | 0.888 | Glass | 1.591 | 60.6 | 34.44 |
| 3 | | −16.1636 | (ASP) | 0.060 | | | | |
| 4 | Lens 2 | 2.1525 | (ASP) | 0.766 | Plastic | 1.616 | 25.3 | 43.91 |
| 5 | | 2.0216 | (ASP) | 0.724 | | | | |
| 6 | Lens 3 | −34.4131 | (ASP) | 0.531 | Plastic | 1.544 | 56.0 | 13.00 |
| 7 | | −5.8976 | (ASP) | D1 | | | | |
| 8 | Lens 4 | −2.7116 | (ASP) | 0.488 | Plastic | 1.669 | 19.5 | −15.56 |
| 9 | | −3.9316 | (ASP) | −0.155 | | | | |

| | | | | | | | |
|---|---|---|---|---|---|---|---|
| 10 | Stop | Plano | 0.600 | | | | |
| 11 | Reflective | Plano | 15.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 0.316 | | | | |
| 15 | Image | Plano | — | | | | |

Note:
Reference wavelength is 587.6 nm (d-line).
An effective radius of the stop S1 (Surface 10) is 2.020 mm.

TABLE 2B
Optical data for optical imaging lens assembly with
infinite object distance and finite object distance

| | Infinite | | Finite |
|---|---|---|---|
| | object distance | | object distance |
| | (First state) | | (Second state) |
| f [mm] | 15.04 | f [mm] | 14.64 |
| Fno | 2.71 | Fno | 2.79 |
| HFOV [deg.] | 16.4 | HFOV [deg.] | 16.0 |
| object distance | ∞ | object distance | 299.769 |
| [mm] | | [mm] | |
| D0 [mm] | ∞ | D0 [mm] | 300.000 |
| D1 [mm] | 0.904 | D1 [mm] | 1.145 |

In Table 2B, the optical data is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 2C
Aspheric Coefficients

| Surface # | 2 | 3 | 4 | 5 |
|---|---|---|---|---|
| k= | 0.00000E+00 | 0.00000E+00 | −8.27533E−01 | −8.54268E−01 |
| A4= | 2.00435135E−02 | −9.23478678E−02 | −1.35887652E−01 | −6.72518168E−02 |
| A6= | −1.74126853E−02 | 1.43898464E−01 | 1.16742145E−01 | −4.72101087E−02 |
| A8= | 1.76228286E−02 | −1.07113141E−01 | −2.79981401E−02 | 1.97842722E−01 |
| A10= | −1.17776243E−02 | 4.83442411E−02 | −3.42766055E−02 | −2.57393155E−01 |
| A12= | 5.05582451E−03 | −1.41388717E−02 | 3.66989993E−02 | 1.93198262E−01 |
| A14= | −1.43192941E−03 | 2.73517060E−03 | −1.80479260E−02 | −9.62972270E−02 |
| A16= | 2.71333439E−04 | −3.45515969E−04 | 5.60989026E−03 | 3.38897167E−02 |
| A18= | −3.41076743E−05 | 2.69015534E−05 | −1.19916060E−03 | −8.65847866E−03 |
| A20= | 2.73339612E−06 | −1.09285778E−06 | 1.81013886E−04 | 1.61526674E−03 |
| A22= | −1.26564310E−07 | 9.18955692E−09 | −1.91718230E−05 | −2.17055151E−04 |
| A24= | 2.57893274E−09 | 5.53336638E−10 | 1.36659420E−06 | 2.02744537E−05 |
| A26= | — | — | −5.91588829E−08 | −1.22905384E−06 |
| A28= | — | — | 1.17754952E−09 | 4.22259711E−08 |
| A30= | — | — | — | −5.87075945E−10 |
| Surface # | 6 | 7 | 8 | 9 |
| k= | 6.36269E+01 | −5.34790E−01 | −6.32241E−01 | −8.03835E−02 |
| A4= | −6.80937859E−03 | 7.26878638E−03 | 3.20640826E−02 | 2.84488497E−02 |
| A6= | −5.32176889E−02 | −4.36994266E−02 | −2.66564273E−02 | −2.58619218E−02 |
| A8= | 1.48893431E−01 | 1.05638815E−01 | 6.83860622E−02 | 5.87163992E−02 |
| A10= | −1.83674417E−01 | −1.26916386E−01 | −1.09045355E−01 | −8.21077220E−02 |
| A12= | 1.36322954E−01 | 9.30416842E−02 | 1.13557087E−01 | 7.49049453E−02 |
| A14= | −6.76878560E−02 | −4.45846518E−02 | −8.13986514E−02 | −4.64949443E−02 |
| A16= | 2.36722153E−02 | 1.42247254E−02 | 4.12511026E−02 | 2.00186362E−02 |
| A18= | −5.95878578E−03 | −2.91872439E−03 | −1.49188064E−02 | −5.98519852E−03 |
| A20= | 1.07774097E−03 | 3.22030399E−04 | 3.82802399E−03 | 1.21998042E−03 |
| A22= | −1.36489638E−04 | 3.07756059E−06 | −6.80664384E−04 | −1.61762810E−04 |
| A24= | 1.13990887E−05 | −6.85637099E−06 | 7.97230107E−05 | 1.25784663E−05 |
| A26= | −5.49828729E−07 | 1.03565503E−06 | −5.52990899E−06 | −4.35169486E−07 |
| A28= | 1.00704754E−08 | −7.15832828E−08 | 1.72015614E−07 | — |
| A30= | 1.18070496E−10 | 2.00100682E−09 | — | — |

In the 2nd embodiment, the equation of the aspheric surface profiles of the aforementioned lens elements is the same as the equation of the 1st embodiment. Also, the definitions of these parameters shown in Table 2D and Table 2E are the same as those stated in the 1st embodiment with corresponding values for the 2nd embodiment, so an explanation in this regard will not be provided again.

TABLE 2D
Schematic Parameters for optical imaging lens assembly with
infinite object distance and finite object distance

| | Infinite object distance | Finite object distance |
|---|---|---|
| | (First state) | (Second state) |
| f [mm] | 15.04 | 14.64 |
| Fno | 2.71 | 2.79 |
| HFOV [deg.] | 16.4 | 16.0 |
| FOV [deg.] | 32.8 | 32.0 |
| TL/ImgH | 4.61 | 4.66 |
| TL/f | 1.38 | 1.43 |
| BL/f | 1.09 | 1.12 |
| TD/BL | 0.27 | 0.28 |
| ΣCT/ΣAT | 1.58 | 1.39 |
| f/f2 | 0.34 | 0.33 |
| \|f/R7\| + \|f/R8\| | 9.37 | 9.12 |
| TL/R5 | −0.60 | −0.61 |
| CT3/T34 | 0.59 | 0.46 |
| T12/T34 | 0.07 | 0.05 |

TABLE 2E
Schematic Parameters

| | | | |
|---|---|---|---|
| \|f1/f3\| | 2.65 | \|R8/R1\| | 0.05 |
| \|f3/f2\| | 0.30 | \|R8/R6\| | 0.67 |
| \|f4/f2\| | 0.35 | CT1/CT3 | 1.67 |
| \|f2\|/\|fi\|max | 1.00 | CT1/T23 | 1.23 |
| \|R3/R2\| | 0.13 | V1/N1 | 38.09 |
| \|R3/R6\| | 0.36 | V4 | 19.5 |
| \|R4/R5\| | 0.06 | Y1R1/Y4R2 | 1.37 |

### 3rd Embodiment

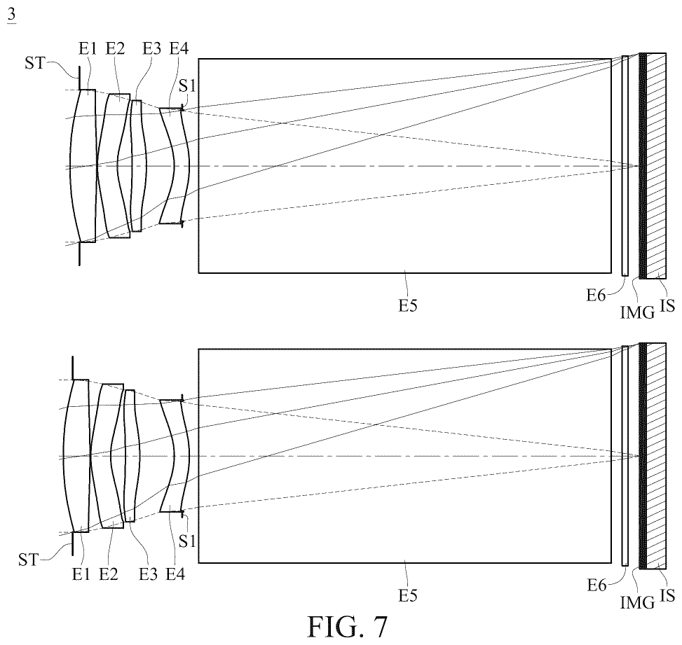

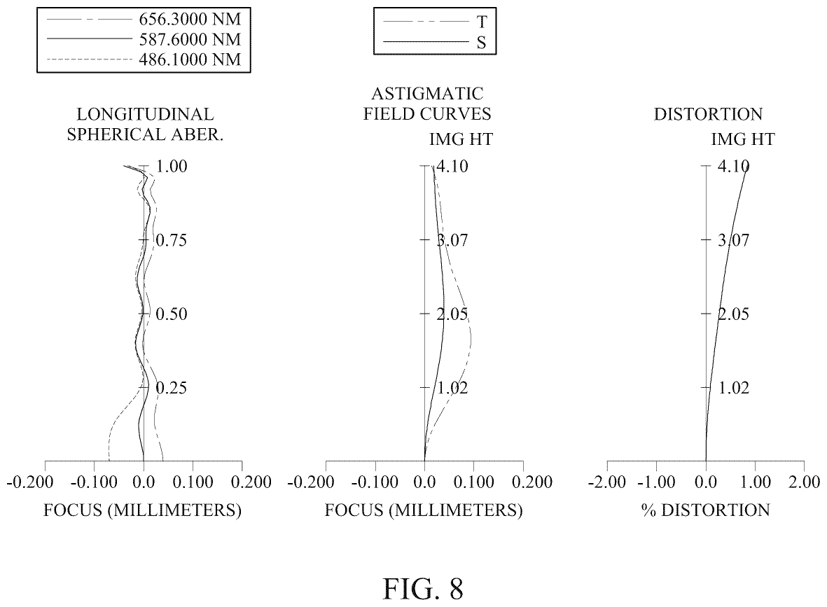

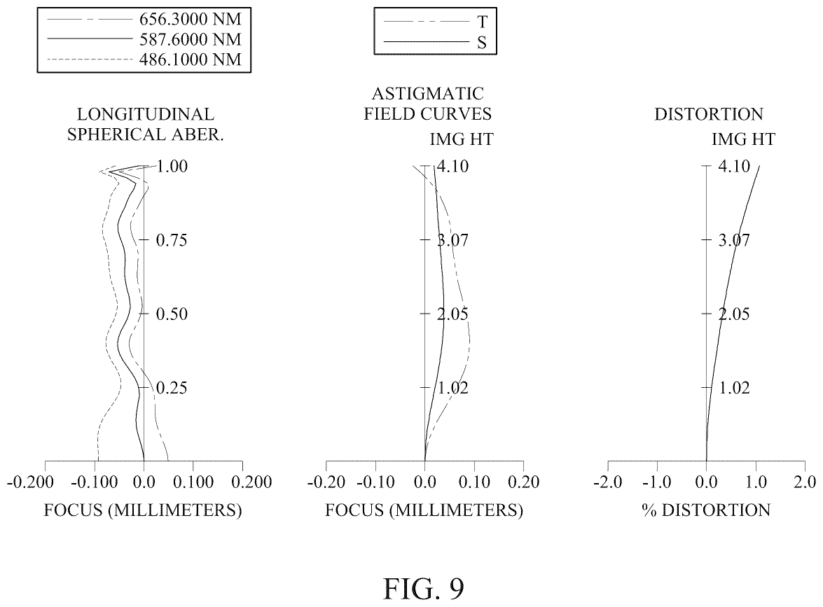

FIG. 7 is a schematic view of an image capturing unit at the first state (corresponding to an infinite object distance) and the second state (corresponding to a finite object distance) according to the 3rd embodiment of the present disclosure. FIG. 8 shows, in order from left to right, spherical aberration curves, astigmatic field curves and a distortion curve of the image capturing unit at the first state according to the 3rd embodiment. FIG. 9 shows, in order from left to right, spherical aberration curves, astigmatic field curves and a distortion curve of the image capturing unit at the second state according to the 3rd embodiment. The upper part of FIG. 7 shows the optical imaging lens assembly at the first state, and the lower part of FIG. 7 shows the optical imaging lens assembly at the second state. In FIG. 7, the image capturing unit 3 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.659 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 7 and the second state as shown in the lower part of FIG. 7.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The object-side surface of the first lens element E1 has one inflection point. The image-side surface of the first lens element E1 has four inflection points. The image-side surface of the first lens element E1 has two critical points in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has two inflection points. The object-side surface of the third lens element E3 has one critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

The reflective element E5 is made of glass material and is a prism which provides an optical path folding function. For simplicity, the light-folding effect generated by the reflective element E5 in FIG. 7 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

The detailed optical data of the 3rd embodiment are shown in Table 3A and Table 3B, and the aspheric surface data are shown in Table 3C below.

TABLE 3A
3rd Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.341 | | | | |
| 2 | Lens 1 | 11.8052 | (ASP) | 0.966 | Glass | 1.806 | 40.7 | 13.12 |
| 3 | | −97.6940 | (ASP) | 0.030 | | | | |
| 4 | Lens 2 | 3.1773 | (ASP) | 0.723 | Plastic | 1.587 | 28.3 | −33.05 |
| 5 | | 2.5004 | (ASP) | 0.535 | | | | |
| 6 | Lens 3 | −36.2851 | (ASP) | 0.523 | Plastic | 1.544 | 56.0 | 13.23 |
| 7 | | −6.0367 | (ASP) | D1 | | | | |
| 8 | Lens 4 | −2.4994 | (ASP) | 0.551 | Plastic | 1.669 | 19.5 | −16.52 |
| 9 | | −3.5150 | (ASP) | −0.267 | | | | |

| | | | | | | | |
|---|---|---|---|---|---|---|---|
| 10 | Stop | Plano | 0.600 | | | | |
| 11 | Reflective | Plano | 15.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 0.420 | | | | |
| 15 | Image | Plano | — | | | | |

Note:
Reference wavelength is 587.6 nm (d-line).
An effective radius of the stop S1 (Surface 10) is 2.023 mm.

TABLE 3B
Optical data for optical imaging lens assembly with
infinite object distance and finite object distance

| | Infinite object | | Finite object |
|---|---|---|---|
| | distance | | distance |
| | (First state) | | (Second state) |
| f [mm] | 15.01 | f [mm] | 14.64 |
| Fno | 2.70 | Fno | 2.79 |
| HFOV [deg.] | 15.1 | HFOV [deg.] | 14.7 |
| object distance | ∞ | object distance | 299.659 |
| [mm] | | [mm] | |
| D0 [mm] | ∞ | D0 [mm] | 300.000 |
| D1 [mm] | 1.012 | D1 [mm] | 1.253 |

In Table 3B, the optical data is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 3C
Aspheric Coefficients

| Surface # | 2 | 3 | 4 | 5 |
|---|---|---|---|---|
| k= | 0.00000E+00 | 0.00000E+00 | −5.89172E−01 | −7.21830E−01 |
| A4= | 6.35463882E−03 | −1.62480541E−02 | −5.25177128E−02 | −3.55004808E−02 |
| A6= | −3.23304666E−03 | 1.05474821E−02 | 4.81802406E−03 | −3.35061748E−02 |
| A8= | 1.28272255E−03 | −2.98450116E−03 | 1.03629960E−02 | 4.07676246E−02 |
| A10= | −3.07074510E−04 | 4.13884920E−04 | −7.10746437E−03 | −2.16019006E−02 |
| A12= | 4.06979174E−05 | −2.37134783E−05 | 2.23052683E−03 | 6.42986971E−03 |
| A14= | −2.78444901E−06 | −1.13967813E−07 | −3.97925583E−04 | −1.11383092E−03 |
| A16= | 7.67542458E−08 | 4.45562596E−08 | 4.17439057E−05 | 1.08680928E−04 |
| A18= | — | — | −2.41936161E−06 | −5.29843497E−06 |
| A20= | — | — | 6.02666308E−08 | 9.11924478E−08 |
| Surface # | 6 | 7 | 8 | 9 |
| k= | −5.08397E+01 | −1.69487E+00 | −5.47912E−01 | 1.96422E−01 |
| A4= | 4.99785363E−03 | 8.57749965E−03 | 2.28411877E−02 | 2.04700551E−02 |
| A6= | −4.80143819E−02 | −3.20094477E−02 | −6.43184257E−03 | −6.28918538E−03 |
| A8= | 5.24648366E−02 | 4.01602137E−02 | 1.30046454E−02 | 1.09641711E−02 |
| A10= | −2.67591342E−02 | −2.38015328E−02 | −1.12510775E−02 | −9.01994893E−03 |
| A12= | 7.74473170E−03 | 8.48790985E−03 | 5.45091003E−03 | 4.33595179E−03 |
| A14= | −1.29172074E−03 | −1.90085749E−03 | −1.61134399E−03 | −1.28981112E−03 |
| A16= | 1.14139238E−04 | 2.59748843E−04 | 2.89625589E−04 | 2.34416036E−04 |
| A18= | −3.93709201E−06 | −1.97150396E−05 | −2.91258776E−05 | −2.38586000E−05 |
| A20= | −2.30374632E−08 | 6.35382867E−07 | 1.25678782E−06 | 1.04123230E−06 |

In the 3rd embodiment, the equation of the aspheric surface profiles of the aforementioned lens elements is the same as the equation of the 1st embodiment. Also, the definitions of these parameters shown in Table 3D and Table 3E are the same as those stated in the 1st embodiment with corresponding values for the 3rd embodiment, so an explanation in this regard will not be provided again.

TABLE 3D
Schematic Parameters for optical imaging lens assembly with
infinite object distance and finite object distance

| | Infinite object distance | Finite object distance |
|---|---|---|
| | (First state) | (Second state) |
| f [mm] | 15.01 | 14.64 |
| Fno | 2.70 | 2.79 |
| HFOV [deg.] | 15.1 | 14.7 |
| FOV [deg.] | 30.2 | 29.4 |
| TL/ImgH | 5.05 | 5.11 |
| TL/f | 1.38 | 1.43 |
| BL/f | 1.09 | 1.12 |
| TD/BL | 0.27 | 0.28 |
| ΣCT/ΣAT | 1.75 | 1.52 |
| f/f2 | −0.45 | −0.44 |
| \|f/R7\| + \|f/R8\| | 10.28 | 10.03 |
| TL/R5 | −0.57 | −0.58 |
| CT3/T34 | 0.52 | 0.42 |
| T12/T34 | 0.03 | 0.02 |

TABLE 3E
Schematic Parameters

| | | | |
|---|---|---|---|
| \|f1/f3\| | 0.99 | \|R8/R1\| | 0.30 |
| \|f3/f2\| | 0.40 | \|R8/R6\| | 0.58 |
| \|f4/f2\| | 0.50 | CT1/CT3 | 1.85 |
| \|f2\|/\|fi\|max | 1.00 | CT1/T23 | 1.81 |
| \|R3/R2\| | 0.03 | V1/N1 | 22.54 |
| \|R3/R6\| | 0.53 | V4 | 19.5 |
| \|R4/R5\| | 0.07 | Y1R1/Y4R2 | 1.37 |

### 4th Embodiment

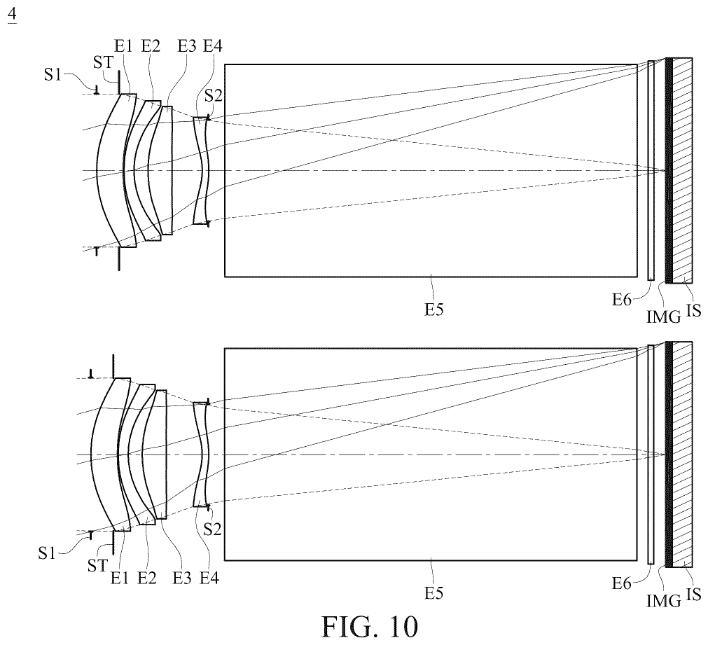

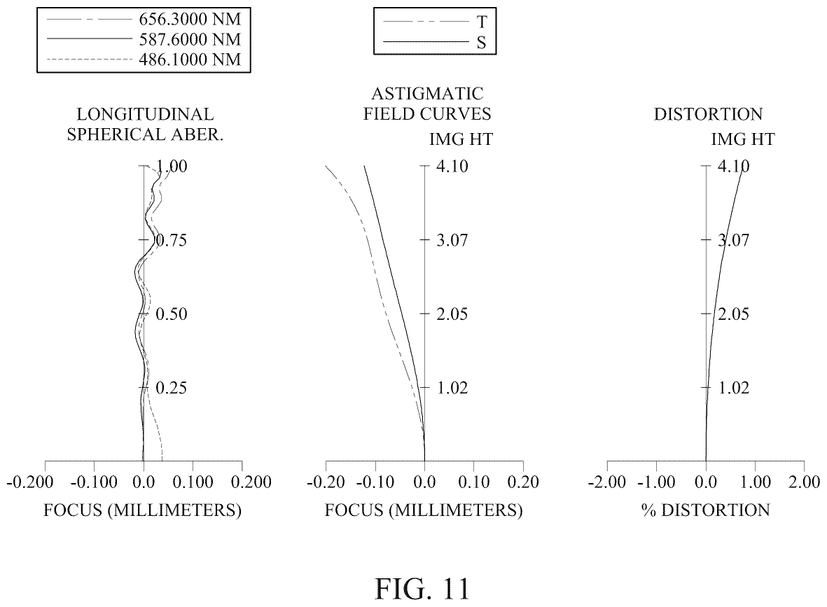

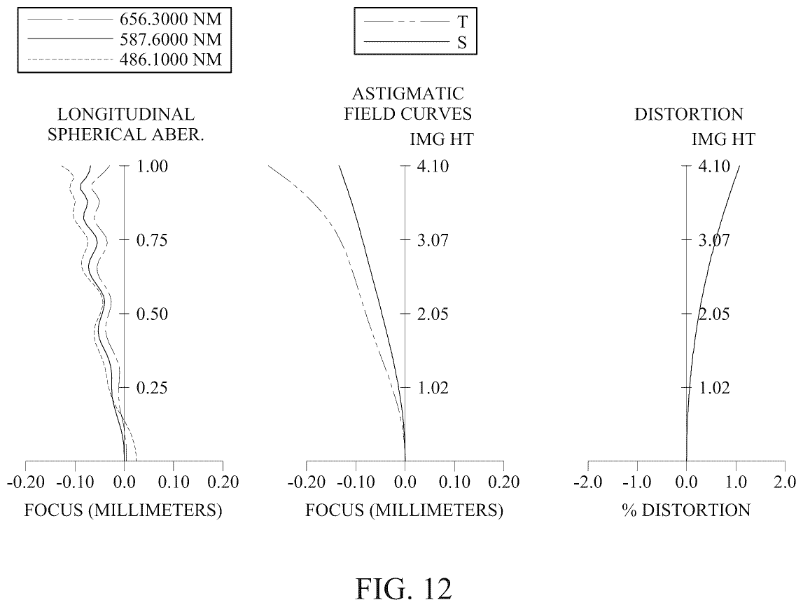

FIG. 10 is a schematic view of an image capturing unit respectively at the first state (corresponding to an infinite object distance) and the second state (corresponding to a finite object distance) according to the 4th embodiment of the present disclosure. FIG. 11 shows, in order from left to right, spherical aberration curves, astigmatic field curves and a distortion curve of the image capturing unit at the first state according to the 4th embodiment. FIG. 12 shows, in order from left to right, spherical aberration curves, astigmatic field curves and a distortion curve of the image capturing unit at the second state according to the 4th embodiment. The upper part of FIG. 10 shows the optical imaging lens assembly at the first state, and the lower part of FIG. 10 shows the optical imaging lens assembly at the second state. In FIG. 10, the image capturing unit 4 includes the optical imaging lens assembly (its reference numeral is omitted) of the present disclosure and an image sensor IS. The optical imaging lens assembly includes, in order from an object side to an image side along an optical path, a stop S1, an aperture stop ST, a first lens element E1, a second lens element E2, a third lens element E3, a fourth lens element E4, a stop S2, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 300.010 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 10 and the second state as shown in the lower part of FIG. 10.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The image-side surface of the first lens element E1 has two inflection points.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has three inflection points. The image-side surface of the third lens element E3 has three critical points in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 10 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

In this embodiment, an axial distance between the aperture stop ST and the stop S1 is defined as D0. An axial distance between the image-side surface of the filter E6 and the image surface IMG is defined as D2.

The detailed optical data of the 4th embodiment are shown in Table 4A and Table 4B, and the aspheric surface data are shown in Table 4C below.

TABLE 4A
4th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Stop | Plano | | 0.823 | | | | |
| 2 | Ape. Stop | Plano | | −0.813 | | | | |
| 3 | Lens 1 | 4.3182 | (ASP) | 0.964 | Glass | 1.802 | 41.0 | 12.74 |
| 4 | | 6.7370 | (ASP) | 0.030 | | | | |
| 5 | Lens 2 | 4.5550 | (ASP) | 0.363 | Plastic | 1.587 | 28.3 | −12.82 |
| 6 | | 2.7540 | (ASP) | 0.511 | | | | |
| 7 | Lens 3 | 4.2542 | (ASP) | 0.871 | Plastic | 1.544 | 56.0 | 7.67 |
| 8 | | −200.0000 | (ASP) | D1 | | | | |
| 9 | Lens 4 | −2.0771 | (ASP) | 0.240 | Plastic | 1.639 | 23.5 | −12.31 |
| 10 | | −2.9502 | (ASP) | −0.021 | | | | |

| | | | | | | | |
|---|---|---|---|---|---|---|---|
| 11 | Stop | Plano | 0.600 | | | | |
| 12 | Reflective | Plano | 15.000 | Glass | 1.804 | 46.6 | — |
| | element | | | | | | |
| 13 | | Plano | 0.400 | | | | |
| 14 | Filter | Plano | 0.210 | Glass | 1.517 | 64.2 | — |
| 15 | | Plano | D2 | | | | |
| 16 | Image | Plano | — | | | | |

Note:
Reference wavelength is 587.6 nm (d-line).
An effective radius of the stop S1 (Surface 1) is 2.800 mm.
An effective radius of the stop S2 (Surface 11) is 1.850 mm.

TABLE 4B
Optical data for optical imaging lens assembly with
infinite object distance and finite object distance

| | Infinite object | | Finite object |
|---|---|---|---|
| | distance | | distance |
| | (First state) | | (Second state) |
| f [mm] | 15.04 | f [mm] | 14.59 |
| Fno | 2.70 | Fno | 2.79 |
| HFOV [deg.] | 15.1 | HFOV [deg.] | 14.7 |
| object distance | ∞ | object distance | 300.010 |
| [mm] | | [mm] | |
| D0 [mm] | ∞ | D0 [mm] | 300.000 |
| D1 [mm] | 1.100 | D1 [mm] | 1.305 |
| D2 [mm] | 0.435 | D2 [mm] | 0.439 |

Except for D0 and D2, the optical data in Table 4B is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 4C
Aspheric Coefficients

| Surface # | 3 | 4 | 5 | 6 |
|---|---|---|---|---|
| k= | 0.00000E+00 | 0.00000E+00 | 1.68083E+00 | 1.35726E−01 |
| A4= | 2.90316092E−03 | 3.20308765E−02 | 1.61610876E−02 | −2.82971994E−02 |
| A6= | −3.09663796E−03 | −2.46018199E−02 | −1.32992870E−02 | 4.13729106E−03 |
| A8= | 1.40698404E−03 | 1.06358273E−02 | 2.17645253E−02 | 5.41717502E−02 |
| A10= | −3.73088608E−04 | −2.82809144E−03 | −2.64689338E−02 | −8.65146366E−02 |
| A12= | 5.37967652E−05 | 4.32344937E−04 | 1.83635015E−02 | 6.87780066E−02 |
| A14= | −4.03530824E−06 | −3.48819564E−05 | −8.05345123E−03 | −3.48378754E−02 |
| A16= | 1.24264478E−07 | 1.15398042E−06 | 2.38248152E−03 | 1.21177106E−02 |
| A18= | — | — | −4.87156891E−04 | −2.94168608E−03 |
| A20= | — | — | 6.81884098E−05 | 4.89349341E−04 |
| A22= | — | — | −6.23870141E−06 | −5.29935943E−05 |
| A24= | — | — | 3.35415505E−07 | 3.35335213E−06 |
| A26= | — | — | −8.01140267E−09 | −9.37818121E−08 |
| Surface # | 7 | 8 | 9 | 10 |
| k= | −4.79746E+00 | −4.50949E+00 | −2.36164E+00 | −5.88867E+00 |
| A4= | 4.63919864E−03 | −1.76849423E−03 | 5.64680592E−02 | 4.55421179E−02 |
| A6= | −6.96875437E−03 | 8.76016750E−03 | −1.30575809E−02 | −3.91913235E−03 |
| A8= | 2.60643416E−02 | −1.34689013E−02 | 4.04139217E−02 | 2.10747650E−02 |
| A10= | −3.09726792E−02 | 1.98787215E−02 | −8.82501775E−02 | −4.51973825E−02 |
| A12= | 2.06066155E−02 | −1.97397254E−02 | 1.01454062E−01 | 4.45956445E−02 |
| A14= | −9.23046104E−03 | 1.23176472E−02 | −7.34803741E−02 | −2.62983755E−02 |
| A16= | 2.96421871E−03 | −4.99172471E−03 | 3.57726584E−02 | 9.93138760E−03 |
| A18= | −6.86503097E−04 | 1.33927078E−03 | −1.19156790E−02 | −2.41145519E−03 |
| A20= | 1.11219721E−04 | −2.36280549E−04 | 2.68532915E−03 | 3.59784456E−04 |
| A22= | −1.18410004E−05 | 2.63378842E−05 | −3.92089103E−04 | −2.88348903E−05 |
| A24= | 7.37730222E−07 | −1.67896519E−06 | 3.35093611E−05 | 7.26259454E−07 |
| A26= | −2.02477802E−08 | 4.65365650E−08 | −1.27342572E−06 | 2.72800666E−08 |

In the 4th embodiment, the equation of the aspheric surface profiles of the aforementioned lens elements is the same as the equation of the 1st embodiment. Also, the definitions of these parameters shown in Table 4D and Table 4E are the same as those stated in the 1st embodiment with corresponding values for the 4th embodiment, so an explanation in this regard will not be provided again.

TABLE 4D
Schematic Parameters for optical imaging lens assembly with
infinite object distance and finite object distance

| | Infinite object distance | Finite object distance |
|---|---|---|
| | (First state) | (Second state) |
| f [mm] | 15.04 | 14.59 |
| Fno | 2.70 | 2.79 |
| HFOV [deg.] | 15.1 | 14.7 |
| FOV [deg.] | 30.2 | 29.4 |
| TL/ImgH | 5.05 | 5.11 |
| TL/f | 1.38 | 1.43 |
| BL/f | 1.11 | 1.14 |
| TD/BL | 0.25 | 0.26 |
| ΣCT/ΣAT | 1.49 | 1.32 |
| f/f2 | −1.17 | −1.14 |
| \|f/R7\| + \|f/R8\| | 12.34 | 11.97 |
| TL/R5 | 4.87 | 4.92 |
| CT3/T34 | 0.79 | 0.67 |
| T12/T34 | 0.03 | 0.02 |

TABLE 4E
Schematic Parameters

| | | | |
|---|---|---|---|
| \|f1/f3\| | 1.66 | \|R8/R1\| | 0.68 |
| \|f3/f2\| | 0.60 | \|R8/R6\| | 0.01 |
| \|f4/f2\| | 0.96 | CT1/CT3 | 1.11 |
| \|f2\|/\|fi\|max | 1.00 | CT1/T23 | 1.89 |
| \|R3/R2\| | 0.68 | V1/N1 | 22.75 |
| \|R3/R6\| | 0.02 | V4 | 23.5 |
| \|R4/R5\| | 0.65 | Y1R1/Y4R2 | 1.50 |

### 5th Embodiment

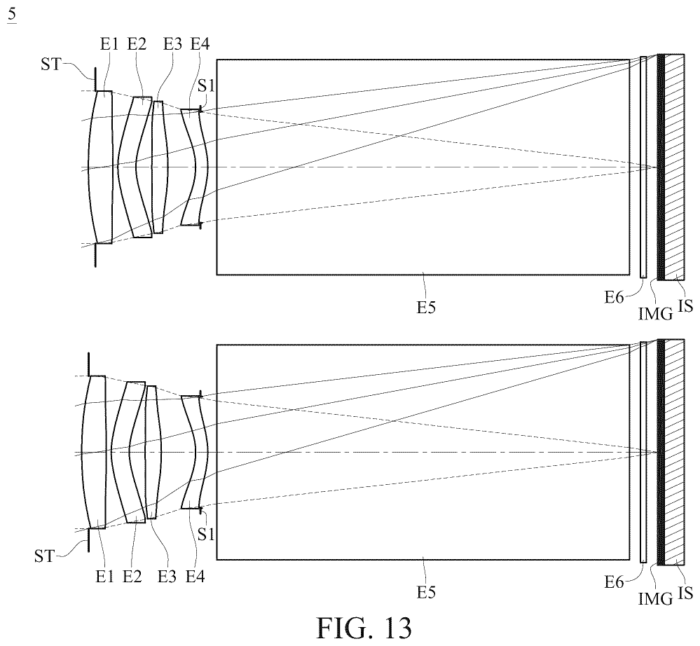

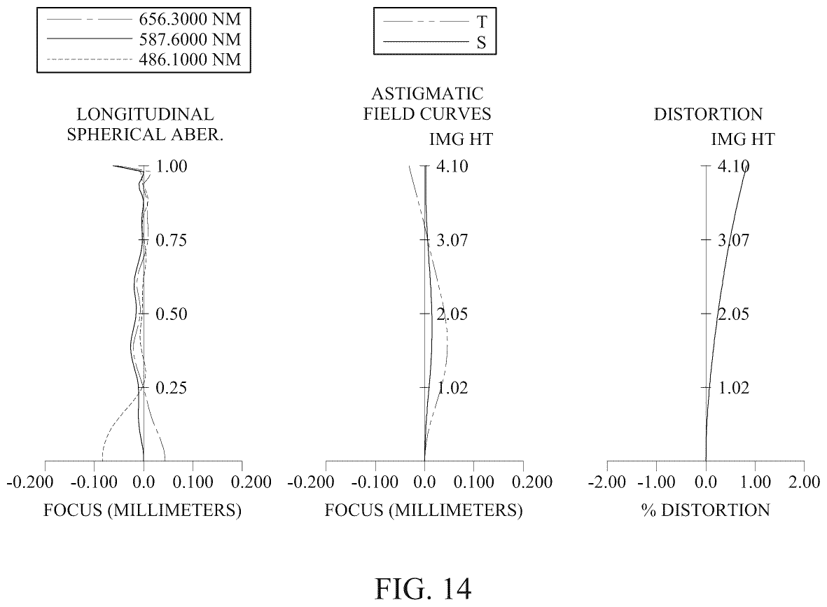

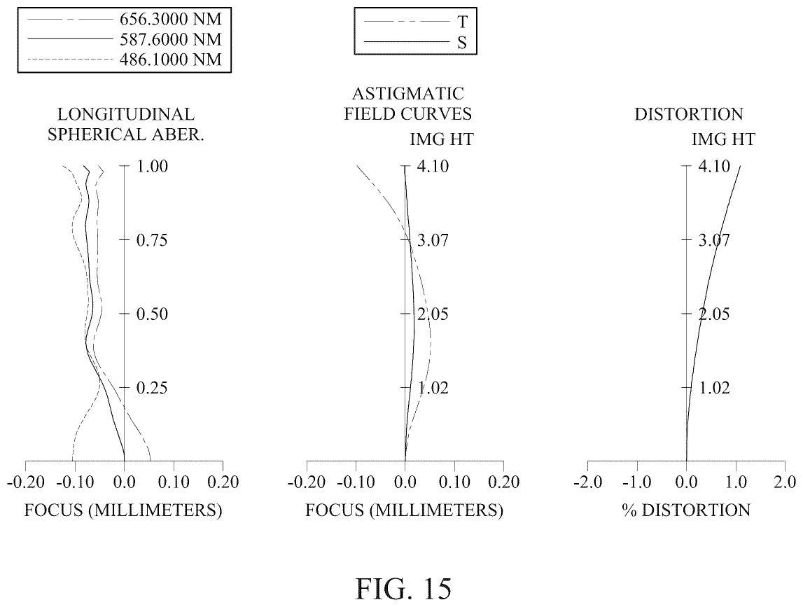

FIG. 13 is a schematic view of an image capturing unit at the first state (corresponding to an infinite object distance) and the second state (corresponding to a finite object distance) according to the 5th embodiment of the present disclosure. FIG. 14 shows, in order from left to right, spherical aberration curves, astigmatic field curves and a distortion curve of the image capturing unit at the first state according to the 5th embodiment. FIG. 15 shows, in order from left to right, spherical aberration curves, astigmatic field curves and a distortion curve of the image capturing unit at the second state according to the 5th embodiment. The upper part of FIG. 13 shows the optical imaging lens assembly at the first state, and the lower part of FIG. 13 shows the optical imaging lens assembly at the second state. In FIG. 13, the image capturing unit 5 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.746 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 13 and the second state as shown in the lower part of FIG. 13.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The object-side surface of the first lens element E1 has one inflection point. The image-side surface of the first lens element E1 has two inflection points. The image-side surface of the first lens element E1 has two critical points in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has three inflection points.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has four inflection points. The image-side surface of the third lens element E3 has three inflection points. The object-side surface of the third lens element E3 has two critical points in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 13 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

The detailed optical data of the 5th embodiment are shown in Table 5A and Table 5B, and the aspheric surface data are shown in Table 5C below.

TABLE 5A
5th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.254 | | | | |
| 2 | Lens 1 | 15.2721 | (ASP) | 0.889 | Glass | 1.806 | 40.7 | 16.76 |
| 3 | | −114.2338 | (ASP) | 0.184 | | | | |
| 4 | Lens 2 | 2.7041 | (ASP) | 0.656 | Plastic | 1.669 | 19.5 | −37.74 |
| 5 | | 2.2050 | (ASP) | 0.579 | | | | |
| 6 | Lens 3 | 19.9203 | (ASP) | 0.583 | Plastic | 1.544 | 56.0 | 11.29 |
| 7 | | −8.7840 | (ASP) | D1 | | | | |
| 8 | Lens 4 | −2.2742 | (ASP) | 0.441 | Plastic | 1.669 | 19.5 | −17.10 |
| 9 | | −3.0590 | (ASP) | −0.267 | | | | |

| | | | | | | | |
|---|---|---|---|---|---|---|---|
| 10 | Stop | Plano | 0.600 | | | | |
| 11 | Reflective | Plano | 15.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 0.417 | | | | |
| 15 | Image | Plano | — | | | | |

Note:
Reference wavelength is 587.6 nm (d-line).
An effective radius of the stop S1 (Surface 10) is 2.027 mm.

TABLE 5B
Optical data for optical imaging lens assembly with
infinite object distance and finite object distance

| | Infinite object | | Finite object |
|---|---|---|---|
| | distance | | distance |
| | (First state) | | (Second state) |
| f [mm] | 15.02 | f [mm] | 14.66 |
| Fno | 2.71 | Fno | 2.79 |
| HFOV [deg.] | 15.1 | HFOV [deg.] | 14.7 |
| object distance | ∞ | object distance | 299.746 |
| [mm] | | [mm] | |
| D0 [mm] | ∞ | D0 [mm] | 300.000 |
| D1 [mm] | 1.008 | D1 [mm] | 1.249 |

In Table 5B, the optical data is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 5C
Aspheric Coefficients

| Surface # | 2 | 3 | 4 | 5 |
|---|---|---|---|---|
| k= | 0.00000E+00 | 0.00000E+00 | −6.52338E−01 | −7.75674E−01 |
| A4= | 5.40966631E−03 | −1.20940842E−02 | −5.32932333E−02 | −6.09791935E−02 |
| A6= | −2.20215530E−03 | 8.65485892E−03 | 9.84819192E−03 | 1.70207337E−04 |
| A8= | 7.91665203E−04 | −2.80386647E−03 | 3.70365626E−03 | 1.20772406E−02 |
| A10= | −1.92924333E−04 | 4.92638799E−04 | −2.29577133E−03 | −3.89930441E−03 |
| A12= | 2.77784604E−05 | −4.55729895E−05 | 1.18713772E−04 | −8.93949189E−04 |
| A14= | −2.10366685E−06 | 1.88255163E−06 | 1.94436590E−04 | 8.58020406E−04 |
| A16= | 6.31447933E−08 | −1.97441377E−08 | −6.53743168E−05 | −2.33413730E−04 |
| A18= | — | — | 9.65956832E−06 | 3.18631162E−05 |
| A20= | — | — | −7.12996072E−07 | −2.22959235E−06 |
| A22= | — | — | 2.14789313E−08 | 6.39761447E−08 |
| Surface # | 6 | 7 | 8 | 9 |
| k= | −9.90000E+01 | 5.56664E+00 | −7.83105E−01 | −3.98190E−01 |
| A4= | −1.59429529E−02 | −3.96825326E−03 | 2.46361582E−02 | 2.33721323E−02 |
| A6= | −1.20632643E−02 | −7.92428198E−03 | 3.24346543E−03 | −1.47591453E−04 |
| A8= | 1.29517607E−02 | 1.23043687E−02 | −1.75491899E−04 | 4.07741934E−03 |
| A10= | 9.33447194E−06 | −4.86089448E−03 | −7.74168680E−04 | −4.93276296E−03 |
| A12= | −3.72621851E−03 | 3.00804528E−04 | −8.05563333E−06 | 3.07877011E−03 |
| A14= | 1.85364269E−03 | 3.65391951E−04 | 2.56772781E−04 | −1.24117849E−03 |
| A16= | −4.39124601E−04 | −1.35590011E−04 | −1.21670910E−04 | 3.34796568E−04 |
| A18= | 5.71558766E−05 | 2.19516806E−05 | 2.64008430E−05 | −5.79427153E−05 |
| A20= | −3.93614489E−06 | −1.76425800E−06 | −2.87990977E−06 | 5.76722205E−06 |
| A22= | 1.12466022E−07 | 5.72777270E−08 | 1.28350290E−07 | −2.49425782E−07 |

In the 5th embodiment, the equation of the aspheric surface profiles of the aforementioned lens elements is the same as the equation of the 1st embodiment. Also, the definitions of these parameters shown in Table 5D and Table 5E are the same as those stated in the 1st embodiment with corresponding values for the 5th embodiment, so an explanation in this regard will not be provided again.

TABLE 5D
Schematic Parameters for optical imaging lens assembly with
infinite object distance and finite object distance

| | Infinite object distance | Finite object distance |
|---|---|---|
| | (First state) | (Second state) |
| f [mm] | 15.02 | 14.66 |
| Fno | 2.71 | 2.79 |
| HFOV [deg.] | 15.1 | 14.7 |
| FOV [deg.] | 30.2 | 29.4 |
| TL/ImgH | 5.05 | 5.11 |
| TL/f | 1.38 | 1.43 |
| BL/f | 1.09 | 1.12 |
| TD/BL | 0.27 | 0.28 |
| ΣCT/ΣAT | 1.45 | 1.28 |
| f/f2 | −0.40 | −0.39 |
| \|f/R7\| + \|f/R8\| | 11.51 | 11.24 |
| TL/R5 | 1.04 | 1.05 |
| CT3/T34 | 0.58 | 0.47 |
| T12/T34 | 0.18 | 0.15 |

TABLE 5E
Schematic Parameters

| | | | |
|---|---|---|---|
| \|f1/f3\| | 1.49 | \|R8/R1\| | 0.20 |
| \|f3/f2\| | 0.30 | \|R8/R6\| | 0.35 |
| \|f4/f2\| | 0.45 | CT1/CT3 | 1.52 |
| \|f2\|/\|fi\|max | 1.00 | CT1/T23 | 1.54 |
| \|R3/R2\| | 0.02 | V1/N1 | 22.54 |
| \|R3/R6\| | 0.31 | V4 | 19.5 |
| \|R4/R5\| | 0.11 | Y1R1/Y4R2 | 1.36 |

### 6th Embodiment

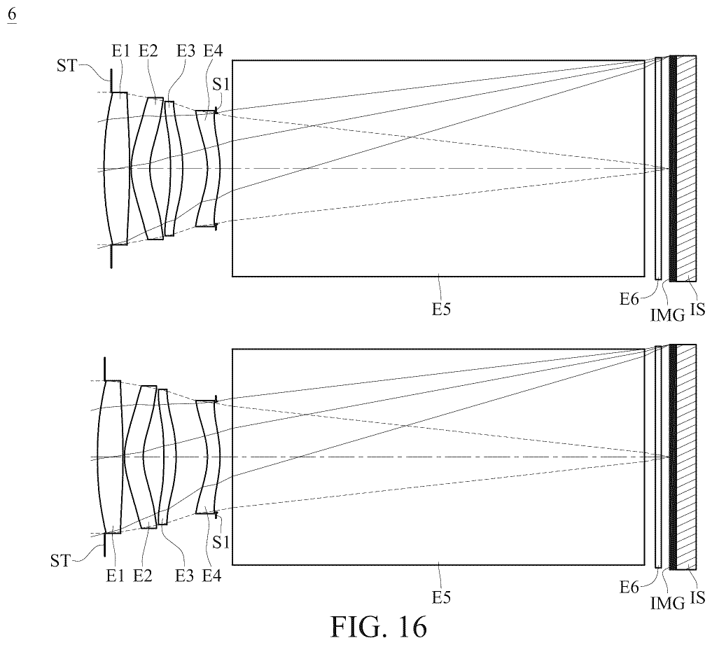

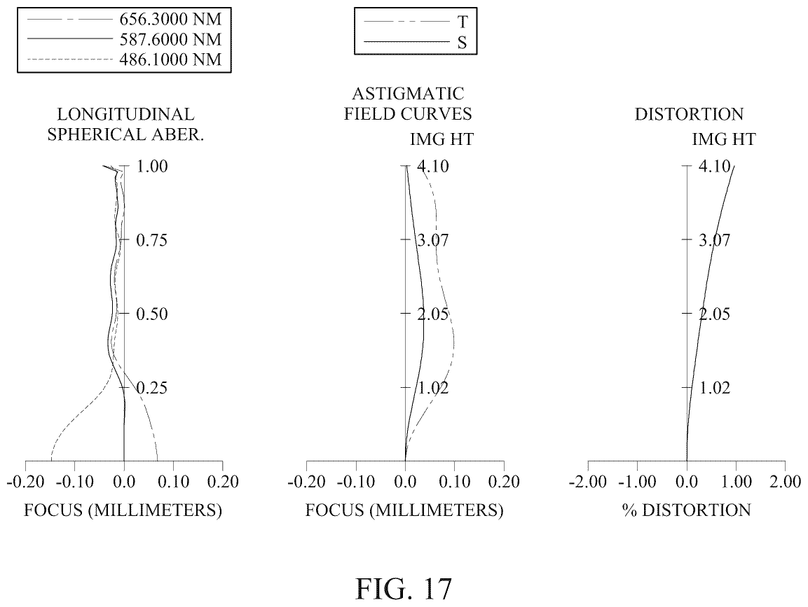

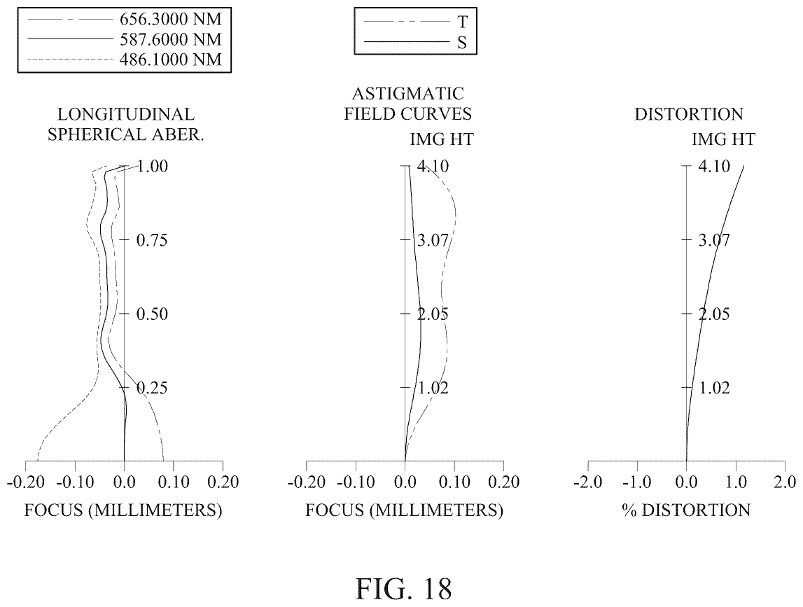

FIG. 16 is a schematic view of an image capturing unit at the first state (corresponding to an infinite object distance) and the second state (corresponding to a finite object distance) according to the 6th embodiment of the present disclosure. FIG. 17 shows, in order from left to right, spherical aberration curves, astigmatic field curves and a distortion curve of the image capturing unit at the first state according to the 6th embodiment. FIG. 18 shows, in order from left to right, spherical aberration curves, astigmatic field curves and a distortion curve of the image capturing unit at the second state according to the 6th embodiment. The upper part of FIG. 16 shows the optical imaging lens assembly at the first state, and the lower part of FIG. 16 shows the optical imaging lens assembly at the second state. In FIG. 16, the image capturing unit 6 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.736 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 16 and the second state as shown in the lower part of FIG. 16.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The image-side surface of the first lens element E1 has four inflection points. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has three inflection points. The image-side surface of the second lens element E2 has three inflection points.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 16 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

The detailed optical data of the 6th embodiment are shown in Table 6A and Table 6B, and the aspheric surface data are shown in Table 6C below.

TABLE 6A
6th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.264 | | | | |
| 2 | Lens 1 | 18.3279 | (ASP) | 0.923 | Glass | 1.720 | 50.6 | 30.39 |
| 3 | | 110.5006 | (ASP) | 0.060 | | | | |
| 4 | Lens 2 | 2.3817 | (ASP) | 0.682 | Plastic | 1.587 | 28.3 | 29.65 |
| 5 | | 2.4668 | (ASP) | 0.750 | | | | |
| 6 | Lens 3 | −12.6514 | (ASP) | 0.445 | Plastic | 1.544 | 56.0 | 16.22 |
| 7 | | −5.2630 | (ASP) | D1 | | | | |
| 8 | Lens 4 | −2.6730 | (ASP) | 0.458 | Plastic | 1.669 | 19.5 | −15.43 |
| 9 | | −3.8545 | (ASP) | −0.154 | | | | |

| | | | | | | | |
|---|---|---|---|---|---|---|---|
| 10 | Stop | Plano | 0.600 | | | | |
| 11 | Reflective | Plano | 15.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 0.309 | | | | |
| 15 | Image | Plano | — | | | | |

Note:
Reference wavelength is 587.6 nm (d-line).
An effective radius of the stop S1 (Surface 10) is 2.020 mm.

TABLE 6B
Optical data for optical imaging lens assembly with
infinite object distance and finite object distance

| | Infinite object | | Finite object |
|---|---|---|---|
| | distance | | distance |
| | (First state) | | (Second state) |
| f [mm] | 15.03 | f [mm] | 14.63 |
| Fno | 2.71 | Fno | 2.79 |
| HFOV [deg.] | 15.1 | HFOV [deg.] | 14.7 |
| object distance | ∞ | object distance | 299.736 |
| [mm] | | [mm] | |
| D0 [mm] | ∞ | D0 [mm] | 300.000 |
| D1 [mm] | 0.901 | D1 [mm] | 1.142 |

In Table 6B, the optical data is the same as the data of the 1st embodiment. The optical imaging lens assembly of this embodiment can further have other focal lengths corresponding to the intermediate range of the first state and the second state in other movement focusing 5 conditions besides the first state and the second state for different object distances.

TABLE 6C
Aspheric Coefficients

| Surface # | 2 | 3 | 4 | 5 |
|---|---|---|---|---|
| k= | 0.00000E+00 | 0.00000E+00 | −9.12672E−01 | −7.06822E−01 |
| A4= | 7.64882978E−03 | −3.00071049E−02 | −5.19610348E−02 | −1.18895574E−02 |
| A6= | −3.14116167E−03 | 1.81438037E−02 | 3.74678479E−03 | −4.36402627E−02 |
| A8= | 1.14208348E−03 | −5.60397048E−03 | 4.98205742E−03 | 3.02668237E−02 |
| A10= | −2.86479339E−04 | 9.55418612E−04 | −6.38205773E−04 | −6.70840629E−03 |
| A12= | 4.15425565E−05 | −8.91711081E−05 | −1.16222855E−03 | −2.39031928E−03 |
| A14= | −3.10348809E−06 | 4.19745798E−06 | 6.52782178E−04 | 2.19700549E−03 |
| A16= | 9.26616589E−08 | −7.56203742E−08 | −1.70653380E−04 | −7.56941938E−04 |
| A18= | — | — | 2.64401550E−05 | 1.50703674E−04 |
| A20= | — | — | −2.51405011E−06 | −1.80550384E−05 |
| A22= | — | — | 1.37076247E−07 | 1.20826644E−06 |
| A24= | — | — | −3.30750030E−09 | −3.47119366E−08 |
| Surface # | 6 | 7 | 8 | 9 |
| k= | 2.08738E+01 | 4.14536E−02 | −6.90177E−01 | −2.84799E−01 |
| A4= | 1.79789218E−02 | 1.88530162E−02 | 3.58030859E−02 | 2.93630097E−02 |
| A6= | −3.50156065E−02 | −3.12586820E−02 | −2.13255668E−02 | −1.59284970E−02 |
| A8= | 1.35736173E−02 | 2.25204223E−02 | 3.11015659E−02 | 2.38106513E−02 |
| A10= | 6.06555971E−03 | −7.63743739E−03 | −3.08744272E−02 | −2.25434257E−02 |
| A12= | −8.12421326E−03 | 8.11653710E−04 | 2.06785377E−02 | 1.37085383E−02 |
| A14= | 3.97450546E−03 | 4.88376199E−04 | −9.59234124E−03 | −5.50161867E−03 |
| A16= | −1.16843637E−03 | −2.85780645E−04 | 3.07917575E−03 | 1.44821206E−03 |
| A18= | 2.21484524E−04 | 7.53123795E−05 | −6.69060986E−04 | −2.39951201E−04 |
| A20= | −2.64302954E−05 | −1.12240022E−05 | 9.37194304E−05 | 2.26460750E−05 |
| A22= | 1.80034975E−06 | 9.05265362E−07 | −7.62987390E−06 | −9.26797236E−07 |
| A24= | −5.32056849E−08 | −3.06703638E−08 | 2.74214549E−07 | — |

In the 6th embodiment, the equation of the aspheric surface profiles of the aforementioned lens elements is the same as the equation of the 1st embodiment. Also, the definitions of these parameters shown in Table 6D and Table 6E are the same as those stated in the 1st embodiment with corresponding values for the 6th embodiment, so an explanation in this regard will not be provided again.

TABLE 6D
Schematic Parameters for optical imaging lens assembly with
infinite object distance and finite object distance

| | Infinite object distance | Finite object distance |
|---|---|---|
| | (First state) | (Second state) |
| f [mm] | 15.03 | 14.63 |
| Fno | 2.71 | 2.79 |
| HFOV [deg.] | 15.1 | 14.7 |
| FOV [deg.] | 30.2 | 29.4 |
| TL/ImgH | 5.03 | 5.08 |
| TL/f | 1.37 | 1.42 |
| BL/f | 1.09 | 1.12 |
| TD/BL | 0.26 | 0.27 |
| ΣCT/ΣAT | 1.47 | 1.28 |
| f/f2 | 0.51 | 0.49 |
| \|f/R7\| + \|f/R8\| | 9.52 | 9.27 |
| TL/R5 | −1.63 | −1.65 |
| CT3/T34 | 0.49 | 0.39 |
| T12/T34 | 0.07 | 0.05 |

TABLE 6E
Schematic Parameters

| | | | |
|---|---|---|---|
| \|f1/f3\| | 1.87 | \|R8/R1\| | 0.21 |
| \|f3/f2\| | 0.55 | \|R8/R6\| | 0.73 |
| \|f4/f2\| | 0.52 | CT1/CT3 | 2.07 |
| \|f2\|/\|fi\|max | 0.98 | CT1/T23 | 1.23 |
| \|R3/R2\| | 0.02 | V1/N1 | 29.42 |
| \|R3/R6\| | 0.45 | V4 | 19.5 |
| \|R4/R5\| | 0.19 | Y1R1/Y4R2 | 1.37 |

### 7th Embodiment

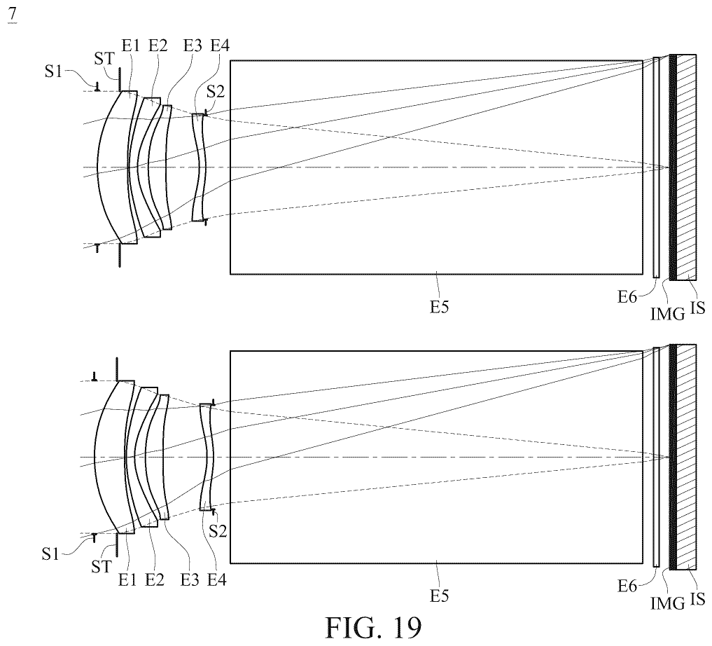

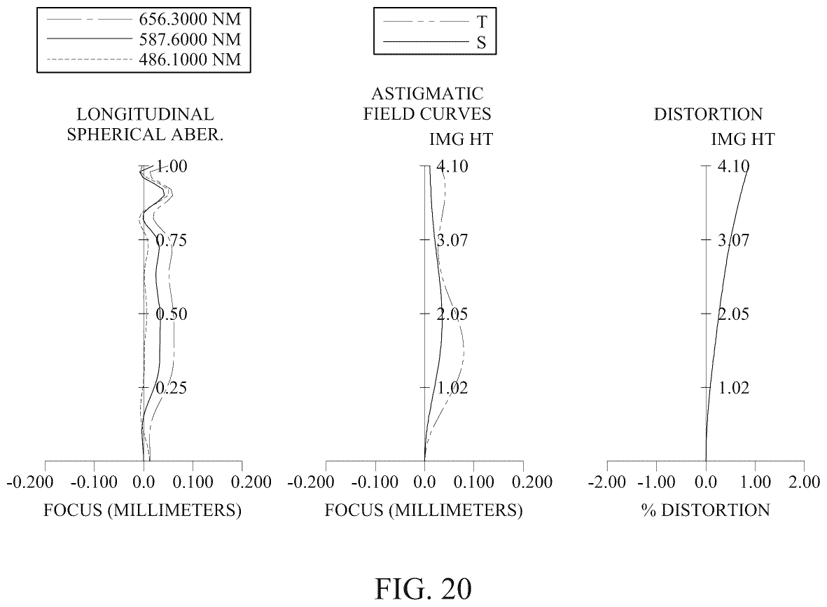

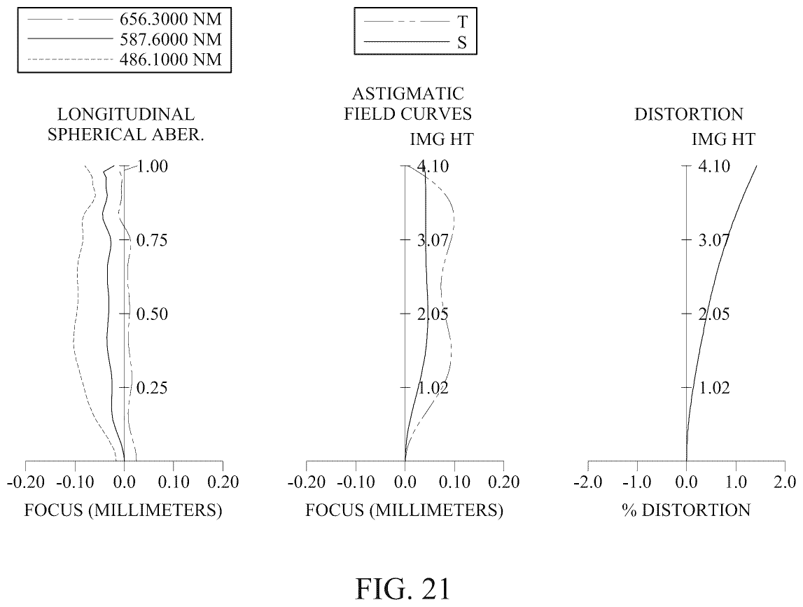

FIG. 19 is a schematic view of an image capturing unit at the first state (corresponding to an infinite object distance) and the second state (corresponding to a finite object distance) according to the 7th embodiment of the present disclosure. FIG. 20 shows, in order from left to right, spherical aberration curves, astigmatic field curves and a distortion curve of the image capturing unit at the first state according to the 7th embodiment. FIG. 21 shows, in order from left to right, spherical aberration curves, astigmatic field curves and a distortion curve of the image capturing unit at the second state according to the 7th embodiment. The upper part of FIG. 19 shows the optical imaging lens assembly at the first state, and the lower part of FIG. 19 shows the optical imaging lens assembly at the second state. In FIG. 19, the image capturing unit 7 includes the optical imaging lens assembly (its reference numeral is omitted) of the present disclosure and an image sensor IS. The optical imaging lens assembly includes, in order from an object side to an image side along an optical path, a stop S1, an aperture stop ST, a first lens element E1, a second lens element E2, a third lens element E3, a fourth lens element E4, a stop S2, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 300.010 millimeters. During the movement focus process, the fourth lens element E4 is moved along the optical axis with respect to the first lens element E1, the second lens element E2, and the third lens element E3 to cause adjustment in a focal length of the optical imaging lens assembly. Furthermore, through the movement focus process, the optical imaging lens assembly has the first state as shown in the upper part of FIG. 19 and the second state as shown in the lower part of FIG. 19.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The image-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 19 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

In this embodiment, an axial distance between the aperture stop ST and the stop S1 is defined as D0. An axial distance between the stop S2 and the object-side surface of the reflective element E5 is defined as D2.

The detailed optical data of the 7th embodiment are shown in Table 7A and Table 7B, and the aspheric surface data are shown in Table 7C below.

TABLE 7A
7th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Stop | Plano | | 0.826 | | | | |
| 2 | Ape. Stop | Plano | | −0.816 | | | | |
| 3 | Lens 1 | 4.8277 | (ASP) | 1.098 | Glass | 1.803 | 46.8 | 7.72 |
| 4 | | 19.6633 | (ASP) | 0.063 | | | | |
| 5 | Lens 2 | 5.4984 | (ASP) | 0.300 | Plastic | 1.584 | 28.2 | −7.87 |
| 6 | | 2.4534 | (ASP) | 0.390 | | | | |
| 7 | Lens 3 | 4.6770 | (ASP) | 0.642 | Plastic | 1.587 | 28.3 | 10.01 |
| 8 | | 21.7689 | (ASP) | D1 | | | | |
| 9 | Lens 4 | −2.7483 | (ASP) | 0.233 | Plastic | 1.697 | 16.3 | −17.48 |
| 10 | | −3.6723 | (ASP) | −0.005 | | | | |

| | | | | | | | |
|---|---|---|---|---|---|---|---|
| 11 | Stop | Plano | D2 | | | | |
| 12 | Reflective | Plano | 15.000 | Glass | 1.804 | 46.6 | — |
| | element | | | | | | |
| 13 | | Plano | 0.400 | | | | |
| 14 | Filter | Plano | 0.210 | Glass | 1.517 | 64.2 | — |
| 15 | | Plano | 0.381 | | | | |
| 16 | Image | Plano | — | | | | |

Note:
Reference wavelength is 587.6 nm (d-line).
An effective radius of the stop S1 (Surface 1) is 2.800 mm.
An effective radius of the stop S2 (Surface 11) is 1.900 mm.

TABLE 7B
Optical data for optical imaging lens assembly with
infinite object distance and finite object distance

| | Infinite | | Finite |
|---|---|---|---|
| | object distance | | object distance |
| | (First state) | | (Second state) |
| f [mm] | 15.16 | f [mm] | 14.64 |
| Fno | 2.73 | Fno | 2.81 |
| HFOV [deg.] | 15.0 | HFOV [deg.] | 14.6 |
| object | ∞ | object | 300.010 |
| distance [mm] | | distance [mm] | |
| D0 [mm] | ∞ | D0 [mm] | 300.000 |
| D1 [mm] | 1.217 | D1 [mm] | 1.604 |
| D2 [mm] | 0.900 | D2 [mm] | 0.619 |

Except for D0 and D2, the optical data in Table 7B is the same as the data of the 1st embodiment. The optical imaging lens assembly of this embodiment can further have other focal lengths corresponding to the intermediate range of the first state and the second state in other movement focusing conditions besides the first state and the second state for different 5 object distances.

TABLE 7C
Aspheric Coefficients

| Surface # | 3 | 4 | 5 | 6 |
|---|---|---|---|---|
| k= | 0.00000E+00 | 0.00000E+00 | 2.46196E+00 | −5.52239E−02 |
| A4= | −1.62387150E−04 | 2.96067325E−02 | 3.47962735E−02 | −4.56772091E−03 |
| A6= | 5.13102732E−04 | −1.99309986E−02 | −3.59082401E−02 | −1.06013678E−02 |
| A8= | −7.62016445E−05 | 8.97376180E−03 | 1.30979129E−02 | −3.58431594E−04 |
| A10= | 1.23625391E−05 | −2.32655075E−03 | −9.75075845E−04 | 7.59335552E−03 |
| A12= | −3.18813083E−06 | 3.35483783E−04 | −1.36763152E−03 | −7.78331670E−03 |
| A14= | 3.48606985E−07 | −2.54592168E−05 | 8.44539756E−04 | 4.02806689E−03 |
| A16= | −1.35491080E−08 | 7.99360913E−07 | −2.86176164E−04 | −1.23832965E−03 |
| A18= | — | — | 6.46159292E−05 | 2.37616623E−04 |
| A20= | — | — | −9.85855443E−06 | −2.82269392E−05 |
| A22= | — | — | 9.75501217E−07 | 1.91176426E−06 |
| A24= | — | — | −5.65119664E−08 | −5.65557629E−08 |
| A26= | — | — | 1.45578057E−09 | — |
| Surface # | 7 | 8 | 9 | 10 |
| k= | −1.56933E+00 | 7.74316E+01 | −1.54281E+00 | −2.82049E+00 |
| A4= | 7.64881993E−03 | −2.37478742E−03 | 3.90356223E−02 | 3.95682285E−02 |
| A6= | −3.95171298E−03 | 3.51970932E−03 | −1.85323938E−02 | −2.66954284E−02 |
| A8= | 1.15015553E−02 | 2.76336788E−03 | 5.48925175E−02 | 6.74300005E−02 |
| A10= | −9.60798033E−03 | −2.15014946E−03 | −8.29733574E−02 | −9.46268794E−02 |
| A12= | 5.34299053E−03 | 1.41730079E−03 | 7.38629847E−02 | 8.13183038E−02 |
| A14= | −2.55570783E−03 | −1.24260675E−03 | −4.29809226E−02 | −4.62893666E−02 |
| A16= | 9.01845617E−04 | 6.59687880E−04 | 1.68303132E−02 | 1.78410630E−02 |
| A18= | −2.00064736E−04 | −1.91726974E−04 | −4.39514909E−03 | −4.60416913E−03 |
| A20= | 2.53327545E−05 | 3.06775980E−05 | 7.33060424E−04 | 7.61247306E−04 |
| A22= | −1.60359816E−06 | −2.52767570E−06 | −7.05486524E−05 | −7.28175294E−05 |
| A24= | 3.57350667E−08 | 8.27466948E−08 | 2.97762204E−06 | 3.06172482E−06 |

In the 7th embodiment, the equation of the aspheric surface profiles of the aforementioned lens elements is the same as the equation of the 1st embodiment. Also, the definitions of these parameters shown in Table 7D and Table 7E are the same as those stated in the 1st embodiment with corresponding values for the 7th embodiment, so an explanation in this regard will not be provided again.

TABLE 7D
Schematic Parameters for optical imaging lens assembly with
infinite object distance and finite object distance

| | Infinite object distance | Finite object distance |
|---|---|---|
| | (First state) | (Second state) |
| f [mm] | 15.16 | 14.64 |
| Fno | 2.73 | 2.81 |
| HFOV [deg.] | 15.0 | 14.6 |
| FOV [deg.] | 30.0 | 29.2 |
| TL/ImgH | 5.09 | 5.11 |
| TL/f | 1.37 | 1.43 |
| BL/f | 1.11 | 1.13 |
| TD/BL | 0.23 | 0.26 |
| ΣCT/ΣAT | 1.36 | 1.11 |
| f/f2 | −1.93 | −1.86 |
| \|f/R7\| + \|f/R8\| | 9.64 | 9.31 |
| TL/R5 | 4.45 | 4.48 |
| CT3/T34 | 0.53 | 0.40 |
| T12/T34 | 0.05 | 0.04 |

TABLE 7E
Schematic Parameters

| | | | |
|---|---|---|---|
| \|f1/f3\| | 0.77 | \|R8/R1\| | 0.76 |
| \|f3/f2\| | 1.27 | \|R8/R6\| | 0.17 |
| \|f4/f2\| | 2.22 | CT1/CT3 | 1.71 |
| \|f2\|/\|fi\|max | 0.45 | CT1/T23 | 2.82 |
| \|R3/R2\| | 0.28 | V1/N1 | 25.96 |
| \|R3/R6\| | 0.25 | V4 | 16.3 |
| \|R4/R5\| | 0.52 | Y1R1/Y4R2 | 1.45 |

### 8th Embodiment

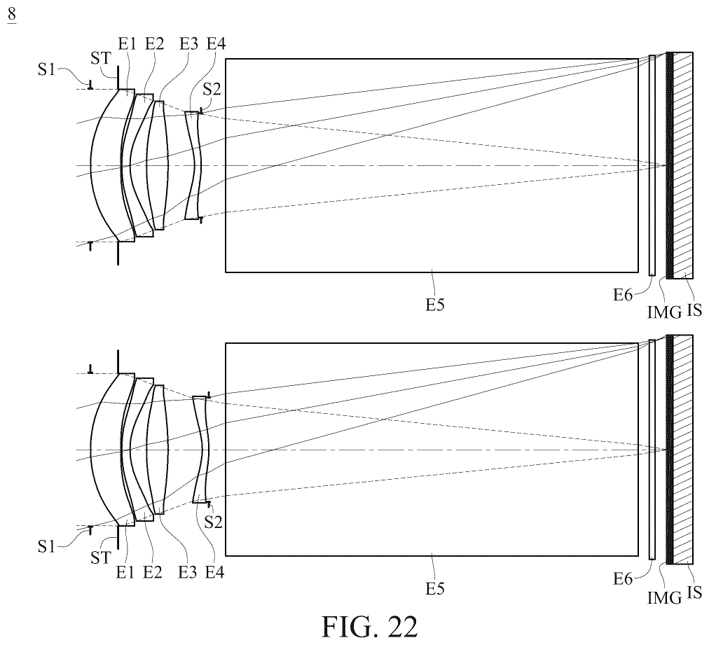

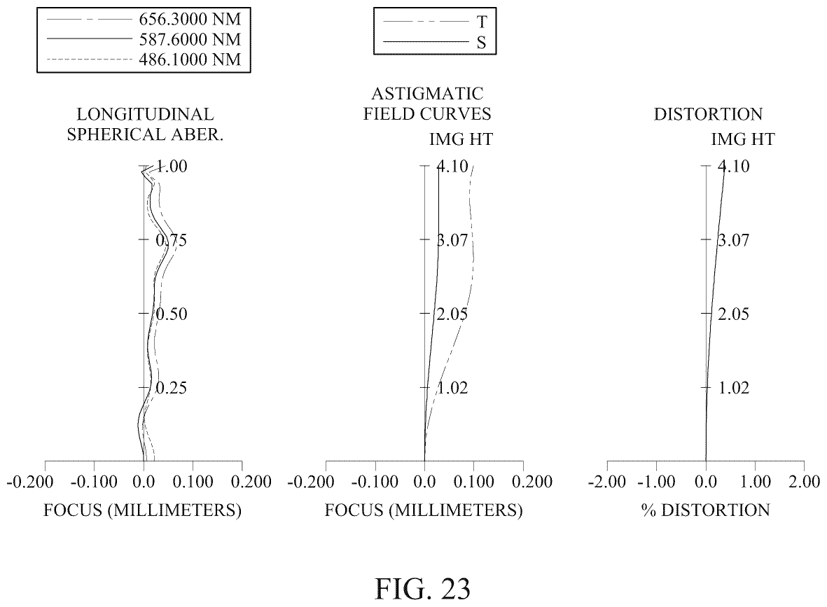

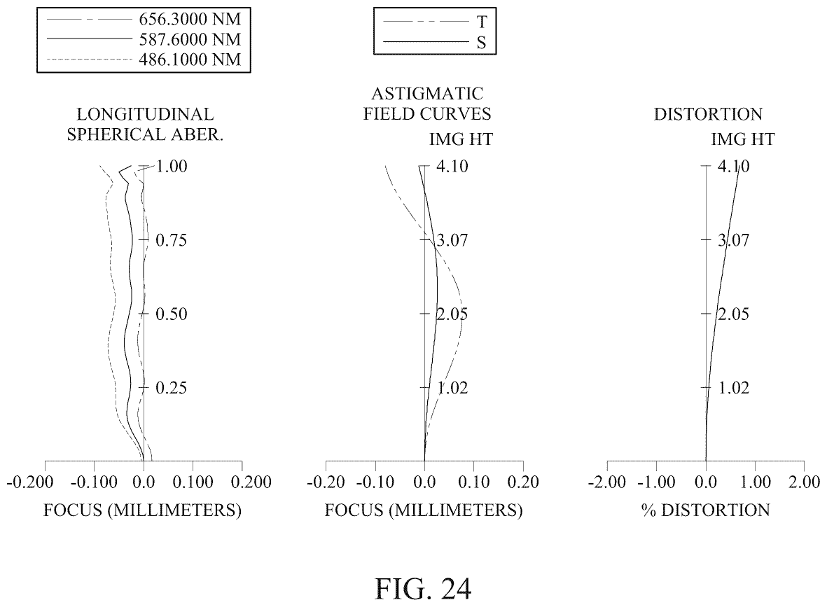

FIG. 22 is a schematic view of an image capturing unit at the first state (corresponding to an infinite object distance) and the second state (corresponding to a finite object distance) according to the 8th embodiment of the present disclosure. FIG. 23 shows, in order from left to right, spherical aberration curves, astigmatic field curves and a distortion curve of the image capturing unit at the first state according to the 8th embodiment. FIG. 24 shows, in order from left to right, spherical aberration curves, astigmatic field curves and a distortion curve of the image capturing unit at the second state according to the 8th embodiment. The upper part of FIG. 22 shows the optical imaging lens assembly at the first state, and the lower part of FIG. 22 shows the optical imaging lens assembly at the second state. In FIG. 22, the image capturing unit 8 includes the optical imaging lens assembly (its reference numeral is omitted) of the present disclosure and an image sensor IS. The optical imaging lens assembly includes, in order from an object side to an image side along an optical path, a stop S1, an aperture stop ST, a first lens element E1, a second lens element E2, a third lens element E3, a fourth lens element E4, a stop S2, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 300.010 millimeters. During the movement focus process, the fourth lens element E4 is moved along the optical axis with respect to the first lens element E1, the second lens element E2, and the third lens element E3 to cause adjustment in a focal length of the optical imaging lens assembly. Furthermore, through the movement focus process, the optical imaging lens assembly has the first state as shown in the upper part of FIG. 22 and the second state as shown in the lower part of FIG. 22.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has three inflection points.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has one inflection point. The image-side surface of the third lens element E3 has one critical point in an off-axis region thereof.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The reflective element E5 is made of glass material and is a prism which provides an optical path folding function. For simplicity, the light-folding effect generated by the reflective element E5 in FIG. 22 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

In this embodiment, an axial distance between the aperture stop ST and the stop S1 is defined as D0. An axial distance between the stop S2 and the object-side surface of the reflective element E5 is defined as D2.

The detailed optical data of the 8th embodiment are shown in Table 8A and Table 8B, and the aspheric surface data are shown in Table 8C below.

TABLE 8A
8th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Stop | Plano | | 1.014 | | | | |
| 2 | Ape. Stop | Plano | | −1.004 | | | | |
| 3 | Lens 1 | 4.2501 | (ASP) | 1.097 | Glass | 1.802 | 41.0 | 8.13 |
| 4 | | 10.8089 | (ASP) | 0.040 | | | | |
| 5 | Lens 2 | 5.1747 | (ASP) | 0.300 | Plastic | 1.587 | 28.3 | −8.80 |
| 6 | | 2.5295 | (ASP) | 0.600 | | | | |
| 7 | Lens 3 | 8.3366 | (ASP) | 0.780 | Plastic | 1.566 | 37.4 | 8.46 |
| 8 | | −10.8838 | (ASP) | D1 | | | | |
| 9 | Lens 4 | −2.3016 | (ASP) | 0.243 | Plastic | 1.669 | 19.5 | −11.98 |
| 10 | | −3.3654 | (ASP) | −0.008 | | | | |

| | | | | | | | |
|---|---|---|---|---|---|---|---|
| 11 | Stop | Plano | D2 | | | | |
| 12 | Reflective | Plano | 15.000 | Glass | 1.804 | 46.6 | — |
| | element | | | | | | |
| 13 | | Plano | 0.400 | | | | |
| 14 | Filter | Plano | 0.210 | Glass | 1.517 | 64.2 | — |
| 15 | | Plano | 0.420 | | | | |
| 16 | Image | Plano | — | | | | |

Note:
Reference wavelength is 587.6 nm (d-line).
An effective radius of the stop S1 (Surface 1) is 2.800 mm.
An effective radius of the stop S2 (Surface 11) is 1.900 mm.

TABLE 8B
Optical data for optical imaging lens assembly with
infinite object distance and finite object distance

| | Infinite | | Finite |
|---|---|---|---|
| | object distance | | object distance |
| | (First state) | | (Second state) |
| f [mm] | 15.15 | f [mm] | 14.51 |
| Fno | 2.73 | Fno | 2.78 |
| HFOV [deg.] | 15.0 | HFOV [deg.] | 14.8 |
| object | ∞ | object | 300.010 |
| distance [mm] | | distance [mm] | |
| D0 [mm] | ∞ | D0 [mm] | 300.000 |
| D1 [mm] | 0.964 | D1 [mm] | 1.245 |
| D2 [mm] | 0.900 | D2 [mm] | 0.619 |

Except for D0 and D2, in Table 8B, the optical data is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 8C
Aspheric Coefficients

| Surface # | 3 | 4 | 5 | 6 |
|---|---|---|---|---|
| k= | 0.00000E+00 | 0.00000E+00 | 1.93268E+00 | −3.07516E−02 |
| A4= | 9.25266872E−04 | 3.08783643E−02 | 1.39595699E−02 | −3.58164298E−02 |
| A6= | −1.27518514E−03 | −2.04925140E−02 | 3.43802714E−02 | 1.01609511E−01 |
| A8= | 1.12007778E−03 | 1.02356536E−02 | −6.95984918E−02 | −1.41728053E−01 |
| A10= | −3.90226960E−04 | −3.01204894E−03 | 5.39223013E−02 | 1.01343790E−01 |
| A12= | 6.91443122E−05 | 4.94224050E−04 | −2.43664748E−02 | −4.38353355E−02 |
| A14= | −6.11274309E−06 | −4.25016119E−05 | 7.18009075E−03 | 1.20922927E−02 |
| A16= | 2.08376330E−07 | 1.49201489E−06 | −1.45269168E−03 | −2.14885913E−03 |
| A18= | — | — | 2.06602305E−04 | 2.38831909E−04 |
| A20= | — | — | −2.06327431E−05 | −1.51055606E−05 |
| A22= | — | — | 1.39878592E−06 | 4.13173404E−07 |
| A24= | — | — | −5.85536639E−08 | — |
| A26= | — | — | 1.15340011E−09 | — |
| Surface # | 7 | 8 | 9 | 10 |
| k= | −7.34158E+00 | −1.32943E+01 | −1.77023E+00 | −3.85909E+00 |
| A4= | −8.12805926E−03 | −1.23356293E−02 | 3.76223559E−02 | 3.75758257E−02 |
| A6= | 3.63956723E−02 | 2.54608861E−02 | 4.35122234E−02 | 2.60529791E−02 |
| A8= | −3.70766603E−02 | −2.70230277E−02 | −7.91126289E−02 | −4.58155596E−02 |
| A10= | 1.80999216E−02 | 1.75450894E−02 | 7.38541550E−02 | 3.96766304E−02 |
| A12= | −3.67878652E−03 | −7.05088301E−03 | −4.56615810E−02 | −2.34509125E−02 |
| A14= | −4.15846279E−04 | 1.72038776E−03 | 1.89961560E−02 | 9.54793925E−03 |
| A16= | 3.88307857E−04 | −2.38943849E−04 | −5.21675929E−03 | −2.59930617E−03 |
| A18= | −8.52722938E−05 | 1.51453060E−05 | 9.04052745E−04 | 4.49663328E−04 |
| A20= | 8.57823588E−06 | 8.12146643E−08 | −8.94818049E−05 | −4.46380369E−05 |
| A22= | −3.41148865E−07 | −4.17950434E−08 | 3.85489436E−06 | 1.93671886E−06 |

In the 8th embodiment, the equation of the aspheric surface profiles of the aforementioned lens elements is the same as the equation of the 1st embodiment. Also, the definitions of these parameters shown in Table 8D and Table 8E are the same as those stated in the 1st embodiment with corresponding values for the 8th embodiment, so an explanation in this regard will not be provided again.

TABLE 8D
Schematic Parameters for optical imaging lens assembly with
infinite object distance and finite object distance

| | Infinite object distance | Finite object distance |
|---|---|---|
| | (First state) | (Second state) |
| f [mm] | 15.15 | 14.51 |
| Fno | 2.73 | 2.78 |
| HFOV [deg.] | 15.0 | 14.8 |
| FOV [deg.] | 30.0 | 29.6 |
| TL/ImgH | 5.11 | 5.11 |
| TL/f | 1.38 | 1.44 |
| BL/f | 1.12 | 1.15 |
| TD/BL | 0.24 | 0.26 |
| ΣCT/ΣAT | 1.51 | 1.28 |
| f/f2 | −1.72 | −1.65 |
| \|f/R7\| + \|f/R8\| | 11.09 | 10.62 |
| TL/R5 | 2.51 | 2.51 |
| CT3/T34 | 0.81 | 0.63 |
| T12/T34 | 0.04 | 0.03 |

TABLE 8E
Schematic Parameters

| | | | |
|---|---|---|---|
| \|f1/f3\| | 0.96 | \|R8/R1\| | 0.79 |
| \|f3/f2\| | 0.96 | \|R8/R6\| | 0.31 |
| \|f4/f2\| | 1.36 | CT1/CT3 | 1.41 |
| \|f2\|/\|fi\|max | 0.73 | CT1/T23 | 1.83 |
| \|R3/R2\| | 0.48 | V1/N1 | 22.75 |
| \|R3/R6\| | 0.48 | V4 | 19.5 |
| \|R4/R5\| | 0.30 | Y1R1/Y4R2 | 1.45 |

### 9th Embodiment

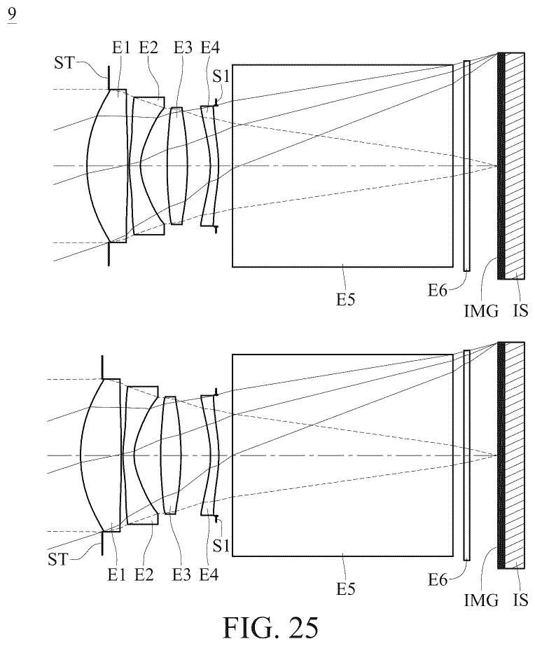

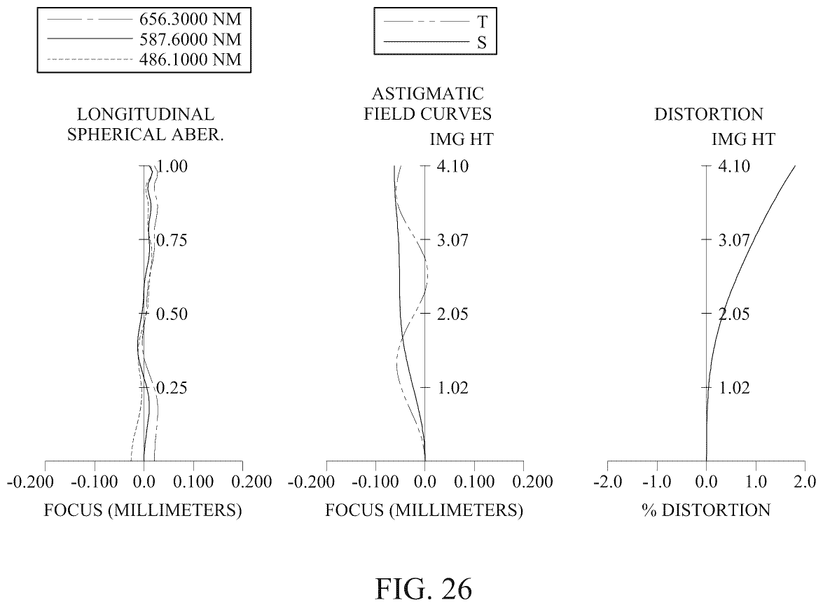

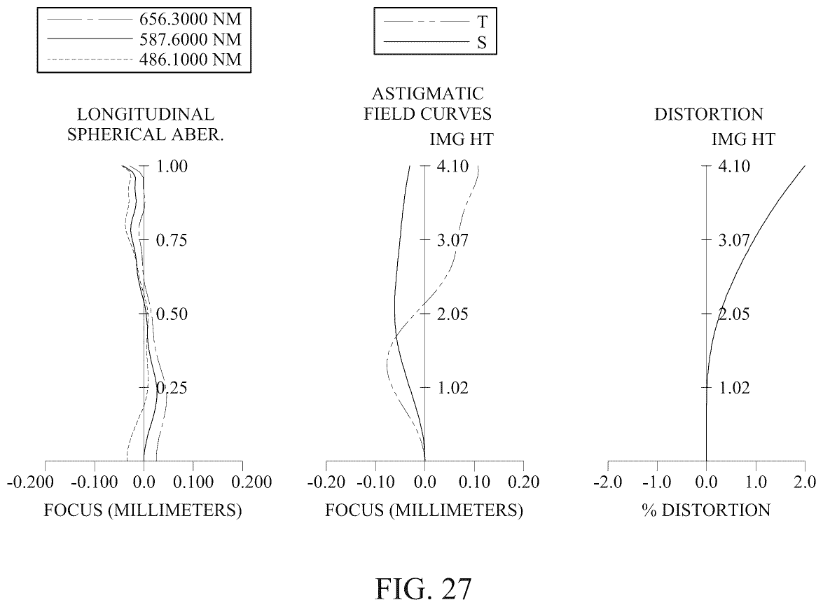

FIG. 25 is a schematic view of an image capturing unit at the first state (corresponding to an infinite object distance) and the second state (corresponding to a finite object distance) according to the 9th embodiment of the present disclosure. FIG. 26 shows, in order from left to right, spherical aberration curves, astigmatic field curves and a distortion curve of the image capturing unit at the first state according to the 9th embodiment. FIG. 27 shows, in order from left to right, spherical aberration curves, astigmatic field curves and a distortion curve of the image capturing unit at the second state according to the 9th embodiment. The upper part of FIG. 25 shows the optical imaging lens assembly at the first state, and the lower part of FIG. 25 shows the optical imaging lens assembly at the second state. In FIG. 25, the image capturing unit 9 includes the optical imaging lens assembly (its reference numeral is omitted) of the present disclosure and an image sensor IS. The optical imaging lens assembly includes, in order from an object side to an image side along an optical path, an aperture stop ST, a first lens element E1, a second lens element E2, a third lens element E3, a fourth lens element E4, a stop S1, a reflective element E5, a filter E6 and an image surface IMG. The optical imaging lens assembly includes four lens elements (E1, E2, E3, and E4) with no additional lens element disposed between each of the adjacent four lens elements.

When an imaged object moves from infinity to a finite object distance, the optical imaging lens assembly performs a movement focus process. In this embodiment, the object distance corresponding to the optical imaging lens assembly at a first state is ∞ (infinity), and the object distance corresponding to the optical imaging lens assembly at a second state is 299.209 millimeters. During the movement focus process, the first lens element E1, the second lens element E2, and the third lens element E3 are moved along the optical axis with respect to the fourth lens element E4 to cause adjustment in a focal length of the optical imaging lens assembly. Furthermore, through the movement focus process, the optical imaging lens assembly has the first state as shown in the upper part of FIG. 25 and the second state as shown in the lower part of FIG. 25.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The object-side surface of the first lens element E1 has one inflection point. The image-side surface of the first lens element E1 has two inflection points.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points.

The reflective element E5 is made of glass material and is a prism which provides an optical path folding function. For simplicity, the light-folding effect generated by the reflective element E5 in FIG. 25 is omitted. The reflective element E5 can have various forms such as the descriptions referring to FIG. 39 to FIG. 52, and thus will not be repeated again.

The filter E6 is made of glass material and located between the reflective element E5 and the image surface IMG, and will not affect the focal length of the optical imaging lens assembly. The image sensor IS is disposed on or near the image surface IMG.

The detailed optical data of the 9th embodiment are shown in Table 9A and Table 9B, and the aspheric surface data are shown in Table 9C below.

TABLE 9A
9th Embodiment

| | | | | | | | | Focal |
|---|---|---|---|---|---|---|---|---|
| Surface # | | Curvature Radius | | Thickness | Material | Index | Abbe # | Length |
| 0 | Object | Infinity | | D0 | | | | |
| 1 | Ape. Stop | Plano | | −0.791 | | | | |
| 2 | Lens 1 | 4.6816 | (ASP) | 1.480 | Glass | 1.806 | 40.7 | 5.43 |
| 3 | | −57.9601 | (ASP) | 0.060 | | | | |
| 4 | Lens 2 | 4.0278 | (ASP) | 0.405 | Plastic | 1.614 | 26.0 | −5.70 |
| 5 | | 1.8010 | (ASP) | 0.967 | | | | |
| 6 | Lens 3 | 28.0065 | (ASP) | 0.734 | Plastic | 1.566 | 37.4 | 11.03 |
| 7 | | −7.9549 | (ASP) | D1 | | | | |
| 8 | Lens 4 | −3.3650 | (ASP) | 0.300 | Plastic | 1.657 | 21.3 | −21.71 |
| 9 | | −4.5601 | (ASP) | −0.097 | | | | |

| | | | | | | | |
|---|---|---|---|---|---|---|---|
| 10 | Stop | Plano | 0.600 | | | | |
| 11 | Reflective | Plano | 8.000 | Glass | 1.608 | 46.2 | — |
| | element | | | | | | |
| 12 | | Plano | 0.400 | | | | |
| 13 | Filter | Plano | 0.210 | Glass | 1.517 | 64.2 | — |
| 14 | | Plano | 1.025 | | | | |
| 15 | Image | Plano | — | | | | |

Note:
Reference wavelength is 587.6 nm (d-line).
An effective radius of the stop S1 (Surface 10) is 2.198 mm.

TABLE 9B
Optical data for optical imaging lens assembly with
infinite object distance and finite object distance

| | Infinite | | Finite |
|---|---|---|---|
| | object distance | | object distance |
| | (First state) | | (Second state) |
| f [mm] | 11.84 | f [mm] | 11.67 |
| Fno | 2.13 | Fno | 2.21 |
| HFOV [deg.] | 18.7 | HFOV [deg.] | 18.2 |
| object | ∞ | object | 299.209 |
| distance [mm] | | distance [mm] | |
| D0 [mm] | ∞ | D0 [mm] | 300.000 |
| D1 [mm] | 0.832 | D1 [mm] | 1.073 |

In Table 9B, the optical data is the same as the data of the 1st embodiment. The optical imaging lens assembly of this embodiment can further have other focal lengths corresponding to the intermediate range of the first state and the second state in other movement focusing conditions besides the first state and the second state for different object distances.

TABLE 9C
Aspheric Coefficients

| Surface # | 2 | 3 | 4 | 5 |
|---|---|---|---|---|
| k= | 0.00000E+00 | 0.00000E+00 | −4.77653E−01 | −6.99742E−01 |
| A4= | −1.33695773E−03 | −6.00727198E−03 | −4.85088797E−02 | −4.08205098E−02 |
| A6= | 1.16381018E−03 | 2.85157076E−03 | −1.87629884E−03 | −9.77630764E−03 |
| A8= | −5.11357342E−04 | −8.71180225E−04 | 1.80237678E−03 | −9.08428940E−03 |
| A10= | 1.13350758E−04 | 2.53017186E−04 | 6.44884102E−03 | 3.61015260E−02 |
| A12= | −1.38490541E−05 | −4.68511645E−05 | −6.30436668E−03 | −3.89983416E−02 |
| A14= | 8.67181045E−07 | 4.34940137E−06 | 2.96973868E−03 | 2.47050368E−02 |
| A16= | −2.29835411E−08 | −1.57274241E−07 | −8.72928431E−04 | −1.03888720E−02 |
| A18= | — | — | 1.70580198E−04 | 2.98071761E−03 |
| A20= | — | — | −2.22623251E−05 | −5.76796397E−04 |
| A22= | — | — | 1.87046802E−06 | 7.19183820E−05 |
| A24= | — | — | −9.16585917E−08 | −5.20777016E−06 |
| A26= | — | — | 1.99198399E−09 | 1.66083454E−07 |
| Surface # | 6 | 7 | 8 | 9 |
| k= | 4.97226E+01 | 4.20009E+00 | −2.15313E−01 | 7.38739E−01 |
| A4= | 2.52285481E−02 | 2.25481141E−02 | 4.58713653E−02 | 3.42281830E−02 |
| A6= | −6.92674849E−03 | −2.93975069E−03 | −1.53589336E−02 | −6.72295781E−03 |
| A8= | −2.02857181E−02 | −2.32276713E−02 | −4.71516419E−03 | −2.11226167E−03 |
| A10= | 3.62896477E−02 | 3.98549084E−02 | 1.28148213E−02 | 1.14504100E−03 |
| A12= | −3.48454102E−02 | −3.87958112E−02 | −9.98426889E−03 | 1.98906933E−03 |
| A14= | 2.18140511E−02 | 2.48722176E−02 | 4.68863061E−03 | −2.23223420E−03 |
| A16= | −9.23203771E−03 | −1.08096902E−02 | −1.47853653E−03 | 1.04759700E−03 |
| A18= | 2.65757350E−03 | 3.19626780E−03 | 3.17186893E−04 | −2.76747730E−04 |
| A20= | −5.12104935E−04 | −6.32369623E−04 | −4.45815613E−05 | 4.28494294E−05 |
| A22= | 6.31114321E−05 | 7.99969534E−05 | 3.70187260E−06 | −3.64076994E−06 |
| A24= | −4.48790142E−06 | −5.84149513E−06 | −1.37295973E−07 | 1.31435355E−07 |
| A26= | 1.39779899E−07 | 1.87044376E−07 | — | — |

In the 9th embodiment, the equation of the aspheric surface profiles of the aforementioned lens elements is the same as the equation of the 1st embodiment. Also, the definitions of these parameters shown in Table 9D and Table 9E are the same as those stated in the 1st embodiment with corresponding values for the 9th embodiment, so an explanation in this regard will not be provided again.

TABLE 9D
Schematic Parameters for optical imaging lens assembly with
infinite object distance and finite object distance

| | Infinite object distance | Finite object distance |
|---|---|---|
| | (First state) | (Second state) |
| f [mm] | 11.84 | 11.67 |
| Fno | 2.13 | 2.21 |
| HFOV [deg.] | 18.7 | 18.2 |
| FOV [deg.] | 37.4 | 36.4 |
| TL/ImgH | 3.64 | 3.70 |
| TL/f | 1.26 | 1.30 |
| BL/f | 0.86 | 0.87 |
| TD/BL | 0.47 | 0.50 |
| ΣCT/ΣAT | 1.57 | 1.39 |
| f/f2 | −2.08 | −2.05 |
| \|f/R7\| + \|f/R8\| | 6.12 | 6.03 |
| TL/R5 | 0.53 | 0.54 |
| CT3/T34 | 0.88 | 0.68 |
| T12/T34 | 0.07 | 0.06 |

TABLE 9E
Schematic Parameters

| | | | |
|---|---|---|---|
| \|f1/f3\| | 0.49 | \|R8/R1\| | 0.97 |
| \|f3/f2\| | 1.93 | \|R8/R6\| | 0.57 |
| \|f4/f2\| | 3.81 | CT1/CT3 | 2.02 |
| \|f2\|/\|fi\|max | 0.26 | CT1/T23 | 1.53 |
| \|R3/R2\| | 0.07 | V1/N1 | 22.54 |
| \|R3/R6\| | 0.51 | V4 | 21.3 |
| \|R4/R5\| | 0.06 | Y1R1/Y4R2 | 1.27 |

### 10th Embodiment

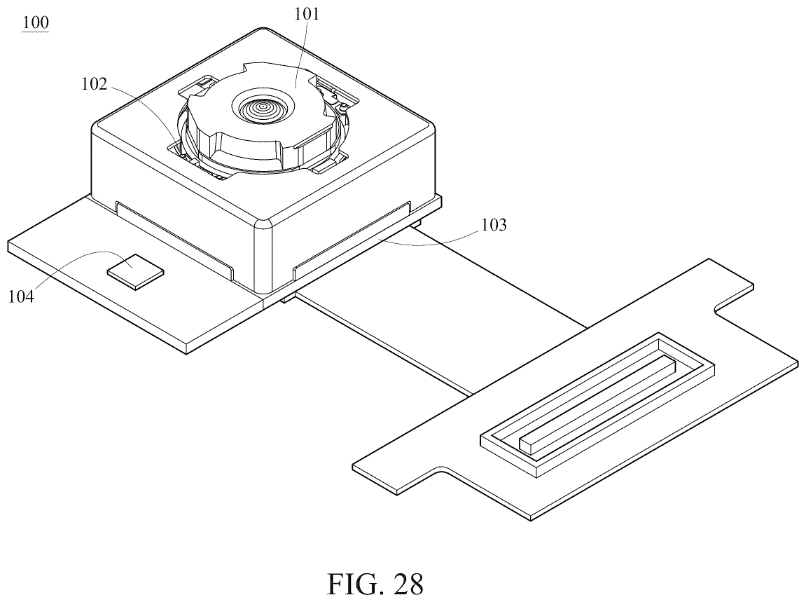

FIG. 28 is a perspective view of an image capturing unit according to the 10th embodiment of the present disclosure. In this embodiment, an image capturing unit 100 is a camera module including a lens unit 101, a driving device 102, an image sensor 103 and an image stabilizer 104. The lens unit 101 includes the optical imaging lens assembly disclosed in the 1st embodiment, a barrel and a holder member (their reference numerals are omitted) for holding the optical imaging lens assembly. However, the lens unit 101 may alternatively be provided with the optical imaging lens assembly disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have internal focusing functionality and auto focusing functionality, and different driving configurations can be obtained through the usages of stepping motor, piezo motor, screw, voice coil motors (VCM), spring type, or ball type. The present disclosure is not limited to the abovementioned focusing manner. The driving device 102 is favorable for obtaining a better imaging position of the lens unit 101, so that a clear image of the imaged object can be captured by the lens unit 101 with different object distances. Moreover, movable elements in the image capturing unit 100 (for example, but not limited to, movable optical elements in the lens assembly or image sensor) can also be driven by the driving device 102, such that the movable elements can have movement parallel with, angled to, or perpendicular to the optical axis. However, the present disclosure is not limited to the abovementioned driving manner. The image sensor 103 (for example, CCD or CMOS), which can feature high photosensitivity and low noise, is disposed on the image surface of the optical imaging lens assembly to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions. Moreover, several elements in the image capturing unit 100 can also be driven by the driving device 102 so as to timely compensate for image tilt, thereby also achieving OIS.

### 11th Embodiment

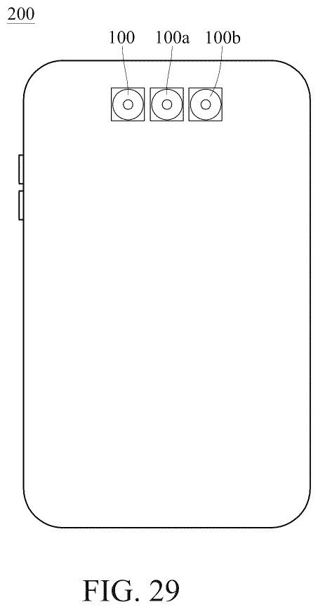

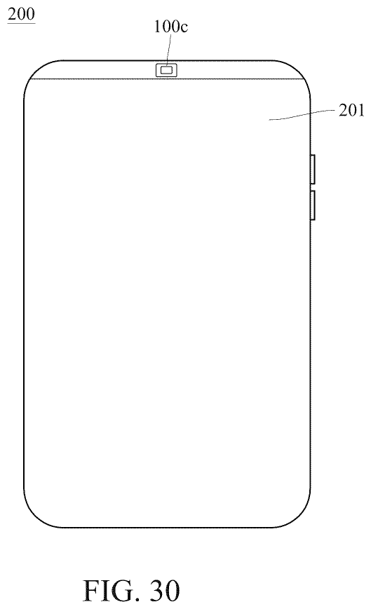

FIG. 29 is one perspective view of an electronic device according to the 11th embodiment of the present disclosure. FIG. 30 is another perspective view of the electronic device in FIG. 29.

In this embodiment, an electronic device 200 is a smartphone including the image capturing unit 100 disclosed in the 10th embodiment, an image capturing unit 100a, an image capturing unit 100b, an image capturing unit 100c and a display unit 201. As shown in FIG. 29, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 30, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the optical imaging lens assembly of the present disclosure and can have a configuration similar to that of the image capturing unit 100. In detail, each of the image capturing units 100a, 100b and 100c can include a lens unit, a driving device, an image sensor and an image stabilizer, and each of the lens unit can include an optical lens assembly such as the optical imaging lens assembly of the present disclosure, a barrel and a holder member for holding the optical imaging lens assembly.

The image capturing unit 100 is a telephoto image capturing unit, the image capturing unit 100a is a wide-angle image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 30, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. Moreover, the aperture stop inside the image capturing unit 100c can also be non-circular for corresponding to the non-circular opening. The detail can be referred to the description related to FIG. 37 and FIG. 38, which will not be repeated again. In this embodiment, the electronic device 200 includes multiple image capturing units 100, 100a, 100b and 100c, but the present disclosure is not limited to the number and arrangement of image capturing units.

### 12th Embodiment

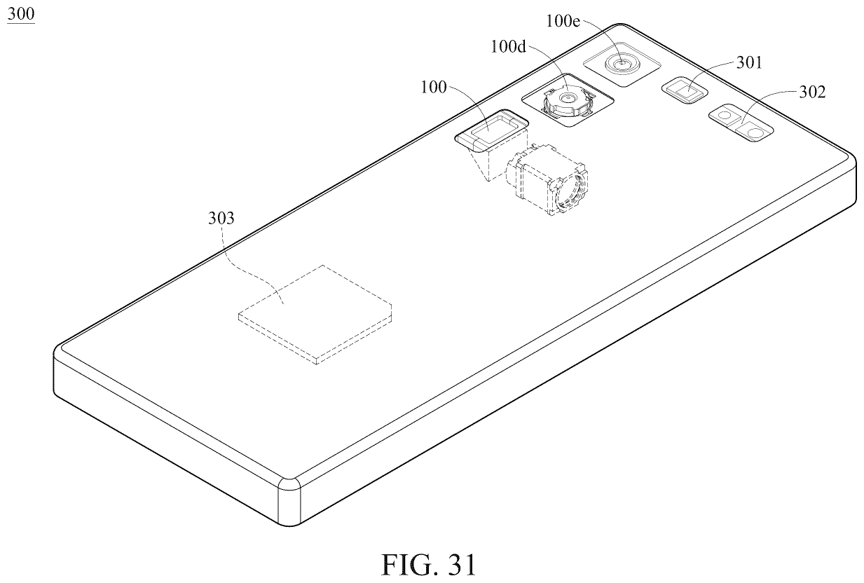

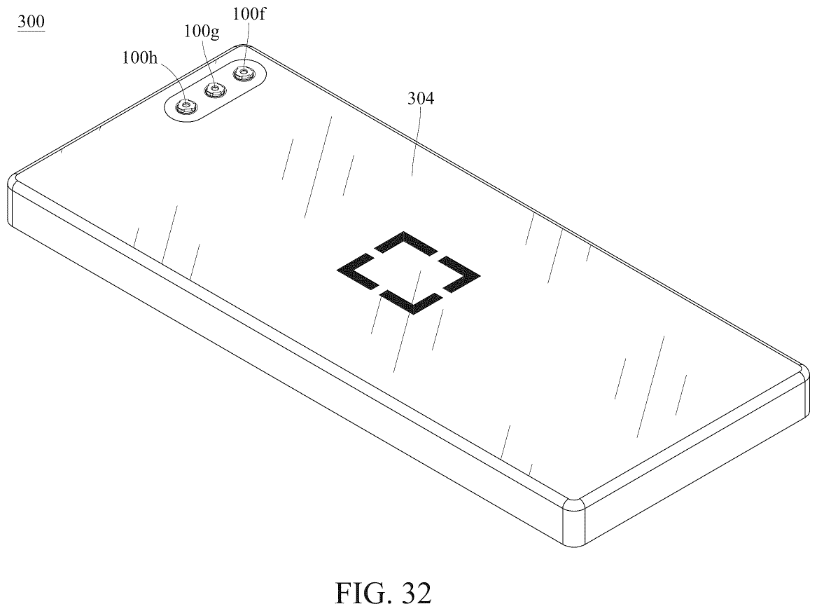

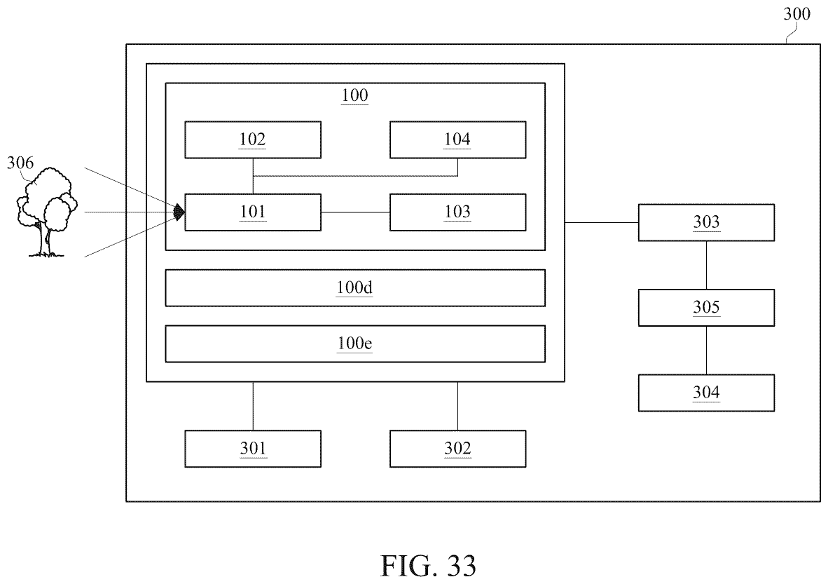

FIG. 31 is one perspective view of an electronic device according to the 12th embodiment of the present disclosure. FIG. 32 is another perspective view of the electronic device in FIG. 31. FIG. 33 is a block diagram of the electronic device in FIG. 31.

In this embodiment, an electronic device 300 is a smartphone including the image capturing unit 100 disclosed in the 10th embodiment, an image capturing unit 100d, an image capturing unit 100e, an image capturing unit 100f, an image capturing unit 100g, an image capturing unit 100h, a flash module 301, a focus assist module 302, an image signal processor 303, a display module 304 and an image software processor 305. The image capturing unit 100, the image capturing unit 100d and the image capturing unit 100e are disposed on the same side of the electronic device 300. The focus assist module 302 can be a laser rangefinder or a ToF (time of flight) module, but the present disclosure is not limited thereto. The image capturing unit 100f, the image capturing unit 100g, the image capturing unit 100h and the display module 304 are disposed on the opposite side of the electronic device 300, and the display module 304 can be a user interface, such that the image capturing units 100f, 100g, 100 h can be front-facing cameras of the electronic device 300 for taking selfies, but the present disclosure is not limited thereto. Furthermore, each of the image capturing units 100d, 100e, 100f, 100g and 100h can include the optical imaging lens assembly of the present disclosure and can have a configuration similar to that of the image capturing unit 100. In detail, each of the image capturing units 100d, 100e, 100f, 100g and 100h can include a lens unit, a driving device, an image sensor and an image stabilizer, and each of the lens unit can include an optical lens assembly such as the optical imaging lens assembly of the present disclosure, a barrel and a holder member for holding the optical imaging lens assembly.

The image capturing unit 100 is a telephoto image capturing unit, the image capturing unit 100d is a wide-angle image capturing unit, the image capturing unit 100e is an ultra-wide-angle image capturing unit, the image capturing unit 100f is a wide-angle image capturing unit, the image capturing unit 100g is an ultra-wide-angle image capturing unit, and the image capturing unit 100h is a ToF image capturing unit. In this embodiment, the image capturing units 100, 100d and 100e have different fields of view, such that the electronic device 300 can have various magnification ratios so as to meet the requirement of optical zoom functionality. Moreover, the image capturing unit 100 can be a telephoto image capturing unit having an optical path folding element configuration such as a reflective element configuration, such that the total track length of the image capturing unit 100 is not limited by the thickness of the electronic device 300. Moreover, the optical path folding element configuration of the image capturing unit 100 can be similar to, for example, one of the structures shown in FIG. 39 to FIG. 52, which can be referred to foregoing descriptions corresponding to FIG. 39 to FIG. 52, and the details in this regard will not be provided again. In addition, the image capturing unit 100h can determine depth information of the imaged object. In this embodiment, the electronic device 300 includes multiple image capturing units 100, 100d, 100e, 100f, 100g and 100h, but the present disclosure is not limited to the number and arrangement of image capturing units.

When a user captures images of an object 306, the light rays converge in the image capturing unit 100, the image capturing unit 100d or the image capturing unit 100e to generate images, and the flash module 301 is activated for light supplement. The focus assist module 302 detects the object distance of the imaged object 306 to achieve fast auto focusing.

The image signal processor 303 is configured to optimize the captured image to improve image quality. The light beam emitted from the focus assist module 302 can be either conventional infrared or laser. In addition, the light rays may converge in the image capturing unit 100f, 100g or 100h to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 13th Embodiment

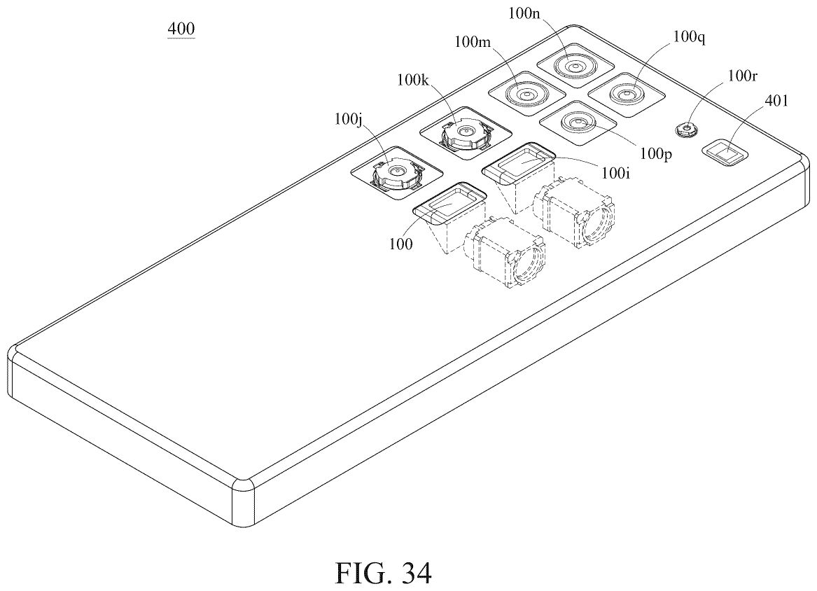

FIG. 34 is one perspective view of an electronic device according to the 13th embodiment of the present disclosure.

In this embodiment, an electronic device 400 is a smartphone including the image capturing unit 100 disclosed in the 10th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the optical imaging lens assembly of the present disclosure and can have a configuration similar to that of the image capturing unit 100, and the details in this regard will not be provided again.

The image capturing unit 100 is a telephoto image capturing unit, the image capturing unit 100i is a telephoto image capturing unit, the image capturing unit 100j is a wide-angle image capturing unit, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p, and 100q have different fields of view, such that the electronic device 400 can have various magnification ratios so as to meet the requirement of optical zoom functionality. Moreover, each of the image capturing units 100 and 100i can be a telephoto image capturing unit having an optical path folding element configuration such as a reflective element configuration. Moreover, the optical path folding element configuration of each of the image capturing unit 100 and 100i can be similar to, for example, one of the structures shown in FIG. 39 to FIG. 52, which can be referred to foregoing descriptions corresponding to FIG. 39 to FIG. 52, and the details in this regard will not be provided again. In addition, the image capturing unit 100r can determine depth information of the imaged object. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphone in this embodiment is only exemplary for showing the image capturing unit of the present disclosure installed in an electronic device, and the present disclosure is not limited thereto. The image capturing unit can be optionally applied to optical systems with a movable focus. Furthermore, the optical imaging lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-9E show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical imaging lens assembly comprising four lens elements, the four lens elements being, in order from an object side to an image side along an optical path, a first lens element, a second lens element, a third lens element and a fourth lens element, and each of the four lens elements having an object-side surface facing toward the object side and an image-side surface facing toward the image side;
wherein the first lens element has positive refractive power, the object-side surface of the second lens element is convex in a paraxial region thereof, the image-side surface of the second lens element is concave in a paraxial region thereof, the third lens element has positive refractive power, the fourth lens element has negative refractive power, the object-side surface of the fourth lens element is concave in a paraxial region thereof, the image-side surface of the fourth lens element is convex in a paraxial region thereof, and at least one of the object-side surface and the image-side surface of at least one lens element of the optical imaging lens assembly has at least one inflection point;
wherein an axial distance between the object-side surface of the first lens element and the image-side surface of the fourth lens element is TD, an axial distance between the image-side surface of the fourth lens element and an image surface is BL, an absolute value of a focal length of the first lens element is |f1|, an absolute value of a focal length of the second lens element is |f2|, an absolute value of a focal length of the third lens element is |f3|, an absolute value of a focal length of the fourth lens element is |f4|, a maximum value of |f1|, |f2|, |f3| and |f4| is |f1|max, a central thickness of the third lens element is CT3, an axial distance between the third lens element and the fourth lens element is T34, and the following conditions are satisfied:
0.10<TD/BL<0.70;
0.20<|f2|/|fi|max≤1.00; and
0.10<CT3/T34<1.20.

2. The optical imaging lens assembly of claim 1, wherein an axial distance between the object-side surface of the first lens element and the image surface is TL, a maximum image height of the optical imaging lens assembly is ImgH, and the following condition is satisfied:
3.00<TL/ImgH<6.00.

3. The optical imaging lens assembly of claim 1, wherein the axial distance between the image-side surface of the fourth lens element and the image surface is BL, a focal length of the optical imaging lens assembly is f, and the following condition is satisfied:
0.70<BL/f<1.30.

4. The optical imaging lens assembly of claim 1, wherein a focal length of the optical imaging lens assembly is f, the focal length of the second lens element is f2, and the following condition is satisfied:
−3.00<f/f2<0.80.

5. The optical imaging lens assembly of claim 1, wherein the focal length of the second lens element is f2, the focal length of the fourth lens element is f4, and the following condition is satisfied:
0.00<|f4/f2|<5.00.

6. The optical imaging lens assembly of claim 1, wherein a curvature radius of the image-side surface of the first lens element is R2, a curvature radius of the object-side surface of the second lens element is R3, and the following condition is satisfied:
0.00<R3/R2|<1.00.

7. The optical imaging lens assembly of claim 1, wherein a curvature radius of the object-side surface of the first lens element is R1, a curvature radius of the image-side surface of the third lens element is R6, a curvature radius of the image-side surface of the fourth lens element is R8, and the following conditions are satisfied:
0.00<|R8/R1|<1.50; and
0.00<R8/R6|<1.20.

8. The optical imaging lens assembly of claim 1, wherein the axial distance between the object-side surface of the first lens element and the image-side surface of the fourth lens element is TD, the axial distance between the image-side surface of the fourth lens element and the image surface is BL, an axial distance between the object-side surface of the first lens element and the image surface is TL, a curvature radius of the object-side surface of the third lens element is R5, and the following conditions are satisfied:
0.10<TD/BL<0.55; and
−2.00<TL/R5<6.00.

9. The optical imaging lens assembly of claim 1, wherein an Abbe number of the first lens element is V1, a refractive index of the first lens element is N1, and the following condition is satisfied:
18.00<V1/N1<43.00.

10. The optical imaging lens assembly of claim 1, wherein a maximum effective radius of the object-side surface of the first lens element is Y1R1, a maximum effective radius of the image-side surface of the fourth lens element is Y4R2, and the following condition is satisfied:
1.00<Y1R1/Y4R2<1.70.

11. The optical imaging lens assembly of claim 1, wherein the optical imaging lens assembly has a first state corresponding to an infinite object distance and a second state corresponding to a finite object distance, and the finite object distance is equal to or less than 1000 millimeters;
when an imaged object at infinity moves to be at the finite object distance, at least one lens element of the optical imaging lens assembly moves along an optical axis direction with respect to other lens elements of the optical imaging lens assembly to perform a movement focus process, so that the optical imaging lens assembly is changed from the first state to the second state.

12. The optical imaging lens assembly of claim 1, further comprising at least one reflective element, wherein the at least one reflective element is disposed between the fourth lens element and the image surface.

13. An image capturing unit comprising:
the optical imaging lens assembly of claim 1; and
an image sensor disposed on the image surface of the optical imaging lens assembly.

14. An electronic device comprising:
the image capturing unit of claim 13.

15. An optical imaging lens assembly comprising four lens elements, the four lens elements being, in order from an object side to an image side along an optical path, a first lens element, a second lens element, a third lens element and a fourth lens element, and each of the four lens elements having an object-side surface facing toward the object side and an image-side surface facing toward the image side;
wherein the first lens element has positive refractive power, the object-side surface of the second lens element is convex in a paraxial region thereof, the image-side surface of the second lens element is concave in a paraxial region thereof, the third lens element has positive refractive power, the fourth lens element has negative refractive power, the object-side surface of the fourth lens element is concave in a paraxial region thereof, and the image-side surface of the fourth lens element is convex in a paraxial region thereof;
wherein an axial distance between the object-side surface of the first lens element and the image-side surface of the fourth lens element is TD, an axial distance between the image-side surface of the fourth lens element and an image surface is BL, an Abbe number of the fourth lens element is V4, a central thickness of the first lens element is CT1, an axial distance between the second lens element and the third lens element is T23, a curvature radius of the object-side surface of the second lens element is R3, a curvature radius of the image-side surface of the third lens element is R6, and the following conditions are satisfied:
0.10<TD/BL<0.60;
5.0<V4<40.0;
1.00<CT1/T23<4.00; and
0.00<R3/R6|<0.80.

16. The optical imaging lens assembly of claim 15, wherein the image-side surface of the third lens element has at least one inflection point;
wherein an axial distance between the object-side surface of the first lens element and the image surface is TL, a focal length of the optical imaging lens assembly is f, and the following condition is satisfied:
1.15<TL/f<1.55.

17. The optical imaging lens assembly of claim 15, wherein a maximum field of view of the optical imaging lens assembly is FOV, and the following condition is satisfied:
25 degrees<FOV<40 degrees.

18. The optical imaging lens assembly of claim 15, wherein a sum of central thicknesses of all lens elements of the optical imaging lens assembly is ECT, a sum of axial distances between each of all adjacent lens elements of the optical imaging lens assembly is ΣAT, and the following condition is satisfied:
0.90<ΣCT/ΣAT<2.00.

19. The optical imaging lens assembly of claim 15, wherein a focal length of the first lens element is f1, a focal length of the third lens element is f3, and the following condition is satisfied:
0.30<|f1/f3|<3.00.

20. The optical imaging lens assembly of claim 15, wherein a focal length of the second lens element is f2, a focal length of the third lens element is f3, and the following condition is satisfied:
0.00<|f3/f2|<2.50.

21. The optical imaging lens assembly of claim 15, wherein a focal length of the optical imaging lens assembly is f, a curvature radius of the object-side surface of the fourth lens element is R7, a curvature radius of the image-side surface of the fourth lens element is R8, and the following condition is satisfied:
4.00<|f/R7|+|f/R8|<14.00.

22. The optical imaging lens assembly of claim 15, wherein a curvature radius of the image-side surface of the second lens element is R4, a curvature radius of the object-side surface of the third lens element is R5, and the following condition is satisfied:
0.00<|R4/R5|<1.00.

23. The optical imaging lens assembly of claim 15, wherein the central thickness of the first lens element is CT1, a central thickness of the third lens element is CT3, and the following condition is satisfied:
0.90<CT1/CT3<3.00.

24. The optical imaging lens assembly of claim 15, wherein an axial distance between the first lens element and the second lens element is T12, an axial distance between the third lens element and the fourth lens element is T34, and the following condition is satisfied:
0.00<T12/T34<0.30.

25. The optical imaging lens assembly of claim 15, further comprising at least one reflective element, wherein the at least one reflective element is disposed between the fourth lens element and the image surface, and the optical path is reflected at least twice through the at least one reflective element.

26. The optical imaging lens assembly of claim 15, wherein the optical imaging lens assembly has a first state corresponding to an infinite object distance and a second state corresponding to a finite object distance, and the finite object distance is equal to or less than 500 mm;
when an imaged object at infinity moves to be at the finite object distance, at least one lens element of the optical imaging lens assembly moves along an optical axis direction with respect to other lens elements of the optical imaging lens assembly to perform a movement focus process, so that the optical imaging lens assembly is changed from the first state to the second state.

27. The optical imaging lens assembly of claim 15, wherein the axial distance between the object-side surface of the first lens element and the image-side surface of the fourth lens element is TD, the axial distance between the image-side surface of the fourth lens element and the image surface is BL, an absolute value of a focal length of the first lens element is |f1|, an absolute value of a focal length of the second lens element is |f2|, an absolute value of a focal length of the third lens element is |f3|, an absolute value of a focal length of the fourth lens element is |f4|, a maximum value of |f1|, |f2|, |f3| and |f4| is |fi|max, the central thickness of the first lens element is CT1, a central thickness of the third lens element is CT3, the axial distance between the second lens element and the third lens element is T23, an axial distance between the third lens element and the fourth lens element is T34, the Abbe number of the fourth lens element is V4, the curvature radius of the object-side surface of the second lens element is R3, the curvature radius of the image-side surface of the third lens element is R6, and the following conditions are satisfied:
0.23≤TD/BL≤0.50;
0.26≤|f2|/|fi|max≤1.00;
0.34≤CT3/T34≤0.88;
16.3≤V4≤23.5;
1.23≤CT1/T23≤2.82; and
0.02≤|R3/R6|≤0.58.
